(19) United States
(12) Patent Application Publication
(10) Pub. No.: US 2008/0305361 A1
(43) Pub. Date: Dec. 11, 2008

(54) Organometallic Complex, and Light-Emitting Material, Light-Emitting Element, Light-Emitting Device and Electronic Device

(75) Inventors: Hideko Inoue, Atsugi (JP); Satoshi Seo, Kawasaki (JP); Nobuharu Ohsawa, Zama (JP)

Correspondence Address: COOK, ALEX, McFARRON, MANZO,CUMMINGS & MEHLER,;LTD., SUITE 2850, 200 WEST ADAMS STREET, CHICAGO, IL, 60606, US

(73) Assignee: Semiconductor Energy Laboratory Co., Ltd.

(21) Appl. No.: 12/132,174

(22) Filed: Jun. 3, 2008

(30) Foreign Application Priority Data
Jun. 5, 2007 (JP) 2007-149497

(51) Int. Cl. H05B 33/00; B32B 9/00; C07F 19/00

(52) U.S. Cl. 428/691; 428/690; 544/225

(57) ABSTRACT

The present invention provides a novel organometallic complex which emits green phosphorescence so as to enrich variations of phosphorescent materials for green color which is one of three primary colors. An organometallic complex comprising a structure represented by a general formula (G1) is provided.

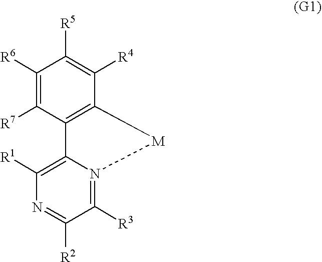

In the formula, R¹ represents an alkyl group having 1 to 4 carbon atoms, and R² and R³ individually represent hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. In addition, M is a central metal and represents either an element belonging to Group 9 in the periodic table or an element belonging to Group 10 in the periodic table.

### TECHNICAL FIELD

The present invention relates to an organometallic complex. In addition, the present invention relates to a light-emitting material, a light-emitting element, a light-emitting device and an electronic device which use the organometallic complex.

### BACKGROUND ART

Organic compounds absorb light, and thereby the compounds are converted to an excited state. By going through this excited state, various reactions (such as photochemical reactions) are caused in some cases, or luminescence is produced in some cases. Therefore, various applications of the organic compounds have been being made.

As one example of the photochemical reactions, a reaction (oxygen addition) of singlet oxygen with an unsaturated organic molecule is known (refer to Reference 1: Haruo INOUE, et al., Basic Chemistry Course PHOTOCHEMISTRY I (Maruzen Co., Ltd.), pp. 106-110, for example). Since the ground state of an oxygen molecule is a triplet state, oxygen in a singlet state (singlet oxygen) is not generated by direct photoexcitation. However, singlet oxygen is generated in the presence of any other triplet excited molecule, which leads to an oxygen addition reaction. In this case, a compound capable of forming the triplet excited molecule is referred to as a photosensitizer.

As described above, in order to generate singlet oxygen, a photosensitizer that is capable of forming a triplet excited molecule by photoexcitation is necessary. However, since the ground state of an ordinary organic compound is a singlet state, photoexcitation to a triplet excited state is a forbidden transition, and a triplet excited molecule is unlikely to be generated. Therefore, as such a photosensitizer, a compound which easily causes intersystem crossing from the singlet excited state to the triplet excited state (or a compound which allows the forbidden transition of photoexcitation directly to the triplet excited state) is required. In other words, such a compound can be used as a photosensitizer and is useful.

Also, such a compound often emits phosphorescence. The phosphorescence is luminescence generated by transition between different energies in multiplicity and, in the case of an ordinary organic compound, indicates luminescence generated in returning from the triplet excited state to the singlet ground state (in contrast, luminescence in returning from a singlet excited state to a singlet ground state is referred to as fluorescence). Application fields of a compound capable of emitting phosphorescence, that is, a compound capable of converting a triplet excited state into luminescence (hereinafter, referred to as a phosphorescent compound), include a light-emitting element using an organic compound as a light-emitting substance.

This light-emitting element has a simple structure in which a light-emitting layer containing an organic compound that is a light-emitting substance is provided between electrodes, and has attracted attention as a next-generation flat panel display element because of its characteristics such as a thin shape, lightweight, high response speed, and low direct current voltage driving. In addition, a display device using this light-emitting element is superior in contrast, image quality, and wide viewing angle.

The emission mechanism of a light-emitting element in which an organic compound is used as a light-emitting substance is a carrier injection type. That is, by applying voltage with a light-emitting layer interposed between electrodes, electrons and holes injected from the electrodes are recombined to make the light-emitting substance excited, and light is emitted when the excited state returns to the ground state. As in the case of photoexcitation described above, types of the excited state include a singlet excited state (S*) and a triplet excited state (T*). Further, the statistical generation ratio thereof in a light-emitting element is considered to be S*:T*=1:3.

At room temperature, a compound capable of converting a singlet excited state to luminescence (hereinafter, referred to as a fluorescent compound) exhibits only luminescence from the singlet excited state (fluorescence), not luminescence from the triplet excited state (phosphorescence). Therefore, in a light-emitting element using a fluorescent compound, the theoretical limit of internal quantum efficiency (the ratio of generated photons to injected carriers) is considered to be 25% based on S*:T*=1:3.

On the other hand, when the phosphorescent compound described above is used, the internal quantum efficiency can be improved to 75 to 100% in theory. Namely, a light emission efficiency that is 3 to 4 times as much as that of the fluorescence compound can be achieved. For these reasons, in order to realize a highly-efficient light-emitting element, a light-emitting element using a phosphorescent compound has been developed actively in recent years (for example, refer to Reference 2: Zhang, Guo-Lin, et al., Gaodeng Xuexiao Huaxue Xuebao (2004), vol. 25, No. 3, pp. 397-400). In particular, as the phosphorescent compound, an organometallic complex using iridium or the like as a central metal has been attracting attention, owing to its high phosphorescence quantum yield.

The organometallic complex disclosed in Reference 2 can be expected to be used as a photosensitizer, since it easily causes intersystem crossing. In addition, since the organometallic complex easily generates luminescence (phosphorescence) from a triplet excited state, a highly efficient light-emitting element is expected, as a result of applying the organometallic complex to the light-emitting element.

### DISCLOSURE OF THE INVENTION

It is known that when a light-emitting element is formed using a chemical substance as a light-emitting substance, the characteristics of the light-emitting element not only depends on the characteristics of the light-emitting substance, but also greatly depends on characteristics of various materials for other elements and compatibility between the materials. Thus, it is necessary for the future development in this technical field to develop a wider variation of materials which are different in their structure or characteristics from each other, even though the materials exhibits almost the same emission color.

On the other hand, variations of emission colors are also important. A full-color light-emitting device using light-emitting elements can be manufactured utilizing three primary colors of light, red, green, and blue. Thus, for the development of light-emitting substances, it is necessary to develop a wider variation of materials having different structures or characteristics for each color, red, green and blue.

Based on the foregoing, it is an object of the present invention to provide a novel organometallic complex which emits green phosphorescence so as to enrich variations of phosphorescent materials for green color which is one of three primary colors. Further, it is an object of the present invention to provide a novel organometallic complex for green phosphorescence which has high emission efficiency. Furthermore, it is another object of the present invention to provide a light-emitting material including the organometallic complex. Additionally, it is another object of the present invention to provide a light-emitting element including the organometallic complex. It is another object of the present invention to provide a light-emitting element including the organometallic complex as a light-emitting substance. Moreover, it is another object of the present invention to provide a light-emitting device having the light-emitting element. It is another object of the present invention to provide an electronic device having the light-emitting element.

The present inventors have made researches keenly. As a result, the present inventors have found that a phenylpyrazine derivative represented by the following general formula (G0) is ortho metalated with a metal ion of an element belonging to Group 9 or Group 10 in the periodic table, thereby obtaining an organometallic complex. In addition, the present inventors have also found that the organometallic complex having an ortho metalated structure of the general formula (G0) easily causes intersystem crossing, and can emit green phosphorescence.

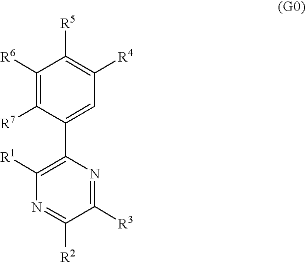

In the general formula (1), R¹ represents an alkyl group having 1 to 4 carbon atoms, and R² and R³ individually represent hydrogen or an alkyl group having 1 to 4 carbon atoms. In addition, R⁴ to R⁷ individually represent either an electron-withdrawing group, hydrogen or an alkyl group having 1 to 4 carbon atoms. Note that at least one of R⁴ to R⁷ represents an electron-withdrawing group.

Therefore, an aspect of the present invention is an organometallic complex comprising a structure represented by a general formula (G1).

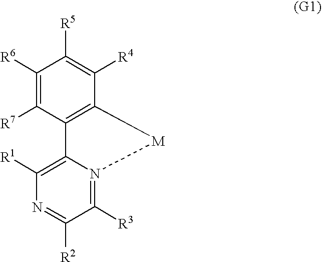

In the formula, R¹ represents an alkyl group having 1 to 4 carbon atoms, and R² and R³ individually represent hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. In addition, M is a central metal and represents either an element belonging to Group 9 in the periodic table or an element belonging to Group 10 in the periodic table.

The organometallic complex having a structure represented by the general formula (G1) is an organometallic complex which can emit green phosphorescence. The organometallic complex also has high emission efficiency.

In addition, another aspect of the present invention is an organometallic complex having the structure represented by the following general formula (G2).

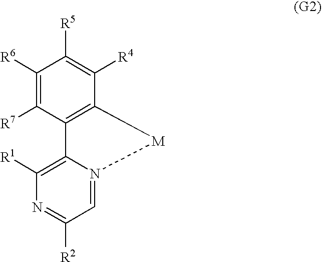

In the formula, R¹ represents an alkyl group having 1 to 4 carbon atoms, and R² represents hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. In addition, M is a central metal and represents either an element belonging to Group 9 in the periodic table or an element belonging to Group 10 in the periodic table.

The organometallic complex represented by the general formula (G2) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G2) is preferable in terms of yield in synthesis.

The organometallic complex having the structure represented by the above general formula (G2) is an organometallic complex which can emit green phosphorescence. Further, the organometallic complex also has high emission efficiency and high yield of synthesis.

Further, an aspect of the present invention is an organometallic complex having a structure represented by the following general formula (G3).

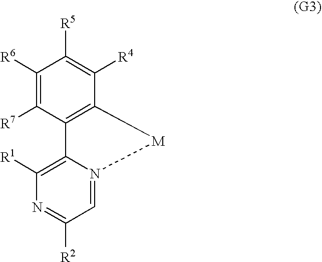

In the formula, R¹ represents an alkyl group having 1 to 4 carbon atoms; R² represents an alkyl group having 1 to 4 carbon atoms; R⁴ to R⁷ individually represent an electron-withdrawing group, hydrogen or an alkyl group having 1 to 4 carbon atoms; at least one of R⁴ to R⁷ represents an electron-withdrawing group and M is a central metal and represents an element belonging to Group 9 or Group 10 in the periodic table.

The organometallic complex having the structure represented by the general formula (G3) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G3) is preferable in terms of yield in synthesis. Moreover, the organometallic complex having the structure represented by the general formula (G3) has an alkyl group at R², and thus stability of the pyrazine derivative is enhanced and is more preferable in yield of synthesis.

The organometallic complex having the structure represented by the above general formula (G3) is an organometallic complex which can emit green phosphorescence. Further, the organometallic complex also has high emission efficiency and is preferable since it can be synthesized with high yield.

In addition, an aspect of the present invention is an organometallic complex having a structure represented by the following general formula (G4).

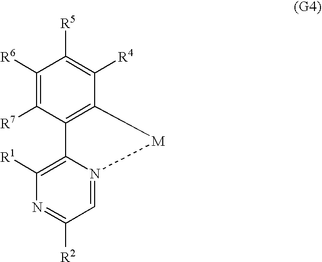

In the formula, R¹ represents an alkyl group having 1 to 4 carbon atoms; R² represents an alkyl group having 1 to 4 carbon atoms; R⁴ to R⁷ individually represent a fluoro group, a trifluoromethyl group, hydrogen or an alkyl group having 1 to 4 carbon atoms; at least one of R⁴ to R⁷ represents a fluoro group or a trifluoromethyl group, and M is a central metal and represents an element belonging to Group 9 or Group 10 in the periodic table.

The organometallic complex represented by the general formula (G4) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G4) is preferable in terms of yield in synthesis. Moreover, the organometallic complex having the structure represented by the general formula (G4) has an alkyl group at R², and thus stability of the pyrazine derivative is enhanced and is more preferable in yield of synthesis. In addition, a structure in which at least one of R⁴ to R⁷ is a fluoro group or a trifluoromethyl group is preferable, since synthesis of the phenylpyrazine derivative represented by the general formula (G0) is easy and the organometallic complex represented by the general formula (G4) can emit efficiently.

The organometallic complex having a structure represented by the general formula (G4) is an organometallic complex which can emit green phosphorescence. The organometallic complex also has high emission efficiency. Further, the organometallic complex also has high emission efficiency and is preferable since it can be synthesized with high yield. Further, the organometallic complex can be easily synthesized and emits light with high efficiency.

Further, another aspect of the present invention is an organometallic complex including a structure represented by the following general formula (G5).

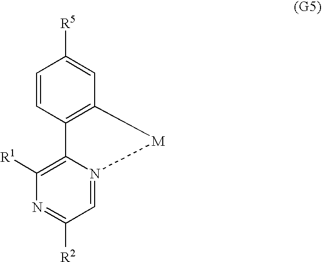

In the formula, R¹ and R² represent an alkyl group having 1 to 4 carbon atoms. In addition, R⁵ represents a fluoro group or a trifluoromethyl group. M is a central metal and represents either an element belonging to Group 9 in the periodic table or an element belonging to Group 10 in the periodic table.

The organometallic complex having the structure represented by the general formula (G5) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G5) is preferable in terms of yield in synthesis. Moreover, the organometallic complex having the structure represented by the general formula (G5) has an alkyl group at R², and thus stability of the pyrazine derivative is enhanced and is more preferable in yield of synthesis. In addition, a structure in which R⁵ is a fluoro group or a trifluoromethyl group is preferable, since synthesis of the phenylpyrazine derivative represented by the general formula (G0) is easy and the organometallic complex represented by the general formula (G5) can emit efficiently. By comprising an electron-withdrawing group at R⁵, the emission wavelength of the organometallic complex is shifted to a region for blue color, and thus can exhibit green with higher color purity than an unsubstituted organometallic complex.

The organometallic complex having a structure represented by the general formula (G5) is an organometallic complex which can emit green phosphorescence. The organometallic complex also has high emission efficiency. Further, the organometallic complex also has high emission efficiency and is preferable since it can be synthesized with high yield. Further, the organometallic complex can be easily synthesized and emits light efficiently. Moreover, the organometallic complex can emit green phosphorescence with high color purity.

Further, another aspect of the present invention is an organometallic complex having the structure represented by the following general formula (G6).

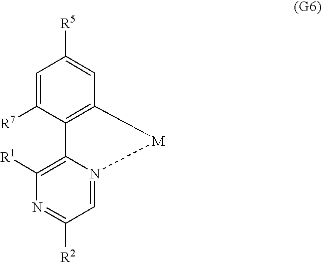

In the formula, R¹ and R² represent an alkyl group having 1 to 4 carbon atoms. In addition, R⁵ and R⁷ individually represent a fluoro group or a trifluoromethyl group, and R⁵ and R⁷ may be the same as or different from each other. M is a central metal and represents either an element belonging to Group 9 in the periodic table or an element belonging to Group 10 in the periodic table.

The organometallic complex represented by the general formula (G6) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G6) is preferable in terms of yield in synthesis. Moreover, the organometallic complex having the structure represented by the general formula (G6) has an alkyl group at R², and thus stability of the pyrazine derivative is enhanced and is more preferable in yield of synthesis. In addition, a structure in which R⁵ and R⁷ individually represent a fluoro group or a trifluoromethyl group is preferable, since synthesis of the phenylpyrazine derivative represented by the general formula (G0) is easy and the organometallic complex represented by the general formula (G6) can emit efficiently. By comprising an electron-withdrawing group at each of R⁵ and R⁷, the emission wavelength of the organometallic complex is shifted to a region for blue color, and thus can exhibit green emission with higher color purity than an unsubstituted organometallic complex.

The organometallic complex having a structure represented by the general formula (G6) is an organometallic complex which can emit green phosphorescence. The organometallic complex also has high emission efficiency. Further, the organometallic complex also has high emission efficiency and is preferable since it can be synthesized with high yield. Further, the organometallic complex can be easily synthesized and emits light with high efficiency. Moreover, the organometallic complex can emit green phosphorescence with high color purity.

Among organometallic complexes having the structure represented by the above general formula (G1), an organometallic complex represented by the general formula (G7) is preferable since it can be easily synthesized. Therefore, an aspect of the present invention is an organometallic complex represented by the general formula (G7).

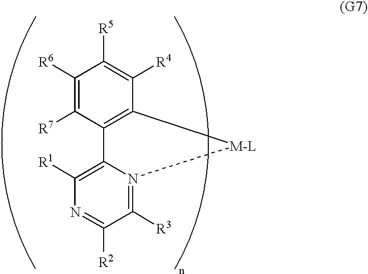

In the formula, R¹ represents an alkyl group having 1 to 4 carbon atoms; R² and R³ individually represent hydrogen or an alkyl group having 1 to 4 carbon atoms; R⁴ to R⁷ individually represent an electron-withdrawing group, hydrogen or an alkyl group having 1 to 4 carbon atoms; at least one of R⁴ to R⁷ represents an electron-withdrawing group; M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex having a structure represented by the general formula (G7) is an organometallic complex which can emit green phosphorescence. Further, the organometallic complex also has high emission efficiency and is preferable since it can be easily synthesized.

In addition, among organometallic complexes having the structure represented by the above general formula (G2), an organometallic complex represented by the general formula (G8) is preferable since it can be easily synthesized. Therefore, an aspect of the present invention is an organometallic complex represented by the general formula (G8).

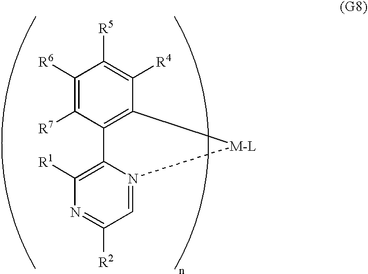

In the formula, R¹ represents an alkyl group having 1 to 4 carbon atoms; R² represents hydrogen or an alkyl group having 1 to 4 carbon atoms; R⁴ to R⁷ individually represent an electron-withdrawing group, hydrogen or an alkyl group having 1 to 4 carbon atoms; at least one of R⁴ to R⁷ represents an electron-withdrawing group; M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex represented by the general formula (G8) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex represented by the general formula (G8) is preferable in terms of yield in synthesis.

The organometallic complex represented by the general formula (G8) is an organometallic complex which can emit green phosphorescence. The organometallic complex also has high emission efficiency. Further, the organometallic complex also has high yield in synthesis. The organometallic complex is preferable since it can be easily synthesized.

In addition, among organometallic complexes having the structure represented by the above general formula (G3), an organometallic complex represented by the general formula (G9) is preferable since it can be easily synthesized. Therefore, an aspect of the present invention is an organometallic complex represented by the general formula (G9).

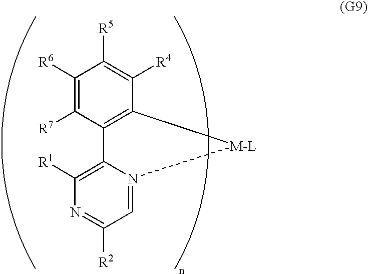

In the formula, R¹ represents an alkyl group having 1 to 4 carbon atoms; R² represents an alkyl group having 1 to 4 carbon atoms; R⁴ to R⁷ individually represents an electron-withdrawing group, hydrogen or an alkyl group having 1 to 4 carbon atoms; at least one of R⁴ to R⁷ represents an electron-withdrawing group; M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex represented by the general formula (G9) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex represented by the general formula (G9) is preferable in terms of yield in synthesis. Moreover, the organometallic complex having the structure represented by the general formula (G9) has an alkyl group at R², and thus stability of the pyrazine derivative is enhanced and is more preferable in yield of synthesis.

The organometallic complex represented by the general formula (G9) is an organometallic complex which can emit green phosphorescence. The organometallic complex also has high emission efficiency. Further, the organometallic complex can be synthesized with high yield. The organometallic complex is preferable since it can be easily synthesized.

In addition, among organometallic complexes having the structure represented by the above general formula (G4), an organometallic complex represented by the general formula (G10) is preferable since it can be easily synthesized. Therefore, an aspect of the present invention is an organometallic complex represented by the general formula (G10).

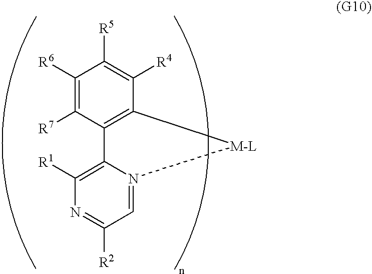

In the formula, R¹ represents an alkyl group having 1 to 4 carbon atoms; R² represents an alkyl group having 1 to 4 carbon atoms; R⁴ to R⁷ individually represent a fluoro group, a trifluoromethyl group, hydrogen or an alkyl group having 1 to 4 carbon atoms; at least one of R⁴ to R⁷ represents a fluoro group or a trifluoromethyl group; M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex represented by the general formula (G10) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G10) is preferable in terms of yield in synthesis. Moreover, the organometallic complex having the structure represented by the general formula (G10) has an alkyl group at R², and thus stability of the pyrazine derivative is enhanced and is more preferable in yield of synthesis. In addition, a structure in which at least one of R⁴ to R⁷ is a fluoro group or a trifluoromethyl group is preferable, since synthesis of the phenylpyrazine derivative represented by the general formula (G0) is easy and the organometallic complex represented by the general formula (G10) can emit efficiently.

The organometallic complex having a structure represented by the general formula (G10) is an organometallic complex which can emit green phosphorescence. The organometallic complex also has high emission efficiency. Further, the organometallic complex can be synthesized with high yield. The organometallic complex is preferable since it can be easily synthesized. The organometallic complex can be easily synthesized and emit light efficiently.

In addition, among organometallic complexes having the structure represented by the above general formula (G5), an organometallic complex represented by the general formula (G11) is preferable since it can be easily synthesized. Therefore, an aspect of the present invention is an organometallic complex represented by the general formula (G11).

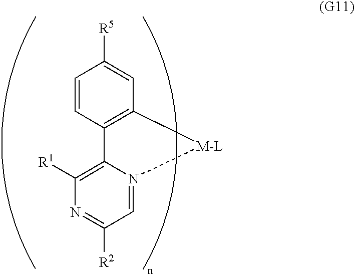

In the formula, R¹ and R² individually represent an alkyl group having 1 to 4 carbon atoms; R⁵ represents a fluoro group or a trifluoromethyl group; and M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex represented by the general formula (G11) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex represented by the general formula (G11) is preferable in terms of yield in synthesis. Moreover, the organometallic complex represented by the general formula (G11) has an alkyl group at R², and thus chemical stability of the pyrazine derivative is enhanced and is more preferable in yield of synthesis. In addition, a structure in which R⁵ is a fluoro group or a trifluoromethyl group is preferable, since synthesis of the phenylpyrazine derivative represented by the general formula (G0) is easy and the organometallic complex represented by the general formula (G11) can emit efficiently. By comprising an electron-withdrawing group at R⁵, the emission wavelength of the organometallic complex is shifted to a region for blue color, and thus can exhibit green with higher color purity than an unsubstituted organometallic complex.

The organometallic complex represented by the general formula (G11) is an organometallic complex which can emit green phosphorescence. The organometallic complex also has high emission efficiency. Further, the organometallic complex can be synthesized with high yield. The organometallic complex is preferable since it can be easily synthesized. The organometallic complex can be easily synthesized and emit light efficiently. In addition, the organometallic complex emits green phosphorescence with high color purity.

In addition, among organometallic complexes having the structure represented by the above general formula (G6), an organometallic complex represented by the general formula (G12) is preferable since it can be easily synthesized. Therefore, an aspect of the present invention is an organometallic complex represented by the general formula (G12).

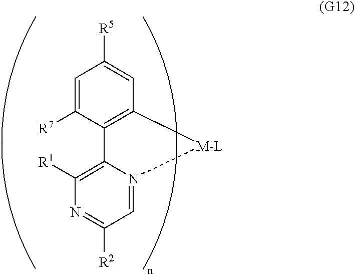

In the formula, R¹ and R² individually represent an alkyl group having 1 to 4 carbon atoms; R⁵ and R⁷ individually represent a fluoro group or a trifluoromethyl group; R⁵ and R⁷ may be the same or different; and M is a central metal and represents an element belonging to Group 9 or Group 10 in the periodic table; L represents a monoanionic ligand; and n is 2 when the central metal is an element belonging to Group 9 in the periodic table, and n is 1 when the central metal is an element belonging to Group 10 in the periodic table.

The organometallic complex represented by the general formula (G12) is synthesized by ortho metalation of the phenylpyrazine derivative having hydrogen at R³ in the phenylpyrazine derivative represented by the above general formula (G0). The phenylpyrazine derivative having hydrogen at R³ in the phenylpyrazine derivative represented by the above general formula (G0) has small steric hindrance and easy to be ortho-metalated with metal. Thus, the organometallic complex having the structure represented by the general formula (G12) is preferable in terms of yield in synthesis. Moreover, the organometallic complex represented by the general formula (G12) has an alkyl group at R², and thus stability of the pyrazine derivative is enhanced and is more preferable in yield of synthesis. In addition, a structure in which R⁵ and R⁷ individually represent a fluoro group or a trifluoromethyl group is preferable, since synthesis of the phenylpyrazine derivative represented by the general formula (G0) is easy and the organometallic complex represented by the general formula (G12) can emit efficiently. By comprising an electron-withdrawing group at each of R⁵ and R⁷, the emission wavelength of the organometallic complex is shifted to a region for blue color, and thus can exhibit green with higher color purity than an unsubstituted organometallic complex.

The organometallic complex having a structure represented by the general formula (G12) is an organometallic complex which can emit green phosphorescence. The organometallic complex also has high emission efficiency. Further, the organometallic complex can be synthesized with high yield. The organometallic complex is preferable since it can be easily synthesized. The organometallic complex can be easily synthesized and emit light efficiently. In addition, the organometallic complex emits green phosphorescence with high color purity.

The above-mentioned monoanionic ligand L is preferably any of a monoanionic bidentate chelate ligand having a β-diketone structure, a monoanionic bidentate chelate ligand having a carboxyl group, a monoanionic bidentate chelate ligand having a phenolic hydroxyl group, and a monoanionic bidentate chelate ligand in which two ligand elements are both nitrogen. More preferably, the monoanionic ligand L is a monoanionic ligand represented by the following structural formulae (L1) to (L8). Since these ligands have high coordinative ability and can be obtained at low price, they are useful.

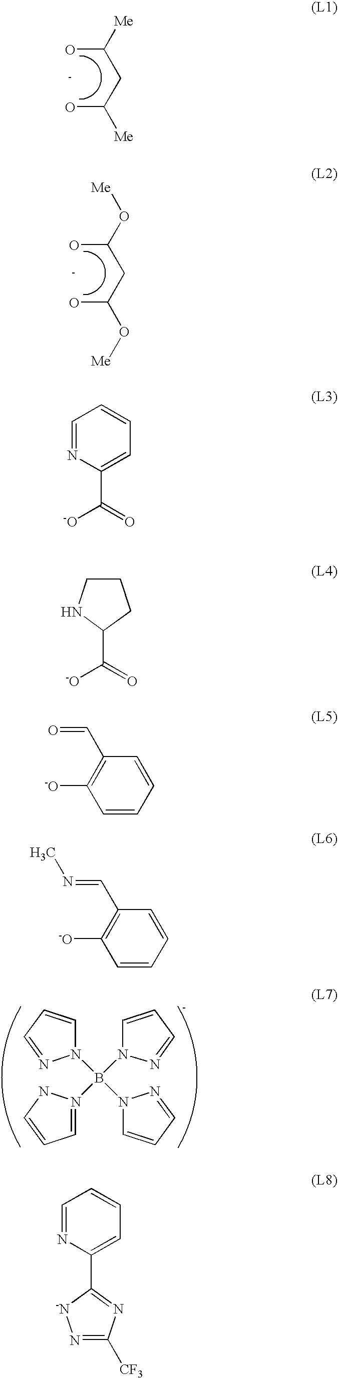

In order to emit phosphorescence more efficiently, a heavy metal is preferable as a center metal in terms of heavy atom effect. Thus, in the organometallic complexes having the structures represented by the above general formulae (G1) to (G6) and the organometallic complexes represented by (G7) to (G12), an element represented by the central metal M is preferably iridium or platinum.

As examples of the above electron-withdrawing group, a halogen group, a trifluoromethyl group, a cyano group, an alkoxycarbonyl group, and the like are given. In particular, a trifluoromethyl group and a fluoro group of a halogen group are preferably used, since the phenylpyrazine derivative represented by the general formula (G0) can be easily synthesized and the organometallic complex can emit light efficiently.

In the organometallic complex including the structure represented by the above general formulae (G1) to (G6) and the organometallic complexes represented by the above general formulae (G7) to (G12), the coordinate structure in which the pyrazine derivative represented by the general formula (G0) is ortho metalated with metal ions, contributes emission of phosphorescence greatly. Therefore, another structure of the present invention is a light-emitting material including at least one of the organometallic complexes including the structure represented by the above general formulae (G1) to (G6) and the organometallic complexes represented by the general formulae (G7) to (G12).

In addition, the organometallic complexes having the structures represented by the above general formulae (G1) to (G6) and the organometallic complexes represented by the general formulae (G7) to (G12) can emit phosphorescence, in other words, they can convert a triplet excitation energy to light emission. Accordingly, by applying any of the organometallic complexes to a light-emitting element, the light-emitting element can have high efficiency, which is very effective. Therefore, the present invention includes a light-emitting element including at least one of the organometallic complexes including the structure represented by the above general formulae (G1) to (G6) and the organometallic complexes represented by the above general formulae (G7) to (G12).

In this case, the organometallic complexes including the structure represented by the above general formulae (G1) to (G6) and the organometallic complexes represented by the general formulae (G7) to (G12) are effective as light-emitting substances. Therefore, another structure of the present invention is a light-emitting element including, as a light-emitting substance, at least one of the organometallic complexes including the structure represented by the above general formulae (G1) to (G6) and the organometallic complexes represented by the above general formulae (G7) to (G12).

Further, a light-emitting device which includes a light-emitting element including at least one of the organometallic complexes including the structure represented by the above general formulae (G1) to (G6) and the organometallic complexes represented by the above general formulae (G7) to (G12) or a light-emitting element including, as a light-emitting substance, at least one of the organometallic complexes including the structure represented by the above general formulae (G1) to (G6) and the organometallic complexes represented by the above general formulae (G7) to (G12) can be a light-emitting device with low power consumption, since the above light-emitting element realizes high emission efficiency. Therefore, an aspect of the present invention includes a light-emitting device which includes a light-emitting element including at least one of the organometallic complexes including the structure represented by the above general formulae (G1) to (G6) and the organometallic complexes represented by the above general formulae (G7) to (G12) or a light-emitting element including, as a light-emitting substance, at least one of the organometallic complexes including the structure represented by the above general formulae (G1) to (G6) and the organometallic complexes represented by the above general formulae (G7) to (G12).

In this specification, the term “light-emitting device” refers to an image display device or a light-emitting device including a light-emitting element. Further, the category of the light-emitting device includes a module including a light-emitting element attached with a connector such as a module attached with an anisotropic conductive film, TAB (Tape Automated Bonding) tape, or a TCP (Tape Carrier Package); a module in which the top of the TAB tape or the TCP is provided with a printed wire board; or a module in which an IC (Integrated Circuit) is directly mounted on a light-emitting element by COG (Chip On Glass); and the like. Moreover, the category includes illumination apparatus and the like.

By carrying out the present invention, a novel organometallic complex which emits green phosphorescence can be provided. Further, a novel organometallic complex for green phosphorescence which has high emission efficiency can be provided. Furthermore, a light-emitting material including the organometallic complex can be provided. Additionally, a light-emitting element including the organometallic complex can be provided. A light-emitting element including the organometallic complex as a light-emitting substance can be provided. Moreover, a light-emitting device having the light-emitting element can be provided. An electronic device having the light-emitting element can be provided.

### BRIEF DESCRIPTION OF DRAWINGS

In the accompanying drawings:

FIG. 1 illustrates a light-emitting element according to an aspect of the present invention;

FIG. 2 illustrates a light-emitting element according to an aspect of the present invention;

FIGS. 3A and 3B are a top view and a cross-sectional view of a light-emitting device according to an aspect of the present invention;

FIGS. 4A and 4B are a perspective view and a cross-sectional view, respectively, of a light-emitting device according to an aspect of the present invention;

FIGS. 5A to 5D each illustrate an electronic device according to an aspect of the present invention;

FIG. 6 illustrates an electronic device according to an aspect of the present invention;

FIG. 7 illustrates an electronic device according to an aspect of the present invention;

FIG. 8 illustrates an electronic device according to an aspect of the present invention;

FIG. 9 is a ¹H-NMR chart of an organometallic complex synthesized in Example 1;

FIG. 10 is a graph showing an ultraviolet-visible light absorption spectrum and an emission spectrum of an organometallic complex of the present invention, [Ir(diPrFppr)₂(pic)] in a dichloromethane solution;

FIG. 11 is a ¹H-NMR chart of an organometallic complex synthesized in Example 2;

FIG. 12 is a graph showing an ultraviolet-visible light absorption spectrum and an emission spectrum of an organometallic complex of the present invention, [Ir(dmF₂ ppr)₂(acac)] in a dichloromethane solution.

FIG. 13 is a ¹H-NMR chart of an organometallic complex synthesized in Example 3;

FIG. 14 is a graph showing an ultraviolet-visible light absorption spectrum and an emission spectrum of an organometallic complex of the present invention, [Ir(dmFppr)₂(acac)] in a dichloromethane solution;

FIG. 15 is a graph showing current density-luminance characteristics of a light-emitting element fabricated in Example 4;

FIG. 16 is a graph showing voltage-luminance characteristics of the light-emitting element fabricated in Example 4;

FIG. 17 is a graph showing luminance-current efficiency characteristics of the light-emitting element fabricated in Example 4;

FIG. 18 is a graph showing an emission spectrum of the light-emitting element fabricated in Example 4;

FIG. 19 is a ¹H-NMR chart of an organometallic complex synthesized in Example 5;

FIG. 20 is a graph showing an ultraviolet-visible light absorption spectrum and an emission spectrum of an organometallic complex of the present invention, [Ir(dmFppr)₂(pic)] in a dichloromethane solution;

FIG. 21 is a ¹H-NMR chart of an organometallic complex synthesized in Example 6;

FIG. 22 is an IR chart of the organometallic complex synthesized in Example 6;

FIG. 23 is a graph showing an ultraviolet-visible light absorption spectrum and an emission spectrum of an organometallic complex of the present invention, [Ir(dmFppr)₂(pro)] in a dichloromethane solution;

FIG. 24 is a ¹H-NMR chart of an organometallic complex synthesized in Example 7; and

FIG. 25 is a graph showing an ultraviolet-visible light absorption spectrum and an emission spectrum of an organometallic complex of the present invention, [Ir(dmFppr)₃] in a dichloromethane solution.

### BEST MODE FOR CARRYING OUT THE INVENTION

Embodiment Modes of the present invention will be hereinafter described in detail with reference to the accompanying drawings. However, the present invention can be carried out in many different modes, and it is easily understood by those who are skilled in the art that embodiments and details herein disclosed can be modified in various ways without departing from the purpose and the scope of the present invention. Therefore, the present invention is not construed as being limited to description of the embodiment modes.

### Embodiment Mode 1

Embodiment Mode 1 will describe an organometallic complex of the present invention.

<<Synthesis Method of a Pyrazine Derivative Represented by the General Formula (G0)>>

An organometallic complex of the present invention is formed by ortho metalation of a phenylpyrazine derivative represented by the following general formula (G0) with a metal ion belonging to Group 9 or Group 10 in the periodic table.

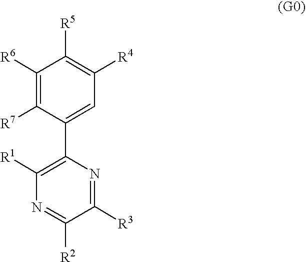

In the formula, R¹ represents an alkyl group having 1 to 4 carbon atoms; R² and R³ individually represent hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. Note that the electron-withdrawing group is a halogen group, a trifluoromethyl group, a cyano group, an alkoxycarbonyl group, or the like.

First, the phenylpyrazine derivative represented by the general formula (G0) can be synthesized by the following simple synthetic scheme. For example, as shown in the following scheme (a), a halide of a benzene derivative (A1) is lithiated with alkyllithium or the like, and is reacted with a pyrazine derivative (A2), thereby obtaining the phenylpyrazine derivative. Alternatively, as shown in the scheme (a′), the phenylpyrazine derivative can be obtained by coupling boronic acid of a benzene derivative (A1′) and halide of a pyrazine derivative (A2′). Note that X in the formula represents a halogen element, in particular, chloro, bromo, or iode is preferable.

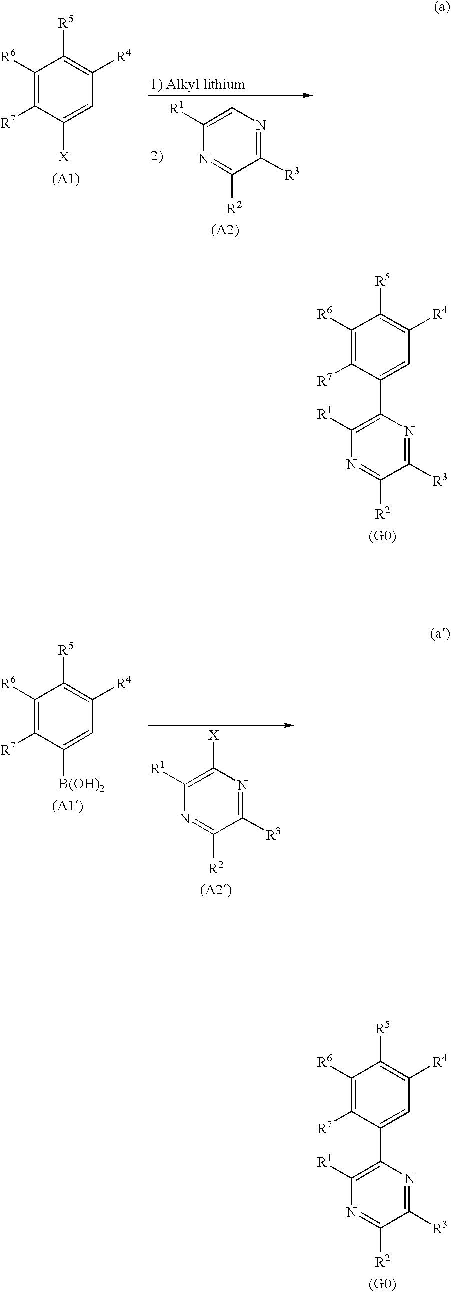

A variety of the above compounds (A1), (A2), (A1′), and (A2′) can be obtained in the market or synthesized, which are easy to get.

### <<Synthesis Method of an Organometallic Complex of the Present Invention Having a Structure Represented by the General Formula (G1)>>

Next, an organometallic complex of the present invention which is formed by ortho metalation of the phenylpyrazine derivative represented by the general formula (G0), i.e., the organometallic complex having the structure represented by the following general formula (G1) will be described.

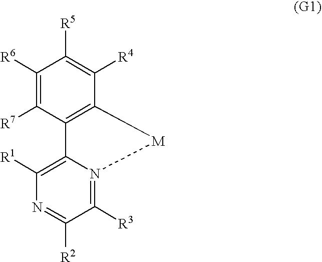

In the formula, R¹ represents an alkyl group having 1 to 4 carbon atoms, R² and R³ individually represent hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. Note that the electron-withdrawing group is a halogen group, a trifluoromethyl group, a cyano group, an alkoxycarbonyl group, or the like. M is a central metal and represents either an element belonging to Group 9 in the periodic table or an element belonging to Group 10 in the periodic table.

First, as represented by the following synthesis scheme (b), a phenylpyrazine derivative represented by the general formula (G0) and a compound of metal belonging to Group 9 or Group 10 in the periodic table and including halogen (a metal halide or a metal complex) is heated with an alcohol solvent (such as glycerol, ethyleneglycol, 2-methoxyethanol, or 2-ethoxyethanol) alone or a mixed solvent of one kind or more of such alcohol solvents and water, so that a binuclear complex (B), which is a kind of organometallic complexes of the present invention having the structure represented by the general formula (G1), can be obtained. As a compound including a metal belonging to Group 9 or Group 10 in the periodic table and including halogen, there are given rhodium chloride hydrate, palladium chloride, iridium chloride hydrate, iridium chloride hydrochloride hydrate, potassium tetrachloroplatinate(II), and the like; however, the present invention is not limited to these examples. In the scheme (b), M denotes an element belonging to Group 9 or Group 10 in the periodic table, and X denotes a halogen element. In addition, n is 2 when M is an element belonging to Group 9 in the periodic table, and n is 1 when M is an element belonging to Group 10 in the periodic table.

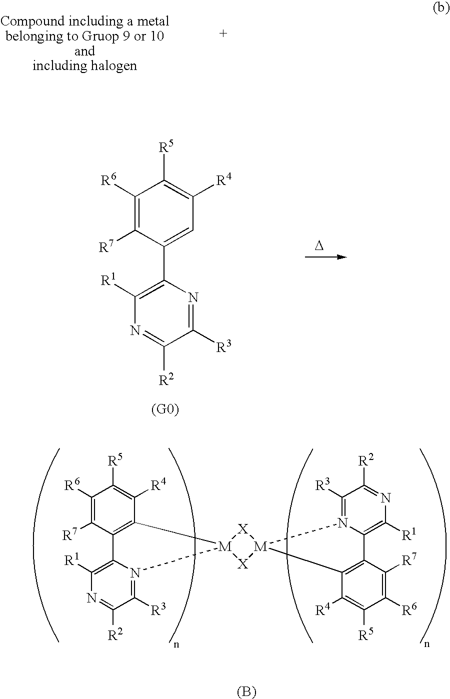

Further, as shown by the following synthesis scheme (c′), the binuclear complex (B) and the phenylpyrazine derivative represented by the general formula (G0) are heated at high temperature of about 200° C. in a high boiling solvent of glycerol or the like, and thus one type (C′) of organometallic complexes of the present invention including the structure represented by the general formula (G1) can be obtained.

As shown in the synthesis scheme (c″), a binuclear complex (B) and a compound which can be ortho-metalated, such as phenylpyridine (more typically, a compound which can be cyclo-metalated) are heated at high temperature of around 200° C. in a high boiling solvent of glycerol or the like, and thus one type (C″) of organometallic complexes of the present invention including the structure represented by the general formula (G1) can be obtained. In the schemes (c′) and (c″), M denotes an element belonging to Group 9 or Group 10 in the periodic table, and X denotes a halogen element. In addition, n is 2 when M is an element belonging to Group 9 in the periodic table, and n is 1 when M is an element belonging to Group 10 in the periodic table.

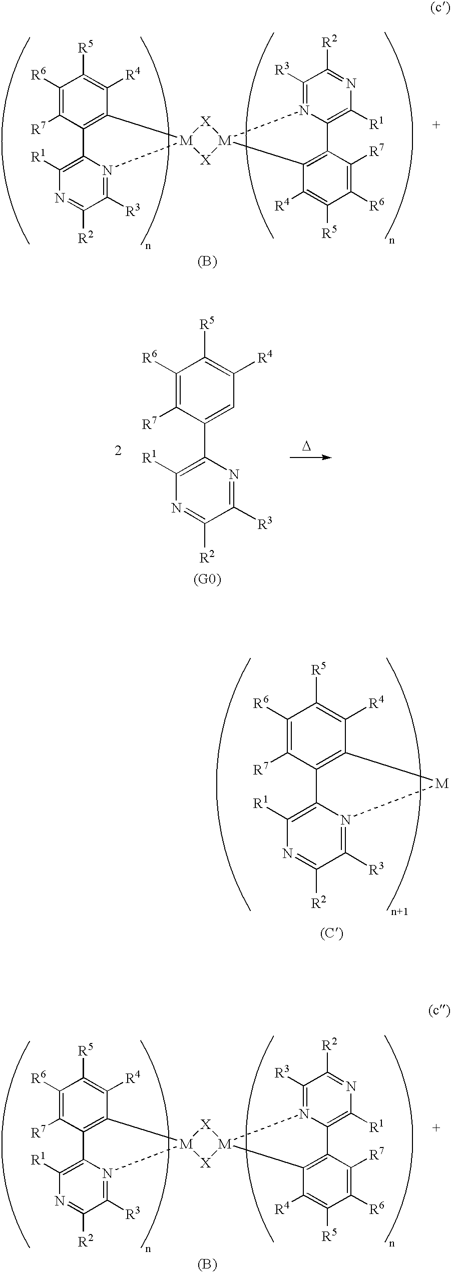

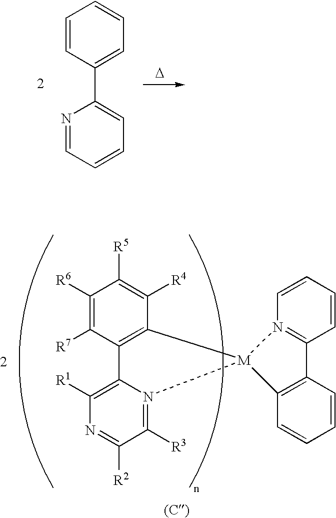

### <<A Synthesis Method of an Organometallic Complex Represented by a General Formula (G7)>>

A preferable example, i.e., an organometallic complex represented by the general formula (G7), among organometallic complexes having the structure represented by the above general formula (G1), will be described.

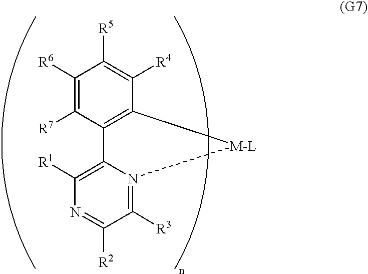

In the formula, R¹ represents an alkyl group having 1 to 4 carbon atoms. R² and R³ individually represent either hydrogen or an alkyl group having 1 to 4 carbon atoms. In addition, R⁴ to R⁷ individually represent an electron-withdrawing group, hydrogen or an alkyl group having 1 to 4 carbon atoms. Note that at least one of R⁴ to R⁷ represents an electron-withdrawing group. M is a central metal and represents either an element belonging to Group 9 in the periodic table or an element belonging to Group 10 in the periodic table. L represents a monoanionic ligand. In addition, n is 2 when M is an element belonging to Group 9 in the periodic table, and n is 1 when M is an element belonging to Group 10 in the periodic table.

The organometallic complex of the present invention represented by the above general formula (G10) can be synthesized by the following scheme (c). In other words, the binuclear complex (B) obtained by the above scheme (b) is reacted with HL which is a material of a monoanionic ligand, and a proton of HL is eliminated and coordinated to the central metal M. In this manner, the organometallic complex of the present invention represented by the general formula (G10) can be obtained. In the scheme (c), M denotes an element belonging to Group 9 or Group 10 in the periodic table, and X denotes a halogen element. In addition, n is 2 when M is an element belonging to Group 9 in the periodic table, and n is 1 when M is an element belonging to Group 10 in the periodic table.

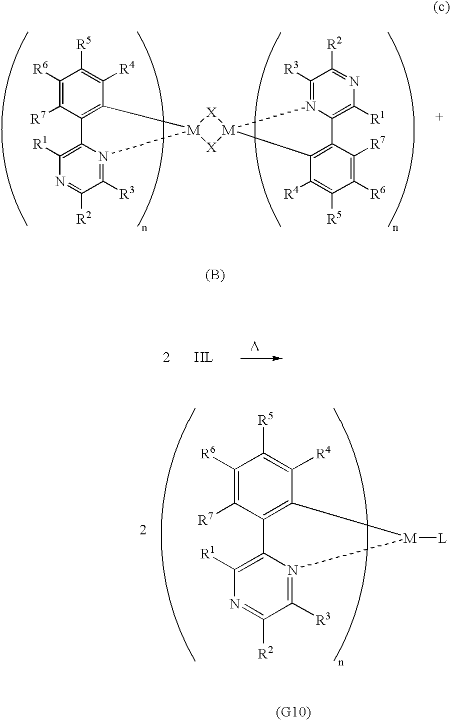

<<An Organometallic Complex of the Present Invention Having the Structure Represented By the General Formula (G1), and a Specific Structural Formula of an Organometallic Complex of the Present Invention which is Represented by the General Formula (G10)>>

Then, specific structural formulae of the organometallic complex of the present invention having the structure shown by the general formula (G1), and the organometallic complex of the present invention represented by the general formula (G10) will be described.

The center metal M is selected from elements belonging to Group 9 or Group 10 in the periodic table and iridium(III) or platinum(II) is preferable in terms of emission efficiency. In particular, when iridium(III) is preferably used, since it is thermally stable.

Next, a ligand portion P surrounded by dashed lines in the following general formulae (G1) and (G7) is described. As described above, M denotes an element belonging to Group 9 or Group 10 in the periodic table. L represents a monoanionic ligand. In addition, n is 2 when M is an element belonging to Group 9 in the periodic table, and n is 1 when M is an element belonging to Group 10 in the periodic table.

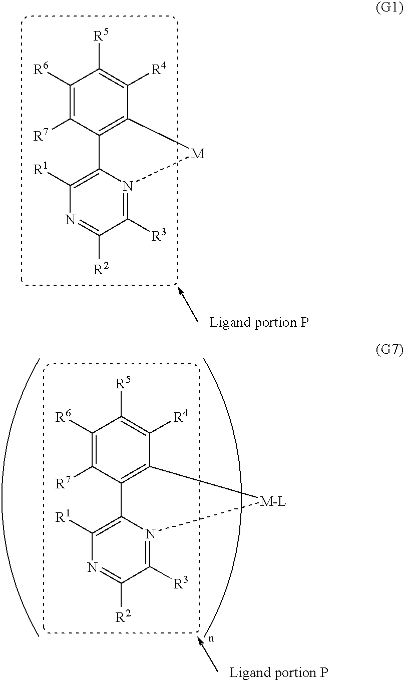

As specific examples of R¹, an alkyl group such as a methyl group, an ethyl group, an isopropyl group, or an n-butyl group is given. By adopting these substituents to R¹, a synthesis yield of an organometallic complex can be more enhanced than when R¹ is hydrogen. As compared with when a conjugated group (such as a phenyl group) is used for R¹, emission spectrum can be more sharpened and thus color purity can be increased.

As specific examples of R² and R³, an alkyl group typified by a methyl group, an ethyl group, an isopropyl group, an n-butyl group or the like can be used as well as hydrogen.

As specific examples of R⁴ to R⁷, an alkyl group typified by a methyl group, an ethyl group, an isopropyl group, an n-butyl group or the like, and an electron-withdrawing group can be used as well as hydrogen. Note that at least one of R⁴ to R⁷ represents an electron-withdrawing group. Note that the electron-withdrawing group is a halogen group, a trifluoromethyl group, a cyano group, an alkoxycarbonyl group, or the like. By adopting an electron-withdrawing group for at least one of R⁴ to R⁷, emission with a short wavelength can be obtained and green emission color can be obtained. Of the above-described electron-withdrawing group, a fluoro group or a trifluoromethyl group which is one type of a halogen group is preferable, since the phenylpyrazine derivative represented by the general formula (G0) can be easily synthesized and the organometallic complex can emit light efficiently.

Next, the monoanionic ligand L in the above general formula (G7) is described. The monoanionic ligand L is preferably any one of a monoanionic bidentate chelate ligand having a β-diketone structure, a monoanionic bidentate chelate ligand having a carboxyl group, a monoanionic bidentate chelate ligand having a phenolic hydroxyl group, and a monoanionic bidentate chelate ligand in which two ligand elements are both nitrogen. This is because these ligands have high coordinating ability. More specifically, monoanionic ligands represented by the following structural formulae (L1) to (L8) are given. However, the monoanionic ligand L is not limited to these ligands.

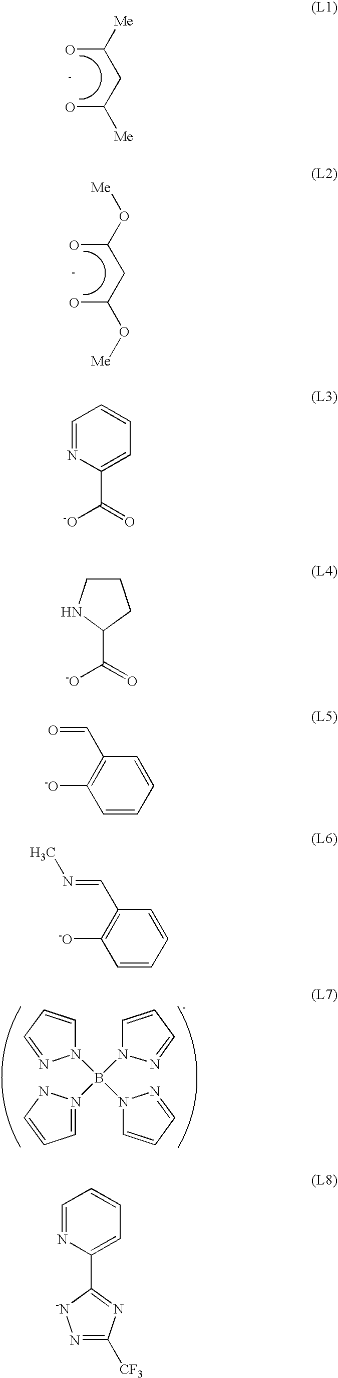

By using the center metal M, a ligand represented by the above general formula (G0), the monoanionic ligand L as described above in combination as appropriate, an organometallic complex of the present invention is constituted. Hereinafter, specific structural formulae (1) to (49) of organometallic complexes of the present invention are given. Note that the present invention is not limited thereto.

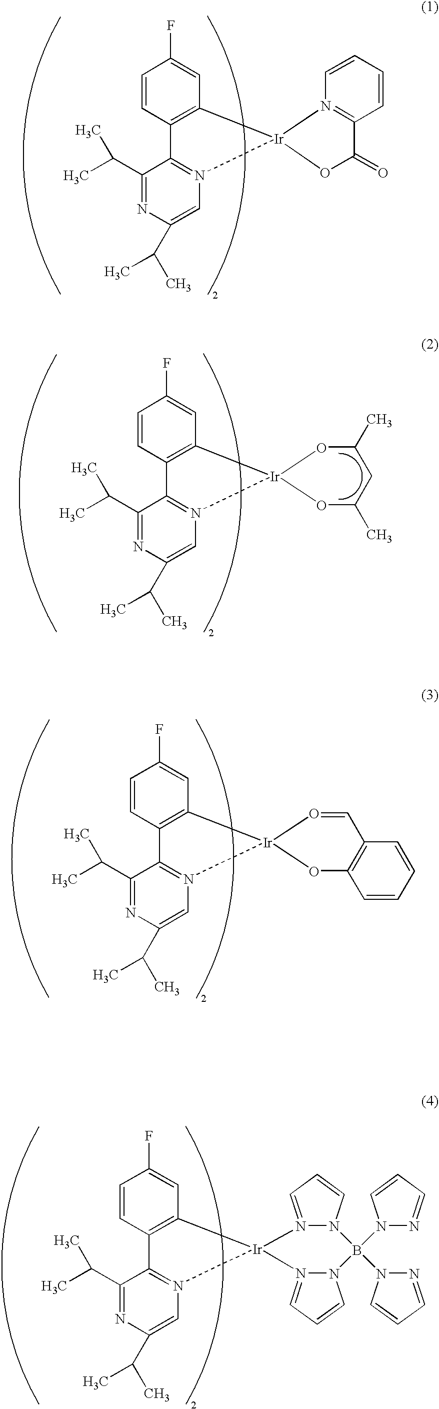

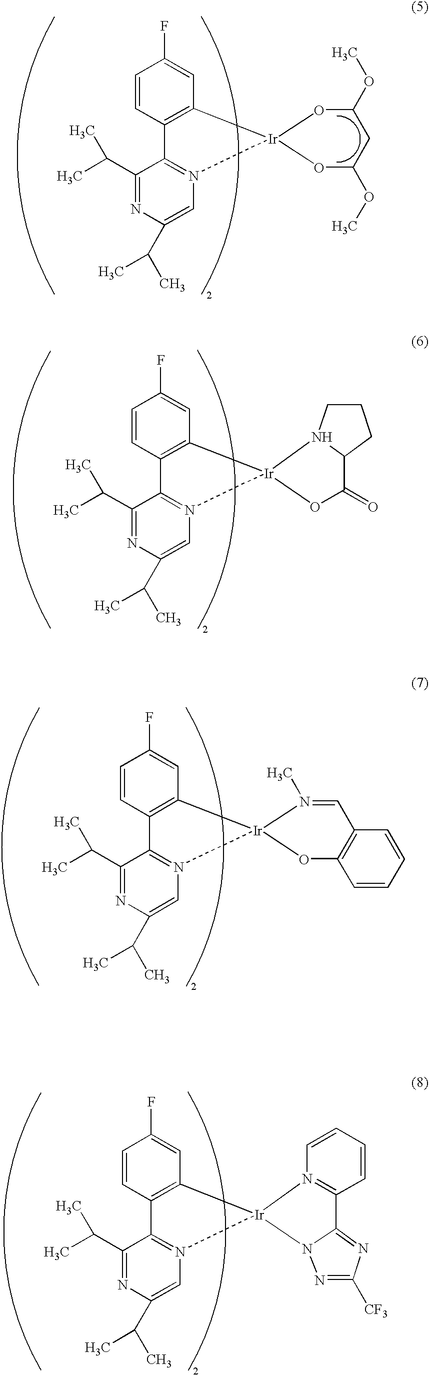

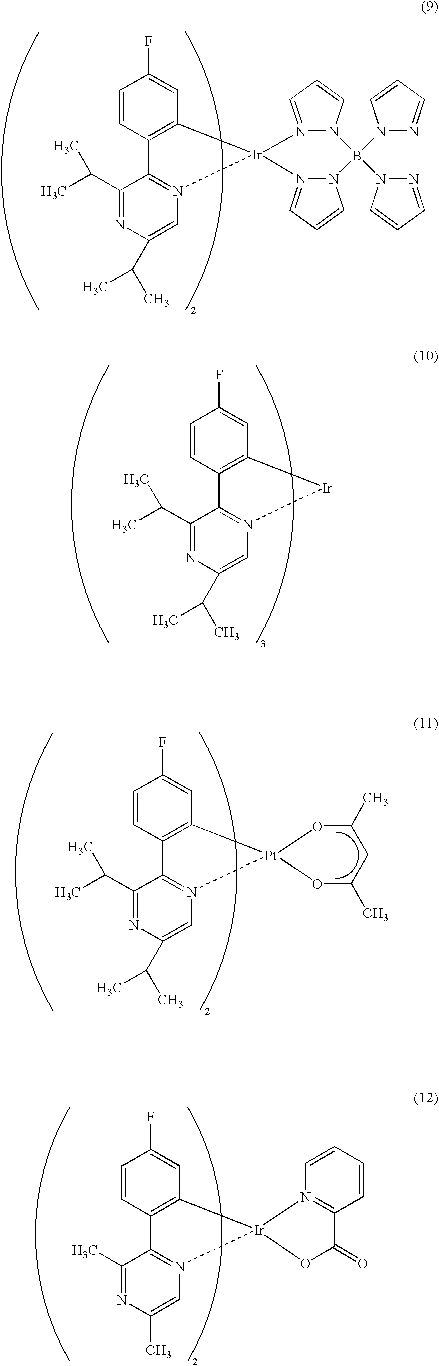

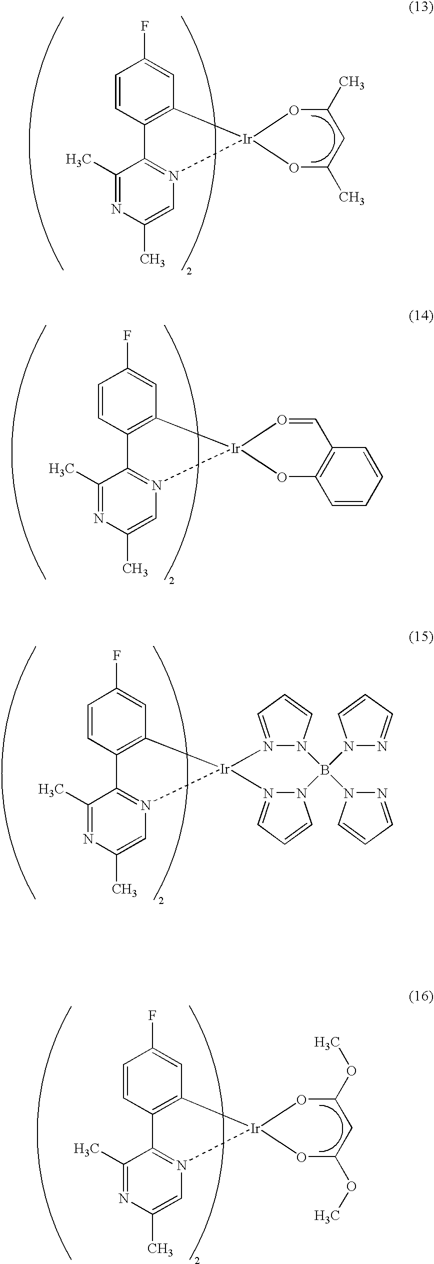

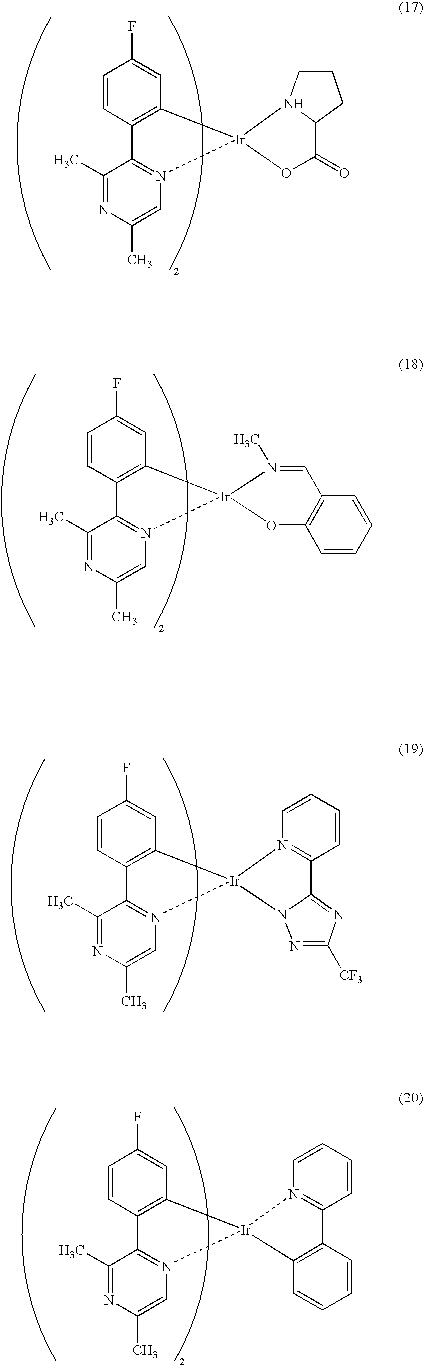

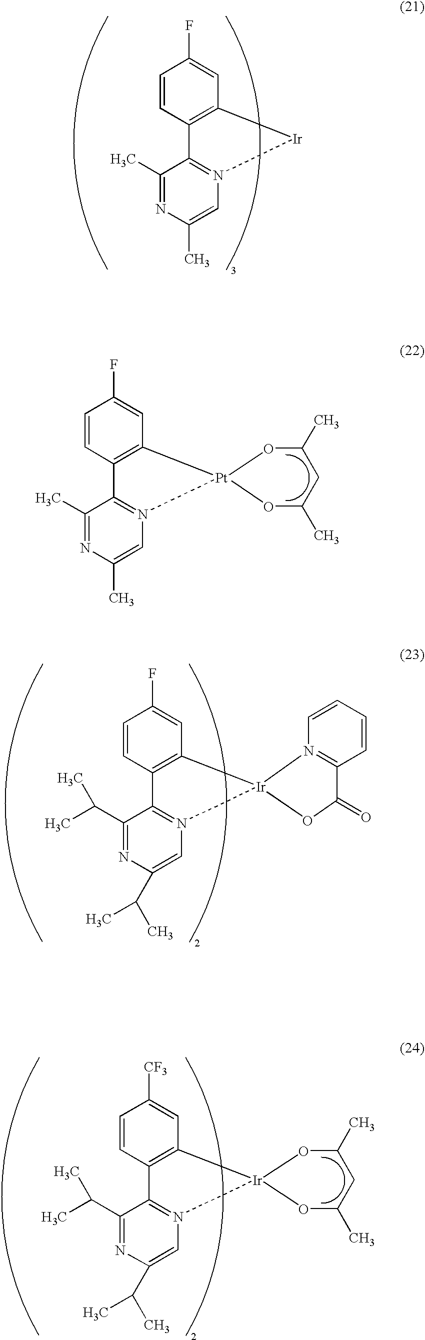

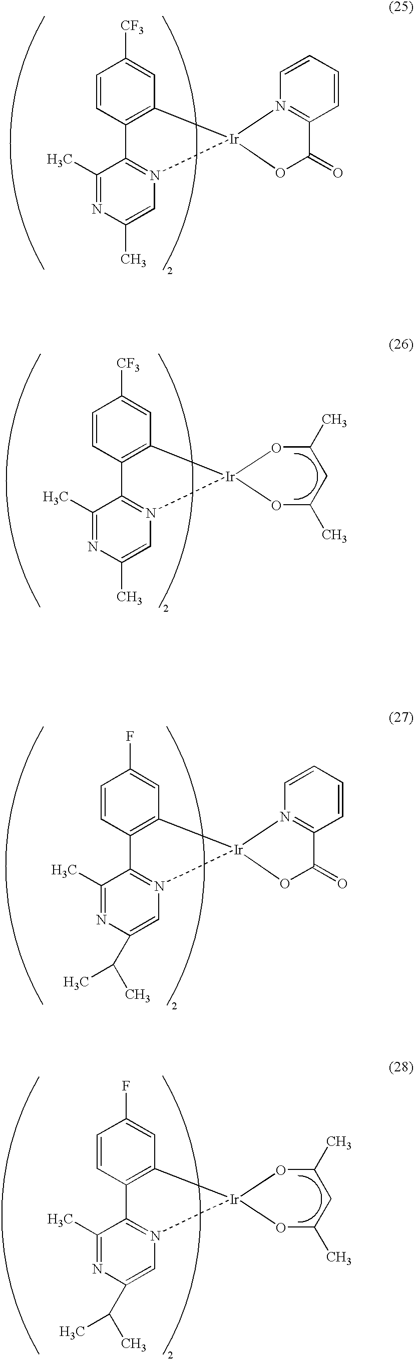

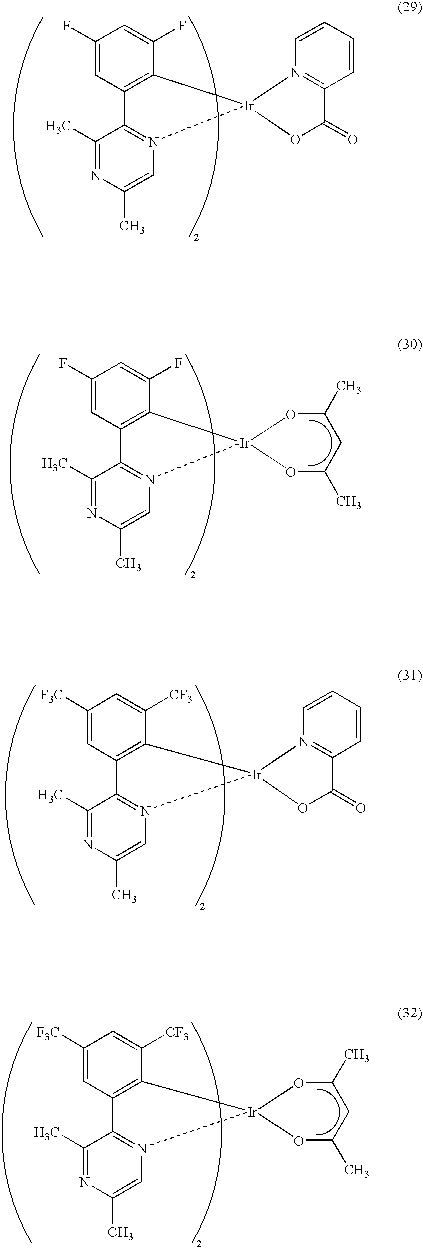

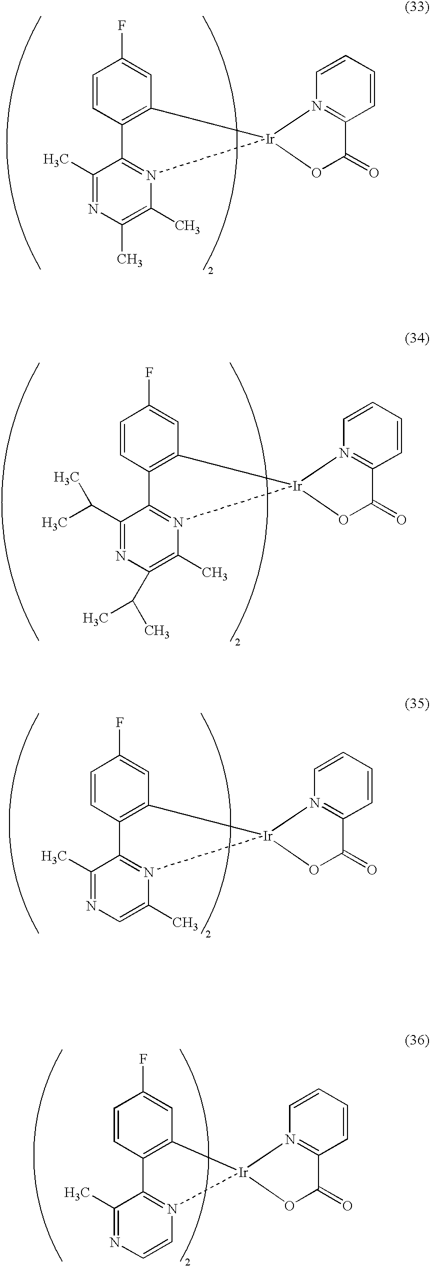

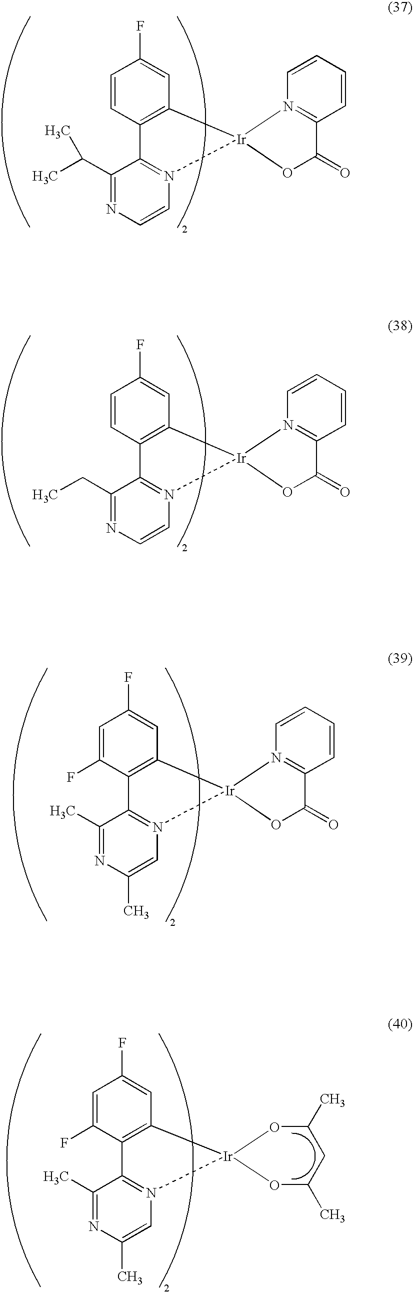

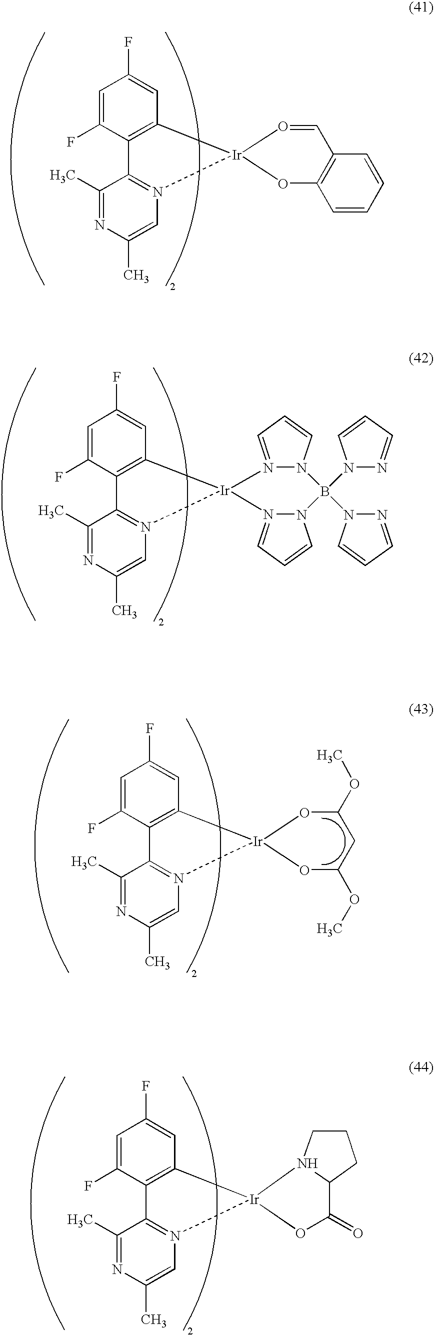

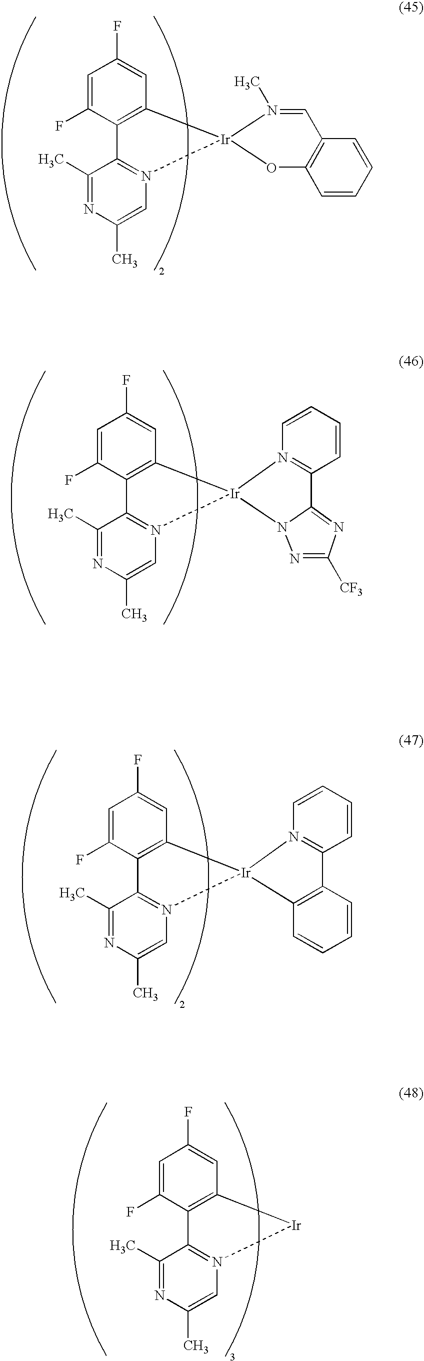

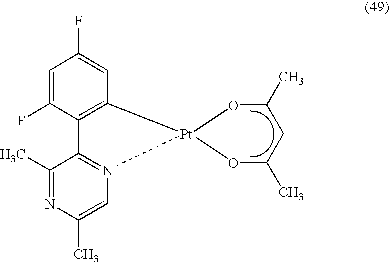

In the organometallic complexes represented by the above structural formulae (1) to (49), there can be a geometrical isomer and a stereoisomer according to the type of ligand. The organometallic complex of the present invention includes all types of such isomers.

In addition, there are two geometrical isomers of a facial isomer and a meridional isomer as the organometallic complex represented by the structural formula (10). The organometallic complex of the present invention includes both isomers.

The foregoing organometallic complex of the present invention can be used as a photosensitizer owing to capability of intersystem crossing. Further, it can exhibit phosphorescence. Thus, the organometallic complexes of the present invention can each be used as a light-emitting material or a light-emitting substance for a light-emitting element. The organometallic complex is a novel organometallic complex which can emit green phosphorescence. Further, it is a novel organometallic complex which has high emission efficiency and can emit green phosphorescence.

### Embodiment Mode 2

In Embodiment Mode 2, a light-emitting element using an organometallic complex described in Embodiment Mode 1 will be described.

A light-emitting element in this embodiment mode includes an EL layer between a pair of electrodes. Note that the element structure is not particularly limited and can be selected as appropriate in accordance with its purposes.

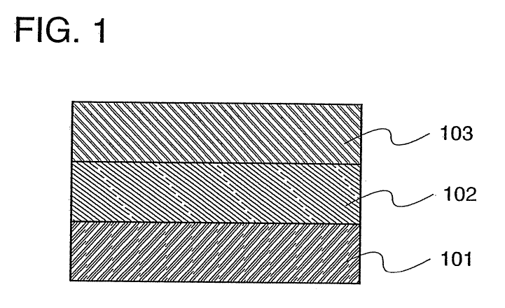

FIG. 1 schematically shows an example of the element structure of a light-emitting element of the present invention. The light-emitting element shown in FIG. 1 has a structure in which an EL layer 102 is interposed between a first electrode 101 and a second electrode 103. The EL layer 102 includes any of the organometallic complexes described in Embodiment Mode 1. Note that an anode in the present invention refers to an electrode for injecting holes into a layer containing a light-emitting material. On the other hand, a cathode in the present invention means an electrode which injects electrons into a layer containing a light-emitting material. Either of the first electrode 101 and the second electrode 103 serves as an anode, and the other serves as a cathode.

For the anode, a known material can be used, and metal, an alloy, a conductive compound, a mixture thereof, or the like having a high work function (specifically, 4.0 eV or higher) is preferably used. Specifically, for example, indium tin oxide (ITO), indium tin oxide including silicon or silicon oxide, indium oxide including zinc oxide (ZnO), indium oxide including tungsten oxide and zinc oxide (IWZO), or the like is given. Films including these conductive metal oxides are generally formed by sputtering; however, a sol-gel method or the like may also be applied. For example, indium oxide including zinc oxide (ZnO) can be formed by a sputtering method using a target in which 1 to 20 wt % zinc oxide is added to indium oxide. A film of indium oxide including tungsten oxide and zinc oxide (IWZO) can be formed by a sputtering method using a target in which 0.5 to 5 wt % tungsten oxide and 0.1 to 1 wt % zinc oxide are included in indium oxide. Further, titanium (Ti), gold (Au), platinum (Pt), nickel (Ni), tungsten (W), chromium (Cr), molybdenum (Mo), iron (Fe), cobalt (Co), copper (Cu), palladium (Pd), nitride of a metal material (e.g., titanium nitride), and the like can be used.

On the other hand, a cathode can be formed by using metal, an alloy, a conductive compound, and a mixture thereof each having a low work function (specifically, 3.8 eV or less). Specifically, metal belonging to Group 1 or 2 of the periodic table, that is, alkali metal such as lithium (Li) or cesium (Cs); alkaline earth metal such as magnesium (Mg), calcium (Ca), or strontium (Sr); or an alloy containing these metals (MgAg, AlLi, or the like); rare-earth metal such as europium (Er) or ytterbium (Yb), an alloy containing these, or the like can be given. A film made of an alkali metal, an alkaline earth metal, or an alloy of them can be formed by a vacuum evaporation method. Further, a film made of an alloy of an alkali metal or an alkaline earth metal can be formed by a sputtering method. It is also possible to deposit a silver paste or the like by an inkjet method or the like.

Note that a conductive composition including a conductive high molecular compound (also referred to as a conductive polymer) can be used for the anode and the cathode. When a thin film of a conductive composition is formed as the anode or the cathode, the thin film preferably has sheet resistance of equal to or less than 10000 Ω/square and light transmittance of equal to or higher than 70% at a wavelength of 550 nm. Note that resistance of a conductive high molecule which is included in the thin film is preferably equal to or lower than 0.1 Ω·cm.

As a conductive high molecule, so-called π electron conjugated high molecule can be used. For example, polyaniline and/or a derivative thereof, polypyrrole and/or a derivative thereof, polythiophene and/or a derivative thereof, and a copolymer of two or more kinds of those materials can be given.

Specific examples of a conjugated conductive high-molecule are given below: polypyrrole,poly(3-methylpyrrole), poly(3-butylpyrrole), poly(3-octylpyrrole), poly(3-decylpyrrole), poly(3,4-dimethylpyrrole), poly(3,4-dibutylpyrrole), poly(3-hydroxypyrrole), poly(3-methyl-4-hydroxypyrrole), poly(3-methoxypyrrole), poly(3-ethoxypyrrole), poly(3-octoxypyrrole), poly(3-carboxylpyrrole), poly(3-methyl-4-carboxylpyrrole), polyN-methylpyrrole, polythiophene, poly(3-methylthiophene), poly(3-butylthiophene), poly(3-octylthiophene), poly(3-decylthiophene), poly(3-dodecylthiophene), poly(3-methoxythiophene), poly(3-ethoxythiophene), poly(3-octoxythiophene), poly(3-carboxylthiophene), poly(3-methyl-4-carboxylthiophene), poly(3,4-ethylenedioxythiophene), polyaniline, poly(2-methylaniline), poly(2-octylaniline), poly(2-isobutylaniline), poly(3-isobutylaniline), poly(2-anilinesulfonic acid), or poly(3-anilinesulfonic acid).

One of the above-described conductive high molecular compounds can be used alone for the anode or the cathode, or an organic resin is added to such a conductive high molecular compound in order to adjust film characteristics such that it can be used as a conductive composition.

As for an organic resin, a thermosetting resin, a thermoplastic resin, or a photocurable resin may be used, as long as such a resin is compatible to a conductive high molecule or a resin can be mixed and dispersed into a conductive high molecule. For example, a polyester-based resin such as polyethylene terephthalate, polybutylene terephthalate, or polyethylene naphthalate; a polyimide-based resin such as polyimide or polyimide amide; a polyamide resin such as polyamide 6, polyamide 6,6, polyamide 12, or polyamide 11; a fluorine resin such as polyvinylidene fluoride, polyvinyl fluoride, polytetrafluoroethylene, ethylenetetrafluoroethylene copolymer, or polychlorotrifluoroethylene; a vinyl resin such as polyvinyl alcohol, polyvinyl ether, polyvinyl butyral, polyvinyl acetate, or polyvinyl chloride; an epoxy resin; a xylene resin; an aramid resin; a polyurethane-based resin; a polyurea-based resin, a melamine resin; a phenol-based resin; polyether; an acrylic-based resin, or a copolymer of any of those resins can be given.

Further, the conductive high molecule or conductive composition may be doped with an acceptor dopant or a donor dopant so that oxidation-reduction potential of a conjugated electron in the conductive high-molecule or the conductive composition may be changed in order to adjust conductivity of the conductive high molecule or conductive composition.

As an acceptor dopant, a halogen compound, an organic cyano compound, an organic metal compound, or the like can be used. Examples of a halogen compound include chlorine, bromine, iodine, iodine chloride, iodine bromide, iodine fluoride, and the like. Lewis acid such as phosphorus pentafluoride, arsenic pentafluoride, antimony pentafluoride, boron trifluoride, boron trichloride, and boron tribromide; proton acid such as inorganic acid such as hydrochloric acid, sulfuric acid, nitric acid, phosphoric acid, fluoroboric acid, hydrofluoric acid, and perchloric acid and organic acid such as organic carboxylic acid and organic sulfonic acid can be used. As the organic carboxylic acid and the organic sulfonic acid, the above-described carboxylic acid compounds or sulfonic acid compounds can be used. As the organic cyano compound, a compound in which two or more cyano groups are included in a conjugated bond can be used. For example, there are tetracyanoethylene, tetracyanoethylene oxide, tetracyanobenzene, tetracyanoquinodimethane, tetracyano azanaphthalene, and the like.

As the donor dopant, there are alkali metal, alkaline-earth metal, a quaternary amine compound, and the like.

Further, a thin film used for the anode or the cathode can be formed by a wet process using a solution in which the conductive high molecule or the conductive composition is dissolved in water or an organic solvent (e.g., an alcohol solvent, a ketone solvent, an ester solvent, a hydrocarbon solvent, or an aromatic solvent).

There is no particular limitation on the solvent in which the conductive high molecule or the conductive composition is dissolved, as long as the above-described conductive high molecule and the high molecular resin compound such as an organic resin are dissolved. For example, the conductive composition may be dissolved in a single solvent or a mixed solvent of the following: water, methanol, ethanol, propylene carbonate, N-methylpyrrolidone, dimethylformamide, dimethylacetamide, cyclohexanone, acetone, methyletylketone, methylisobutylketone, toluene, and/or the like.

Formation of a film using a solution in which the conductive high molecule or conductive composition is dissolved in a solvent can be conducted by a wet process, such as an application method, a coating method, a droplet discharge method (also referred to as an inkjet method), or a printing method. The solvent may dried with thermal treatment or may be dried under reduced pressure. In the case where the organic resin is a thermosetting resin, heat treatment may be performed further. In the case where the organic resin is a photocurable resin, light irradiation treatment may be performed.

The EL layer 102 can be formed using either a low molecular material or a high molecular material. Note that, a material forming the EL layer 102 is not limited to a material containing only an organic compound material, and it may partially contain an inorganic compound material. In addition, the EL layer 102 is generally constituted by combination of functional layers as appropriate, such as a hole-injecting layer, a hole-transporting layer, a hole-blocking layer, a light-emitting layer, an electron-transporting layer, an electron-injecting layer, and the like. The EL layer 102 may include a layer having two or more functions of the above layers, or none of the above layers may be formed. Naturally, a layer having a function other than the above layers may be provided. These functional layers are provided such that a light-emitting region is formed apart from electrodes, in other words, such that carrier recombination occurs in a portion apart from the electrodes. In this embodiment mode, a light-emitting element is exemplified, in which the EL layer 102 has a stacked structure in which a hole-injecting layer, a hole-transporting layer, a light-emitting layer, an electron-transporting layer, and an electron-injecting layer are sequentially stacked over the anode.

The light-emitting element of the present invention is formed using any of the organometallic complexes described in Embodiment Mode 1. The organometallic complexes described in Embodiment Mode 1 have high emission efficiency and are preferable for light-emitting materials of a light-emitting layer. In this case, a light-emitting layer can be formed with a single film of any of the organometallic complexes described in Embodiment Mode 1, or a light-emitting layer can be formed using any of the organometallic complexes described in Embodiment Mode 1 as a dopant with which a host material is doped. The ratio of the organometallic complex serving as a dopant to the host material may be from 0.001 wt % to 50 wt %, preferably from 0.03 wt % to 20 wt %. In a light-emitting element having such a structure, the organometallic complex of Embodiment Mode 1 serves as an emission center so that light can be emitted. Thus, the light-emitting element can be a light-emitting element which has high emission efficiency and emits green phosphorescence. As the host material in the case where any of the organometallic complexes described in Embodiment Mode 1 is used as a dopant for emission center, a material having a larger triplet excitation energy than the triplet excitation energy of the organometallic complex (i.e., an energy difference between a ground state and the triplet excited state) can be used. Specifically, an aromatic amine compound such as 4,4′-bis[N-(1-naphtyl)-N-phenylamino]biphenyl (abbreviation: NPB), 4,4′-bis[N-(9-phenanthryl)-N-phenylamino]biphenyl (abbreviation: PPB), 4,4′-bis[N-(3-methylphenyl)-N-phenylamino]biphenyl (abbreviation: TPD), 4,4′-bis[N-(9,9-dimethylfluoren-2-yl)-N-phenylamino]biphenyl (abbreviation: DFLDPBi), 4,4′,4″-tris(N,N-diphenylamino)triphenylamine (abbreviation: TDATA), 4,4′,4″-tris[N-(3-methylphenyl)-N-phenylamino]triphenylamine (abbreviation: m-MTDATA), 4,4′,4″-tris(N-carbazolyl)triphenylamine (abbreviation: TCTA), 1,1-bis[4-(diphenylamino)phenyl]cyclohexane (abbreviation: TPAC), 9,9-bis[4-(diphenylamino)phenyl]fluorene (abbreviation: TPAF), 4-(9H-carbazol-9-yl)-4′-(5-phenyl-1,3,4-oxadiazol-2-yl)triphenylamine (abbreviation: YGAO11), or N-[4-(9-carbazolyl)phenyl]-N-phenyl-9,9-dimethylfluoren-2-amine (abbreviation: YGAF); a carbazole derivative such as 4,4′-di(N-carbazolyl)biphenyl (abbreviation: CBP), 1,3-bis(N-carbazolyl)benzene (abbreviation: mCP), or 1,3,5-tris(N-carbazolyl)benzene (abbreviation: TCzB); a heteroaromatic compound such as 1,3-bis[5-(p-tert-butylphenyl)-1,3,4-oxadiazol-2-yl]benzene (abbreviation: OXD-7), 2-(4-biphenylyl)-5-(4-tert-butylphenyl)-1,3,4-oxadiazole (abbreviation: PBD); 2,2′,2″-(1,3,5-benzenetriyl)tris(1-phenyl-1H-benzimidazole) (abbreviation: TPBI), 3-(4-tert-butylphenyl)-4-phenyl-5-(4-biphenyl)-1,2,4-triazole (abbreviation: TAZ), 3-(4-tert-butylphenyl)-4-(4-ethylphenyl)-5-(4-biphenylyl)-1,2,4-triazole (abbreviation: p-EtTAZ), 9,9′,9″-[1,3,5-triazine-2,4,6-triyl]tricarbazole (abbreviation: TCzTRz), bathocuproine (abbreviation: BCP); or a metal complex such as tris[2-(2-hydroxyphenyl)-5-phenyl-1,3,4-oxaziazolato]aluminum(III) (abbreviation: Al(OXD)₃), tris(2-hydroxyphenyl-1-phenyl-1-H-benzimidazolato)aluminum(III) (abbreviation: Al(BIZ)₃), bis[2-(2-hydroxyphenyl)benzotihazolato]zinc(II) (abbreviation Zn(BTZ)₂), or bis[2-(2-hydroxyphenyl)benzoxazolato]zinc(II) (abbreviation Zn(PBO)₂) can be used. Further, a high molecular compound such as poly(4-vinyltriphenylamine) (abbreviation: PVTPA) can also be used as such an aromatic amine compound. As such a carbazole derivative, a high molecular compound such as poly(N-vinylcarbazole) (abbreviation: PVK) can also be used.

In addition, the EL layer 102 can be formed by either a wet method or a dry method, such as an evaporation method, an inkjet method, a spin coating method, or a dip coating method.

When a hole-injecting layer is used, a metal oxide such as vanadium oxide, molybdenum oxide, ruthenium oxide, aluminum oxide or the like can be used as a material for the hole-injecting layer. Alternatively, if using an organic compound, a porphyrin-based compound is effective, and phthalocyanine (abbreviation: H₂Pc), copper phthalocyanine (abbreviation: CuPc), or the like can be used. As a hole-injecting layer, a high-molecular compound (such as oligomer, dendrimer, or polymer) can be used. For example, the following high molecular compounds can be used: poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacrylamide] (abbreviation: PTPDMA), and poly[N,N′-bis(4-butylphenyl)-N,N′-bis(phenyl)benzidine (abbreviation: Poly-TPD). Further, high molecular compounds mixed with acid, such as poly (3,4-ethylenedioxythiophene)/poly(styrenesulfonate) (PEDOT/PSS) and polyaniline/poly(styrenesulfonate) (PAni/PSS) can also be used. The hole-injecting layer is formed to be in contact with the anode. By providing the hole-injecting layer, a carrier injection barrier can be lowered and carriers are efficiently injected into the light-emitting element; as a result, a drive voltage can be reduced.

Alternatively, as the hole-injecting layer, a material obtained by making a high hole-transporting material contain an acceptor material (hereinafter, a composite material) can be used. Note that, by using the substance with a high hole-transporting property containing an acceptor substance, the substance can have an ohmic contact with an electrode and a material used to form an electrode may be selected regardless of its work function. In other words, besides a material with a high work function, a material with a low work function may also be used as the anode. As the acceptor substance, 7,7,8,8-tetracyano-2,3,5,6-tetrafluoroquinodimethane (abbreviation: F₄-TCNQ), chloranil, and the like can be given. Furthermore, as the acceptor substance, a transition metal oxide can be given. In addition, an oxide of metals that belong to Group 4 to Group 8 of the periodic table can be given. Specifically, vanadium oxide, niobium oxide, tantalum oxide, chromium oxide, molybdenum oxide, tungsten oxide, manganese oxide, and rhenium oxide are preferable because of their high electron accepting property. Above all, molybdenum oxide is particularly preferable because it is stable even in atmospheric air, has a low hygroscopic property, and is easy to handle.

It is to be noted that, in the present specification, “composition” refers to not only a state where a plurality of materials are simply mixed but also a state where charges are given and received between plural materials by the mixture of the materials.

As the substance having a high hole-transporting property used for the composite material, any of various compounds such as an aromatic amine compound, a carbazole derivative, aromatic hydrocarbon, and a polymer compound (such as an oligomer, a dendrimer, or a polymer) can be used. A substance having a hole mobility of 10⁻⁶ cm²/Vs or higher is preferably used as substance having a high hole-transporting property used for the composite material. However, any other substances can be used as long as they have a hole-transporting property higher than an electron-transporting property. Hereinafter, organic compounds which can be used for the composite material will be specifically listed.

Examples of the aromatic amine compound which can be used for the composite material include N,N′-bis(4-methylphenyl)(p-tolyl)-N,N′-diphenyl-p-phenylenediamine (abbreviation: DTDPPA), 4,4′-bis[N-(4-diphenylaminophenyl)-N-phenylamino]biphenyl (abbreviation: DPAB), 4,4′-bis(N-{4-[N′-(3-methylphenyl)-N′-phenylamino]phenyl}-N-phenylamino)biphenyl (abbreviation: DNTPD), 1,3,5-tris[N-(4-diphenylaminophenyl)-N-phenylamino]benzene (abbreviation: DPA3B), and the like.

Examples of the carbazole derivative which can be used for the composite material include 3-[N-(9-phenylcarbazol-3-yl)-N-phenylamino]-9-phenylcarbazole (abbreviation: PCzPCA1), 3,6-bis[N-(9-phenylcarbazol-3-yl)-N-phenylamino]-9-phenylcarbazole (abbreviation: PCzPCA2), 3-[N-(1-naphtyl)-N-(9-phenylcarbazol-3-yl)amino]-9-phenylcarbazole (abbreviation: PCzPCN1), and the like.

Examples of the carbazole derivative which can be used for the composite material include 4,4′-di(N-carbazolyl)biphenyl (abbreviation: CBP), 1,3,5-tris[4-(N-carbazolyl)phenyl]benzene (abbreviation: TCPB), 9-[4-(10-phenyl-9-anthryl)phenyl]-9H-carbazole (abbreviation: CzPA), 1,4-bis[4-(N-carbazolyl)phenyl]-2,3,5,6-tetraphenylbenzene, and the like.

Examples of the aromatic hydrocarbon which can be used for the composite material include 2-tert-butyl-9,10-di(2-naphthyl)anthracene (abbreviation: t-BuDNA), 2-tert-butyl-9,10-di(1-naphthyl)anthracene, 9,10-bis(3,5-diphenylphenyl)anthracene (abbreviation: DPPA), 2-tert-butyl-9,10-bis(4-phenylphenyl)anthracene (abbreviation: t-BuDBA), 9,10-di(2-naphthyl)anthracene (abbreviation: DNA), 9,10-diphenylanthracene (abbreviation: DPAnth), 2-tert-butylanthracene (abbreviation: t-BuAnth), 9,10-bis(4-methyl-1-naphthyl)anthracene (abbreviation: DMNA), 9,10-bis[2-(1-naphthyl)phenyl]-2-tert-butyl-anthracene, 9,10-bis[2-(1-naphthyl)phenyl]anthracene, 2,3,6,7-tetramethyl-9,10-di(1-naphthyl)anthracene, 2,3,6,7-tetramethyl-9,10-di(2-naphthyl)anthracene, 9,9′-bianthryl, 10,10′-diphenyl-9,9′-bianthryl, 10,10′bis(2-phenylphenyl)-9,9′-bianthryl, 10,10′-bis[(2,3,4,5,6-pentaphenyl)phenyl]-9,9′-bianthryl, anthracene, tetracene, rubrene, perylene, 2,5,8,11-tetra(tert-butyl)perylene, and the like. Further, pentacene, coronene, or the like can be used. Thus, an aromatic hydrocarbon having a hole mobility of equal to or greater than 1×10⁻⁶ cm²/Vs and having 14 to 42 carbon atoms is preferable.

Note that the aromatic hydrocarbon which can be used for the composite material may have a vinyl skeleton. Examples of the aromatic hydrocarbon having a vinyl skeleton are 4,4′-bis(2,2-diphenylvinyl)biphenyl (abbreviation: DPVBi) 9,10-bis[4-(2,2-diphenylvinyl)phenyl]anthracene (abbreviation: DPVPA), and the like.

Note that the hole-injecting layer can be formed using a composite material of the above-described high molecular compound, such as PVK, PVTPA, PTPDMA, or Poly-TPD, and the above-described acceptor substance.

As described above, when a composite material is used for the hole-injecting layer, various metals, alloys, electrically conductive compounds or mixture thereof can be used, regardless of the work function. For example, aluminum (Al), silver (Ag), an aluminum alloy (e.g., AlSi), or the like can be used as the anode, in addition to the above-described materials. Alternatively, any of the following low-work function materials can be used: Group 1 and Group 2 elements of the periodic table, that is, alkali metals such as lithium (Li) and cesium (Cs) and alkaline-earth metals such as magnesium (Mg), calcium (Ca), and strontium (Sr), and alloys thereof (MgAg, AlLi); rare earth metals such as europium (Eu) and ytterbium (Yb), and alloys thereof; and the like. A film made of an alkali metal, an alkaline earth metal, or an alloy of them can be formed by a vacuum evaporation method. Further, a film made of an alloy of an alkali metal or an alkaline earth metal can be formed by a sputtering method. It is also possible to deposit a silver paste or the like by an inkjet method or the like.

The hole-transporting layer can be formed of an appropriate material such as N,N′-bis(spiro-9,9′-bifluorene-2-yl)-N,N′-diphenylbenzidine (abbreviation: BSPB) 4,4′-bis[N-(1-naphthyl)-N-phenylamino]biphenyl (abbreviation: NPB or α-NPD), 4,4′-bis[N-(3-methylphenyl)-N-phenylamino]biphenyl (abbreviation: TPD), 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), 4,4′-bis{N-[4-(N,N-di-m-tolylamino)phenyl]-N-phenylamino}biphenyl (abbreviation: DNTPD), 1,3,5-tris[N,N-di(m-tolyl)amino]benzene (abbreviation: m-MTDAB), 4,4′,4″-tris(N-carbazolyl)triphenylamine (abbreviation: TCTA), phthalocyanine (abbreviation: H₂Pc), copper phthalocyanine (abbreviation: CuPc), or vanadyl phthalocyanine (abbreviation: VOPc). Note that the hole-transporting layer is preferably formed using a substance having a hole mobility of 1×10⁻⁶ cm²/Vs or higher, but any material can be used as long as the material has a hole-transporting property higher than an electron-transporting property. The hole-transporting layer may be formed with not only a single layer but also a multilayer of two or more layers made of substances which satisfy the above conditions.

As the hole-transporting layer, the compound with a high molecular-weight such as PVK, PVTPA, PTPDMA, or Poly-TPD can be used.

Note that the hole-transporting layer in contact with a light-emitting layer is preferably formed with a substance having higher excitation energy than that of the organometallic complex described in Embodiment Mode 1. In other words, a substance having a triplet excitation energy larger than the organometallic complex of Embodiment Mode 1 is preferably used for the hole-transporting layer. With such structures, energy transfer from the light-emitting layer to the hole-transporting layer can be suppressed, and high emission efficiency can be achieved. As a substance having a hole transporting property which is higher than an electron-transporting property, and having high triplet excitation energy, the following can be given: 4,4′,4″-tris(N-carbazolyl)triphenylamine (abbreviation: TCTA), 1,1-bis[4-(diphenylamino)phenyl]cyclohexane (abbreviation: TPAC), 9,9-bis[4-(diphenylamino)phenyl]fluorene (abbreviation: TPAF), 4,4′-di(N-carbazolyl)biphenyl (abbreviation: CBP), and the like.

In the case of using an electron-transporting layer, the electron-transporting layer is arranged between the light emitting layer and an electron-injecting layer. As a suitable material, a metal complex or the like having a quinoline or benzoquinoline skeleton can be used, such as tris(8-quinolinolato)aluminum(III) (abbreviation: Alq₃); tris(4-methyl-8-quinolinolato)aluminum(III) (abbreviation: Almq₃); bis(10-hydroxybenzo[h]quinolinato)beryllium(II) (abbreviation: BeBq₂), or bis(2-methyl-8-quinolinolato)(4-phenylphenolato)aluminum(III) (abbreviation: BAlq). Alternatively, a metal complex or the like having an oxazole-based or thiazole-based ligand, such as bis[2-(2-hydroxyphenyl)benzoxazolato]zinc(II) (abbreviation: Zn(BOX)₂) or bis[2-(2-hydroxyphenyl)benzothiazolato]zinc(II) (abbreviation: Zn(BTZ)₂) can be used. In addition to the metal complex, 2-(4-biphenylyl)-5-(4-tert-butylphenyl)-1,3,4-oxadiazole (abbreviation: PBD); 1,3-bis[5-(p-tert-butylphenyl)-1,3,4-oxadiazol-2-yl]benzene (abbreviation: OXD-7), bathophenanthroline (abbreviation: BPhen), bathocuproine (BCP), or the like can be used. A substance having an electron mobility of 10⁻⁶ cm²/Vs or higher is preferably used for the electron-transporting layer. However, any other substances may also be used as long as they have an electron-transporting property higher than a hole-transporting property. Furthermore, the electron-transporting layer may be formed with not only a single layer but also a multilayer of two or more layers made of substances which satisfy the above conditions.

For the electron-transporting layer, a high molecular compound can be used. For example, poly[(9,9-dihexylfluorene-2,7-diyl)-co-(pyridine-3,5-diyl)] (abbreviation: PF-Py), poly[(9,9-dioctylfluorene-2,7-diyl)-co-(2,2′-bipyridine-6,6′-diyl)] (abbreviation: PF-BPy), or the like can be used.

Note that the electron-transporting layer in contact with the light-emitting layer is preferably formed with a substance having higher excitation energy than that of an organometallic complex in Embodiment Mode 1. Specifically, the electron-transporting layer is preferably formed with a substance having higher triplet excitation energy than that of an organometallic complex in Embodiment Mode 1. With such structures, energy transfer from the light-emitting layer to the electron-transporting layer can be suppressed, and high emission efficiency can be achieved. As a substance having an electron-transporting property which is higher than a hole-transporting property and having high triplet excitation energy, the following can be given: 3-(4-biphenylyl)-4-phenyl-5-(4-tert-butylphenyl)-1,2,4-triazole (abbreviation: TAZ01); 2,2′,2″-(1,3,5-benzenetriyl)tris(1-phenyl-1H-benzimidazole) (abbreviation: TPBI); 3-(4-tert-butylphenyl)-4-phenyl-5-(4-biphenyl)-1,2,4-triazole (abbreviation: TAZ); 3-(4-tert-butylphenyl)-4-(4-ethylphenyl)-5-(4-biphenylyl)-1,2,4-triazole (abbreviation: p-EtTAZ); 9,9′,9″-[1,3,5-triazine-2,4,6-triyl]tricarbazole (abbreviation: TCzTRZ); and the like.

In the case of using an electron-injecting layer, there is no particular limitation on an electron-injecting material used for forming the electron-injecting layer. Specifically, an alkali metal compound or an alkaline earth metal compound such as calcium fluoride, lithium fluoride, lithium oxide, or lithium chloride, or the like is preferable. Alternatively, a layer in which an electron-transporting material such as tris(8-quinolinorato)aluminum (abbreviation: Alq₃) or bathocuproine (abbreviation: BCP) is combined with an alkali metal or an alkaline earth metal such as lithium or magnesium can also be used. The electron-injecting layer is formed to be in contact with a cathode and by using the electron-injecting layer, a carrier injection barrier can be lowered and carriers are efficiently injected into the light-emitting element; as a result, a drive voltage can be reduced. It is more preferable to use the layer, in which a substance having an electron-transporting property is combined with an alkali metal or an alkaline earth metal, since electron injection from the cathode efficiently proceeds.

Further, when the electron-injecting layer is provided between the cathode and the electron-transporting layer, any of a variety of conductive materials such as Al, Ag, ITO, and indium tin oxide containing silicon or silicon oxide can be used for the second electrode 103 regardless of its work function.

In the light-emitting element described in this embodiment mode having such a structure, current flows by application of voltage between the first electrode 101 and the second electrode 103. In the light-emitting layer of the EL layer 102, holes and electrons are recombined, so that light is emitted. That is, a light-emitting region is formed in the light-emitting layer.

The light-emitting element of the present invention is not particularly limited to the above structure, and any light-emitting element in which the EL layer 102 including an organometallic complex described in Embodiment Mode 1 is interposed between the first electrode 101 and the second electrode 103 is included in the category of the present invention.

Although this embodiment mode describes a structure of a light-emitting element which provides light emission only from the light-emitting layer, a light-emitting element may be designed so as to provide light emission from not only a light-emitting layer but also another layer such as an electron-transporting layer or a hole transporting layer. For example, light emission can be obtained from not only a light-emitting layer but also a transporting layer by adding a dopant which contributes to light emission to an electron-transporting layer or a hole transporting layer. When light-emitting materials used for a light-emitting layer and a transporting layer have different light emission colors, a spectrum with emission colors thereof overlapped with each other can be obtained. If emission colors of the light-emitting layer and the transporting layer have the relationship of complementary colors, white light emission can be obtained.

Further, it is possible that a plurality of light-emitting layers can be provided. In a case where the plurality of light-emitting layers emit light with different wavelengths from each other, light of a spectrum in which the light with different wavelengths are overlapped can be obtained from the light-emitting element. For example, in a case where two light-emitting layers are provided and they emit light with complementary colors, or in a case where three light-emitting layers are provided and the respective layers emit red, green and blue, white emission can be obtained.

Note that the light-emitting element in this embodiment mode can have a wide variety of modes by varying the kinds of the first electrode 101 and the second electrode 103. When a light-transmitting material is used for the first electrode 101, light can be emitted from the first electrode 101 side. When a light blocking (particularly, a reflective) material is used for the first electrode 101 and a light-transmitting material is used for the second electrode 103, light can be emitted from the second electrode 103 side. Furthermore, when light-transmitting materials are used for both the first electrode 101 and the second electrode 103, light can be emitted from both the first electrode 101 side and the second electrode 103 side.

The light-emitting element in this embodiment mode includes the EL layer between the first electrode 101 and the second electrode 103, and the EL layer includes any of the organometallic complexes described in Embodiment Mode 1. The organometallic complexes emit green phosphorescence and thus the light-emitting element in this embodiment mode is a light-emitting element which emits green phosphorescence. In addition, the organometallic complexes described in Embodiment Mode 1 emit green phosphorescence with high emission efficiency, and thus the light-emitting element in this embodiment mode also has high emission efficiency and emits green phosphorescence.

A light-emitting device using the light-emitting element having high emission efficiency in this embodiment mode can emit light greatly even with the same current density. In other words, the light-emitting device using the light-emitting element in this embodiment mode can emit light with the same luminance with smaller power consumption, and it can be a power-saving light-emitting element.

### Embodiment Mode 3

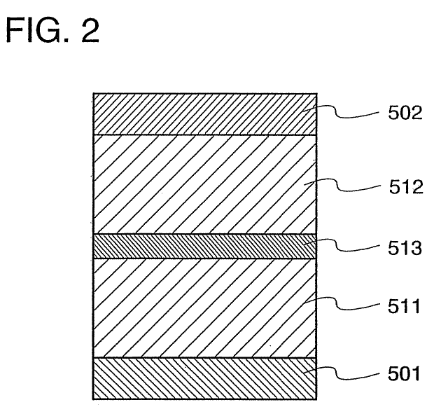

Embodiment Mode 3 will describe a mode of a light-emitting element in which a plurality of light-emitting units are stacked (hereinafter, also referred to as a stacked type element) with reference to FIG. 2. The light-emitting element is a stacked-type light-emitting element including a plurality of light-emitting units between a first electrode and a second electrode (in other words, in the EL layer 102 in Embodiment Mode 2). A structure similar to that described as the EL layer 102 in Embodiment Mode 2 can be used for each light-emitting unit. In other words, the light-emitting element described in Embodiment Mode 2 is a light-emitting element having one light-emitting unit. In this embodiment mode, a light-emitting element having a plurality of light-emitting units will be explained.

In FIG. 2, a first light-emitting unit 511 and a second light-emitting unit 512 are stacked between a first electrode 501 and a second electrode 502. To the first electrode 501 and the second electrode 502, similar materials or fabrication methods to those shown in Embodiment Mode 2 can be applied. The first light-emitting unit 511 and the second light-emitting unit 512 may have the same structure or different structures, and as the structures, a similar structure to that shown in Embodiment Mode 2 can be employed.

A charge generation layer 513 includes a composite material of an organic compound and a metal oxide. The composite material of an organic compound and a metal oxide is the composite material shown in Embodiment Mode 2, and includes an organic compound and a metal oxide such as vanadium oxide, molybdenum oxide or tungsten oxide. As the organic compound, various compounds such as an aromatic amine compound, a carbazole derivative, aromatic hydrocarbon, and a high molecular compound (oligomer, dendrimer, polymer, or the like) can be used. As the organic compound, it is preferable to use the organic compound which has a hole-transporting property and has a hole mobility of 10⁻⁶ cm²/Vs or higher. However, any other substances than the materials described above may also be used as long as the substances have hole-transporting properties higher than the electron-transporting properties. The composite material of the organic compound and the metal oxide can achieve low-voltage driving and low-current driving because of the superior carrier-injecting property and carrier-transporting property.

Note that the charge generation layer 513 may be formed by combination of a composite material of the organic compound and the metal oxide with another material. For example, a layer containing a composite material of the organic compound and the metal oxide may be combined with a layer containing a compound of a substance selected from substances with an electron-donating property and a compound with a high electron-transporting property. Moreover, a layer containing a composite material of the organic compound and the metal oxide may be combined with a transparent conductive film.

In any cases, the charge generation layer 513 interposed between the first light-emitting unit 511 and the second light-emitting unit 512 is acceptable as long as electrons are injected to a light-emitting unit on one side and holes are injected to a light-emitting unit on the other side when a voltage is applied to the first electrode 501 and the second electrode 502. For example, in a case of applying a voltage so that a potential of the first electrode is higher than potential of the second electrode, any structure is acceptable for the charge generation layer 513 as long as the charge generation layer 513 injects electrons and holes into the first light-emitting unit 511 and the second light-emitting unit 512, respectively.

Although the light-emitting element having two light-emitting units is described in this embodiment mode, a light-emitting element in which three or more light-emitting units are stacked can also be employed similarly. By arranging a plurality of light-emitting units that are partitioned by a charge generation layer between a pair of electrodes, as in the light-emitting element according to this embodiment mode, an element having the long life in a high luminance region can be realized while keeping a current density low. In addition, when the light-emitting element is applied to an illumination apparatus for example, uniform light emission in a large area is possible because voltage drop due to resistance of an electrode material can be decreased. Furthermore, a light-emitting device that can drive at a low voltage and consumes low power can be achieved.

In a case where the plural light-emitting units in a light-emitting element emit light with different wavelengths from each other, light of a spectrum in which the light with different wavelengths are overlapped can be obtained from the light-emitting element. For example, in a case where two light-emitting units are provided and they emit light with complementary colors, or in a case where three light-emitting units are provided and the respective layers emit red, green and blue, white emission can be obtained from the light-emitting element. In the former structure, any of the organometallic complexes described in Embodiment Mode 1 is used for the one light-emitting unit, and in the latter structure, any of the organometallic complexes described in Embodiment Mode 1 is used for the light-emitting unit for green emission, thereby forming the light-emitting element.

Note that this embodiment mode can be combined with any of the other embodiment modes as appropriate.

### Embodiment Mode 4

Embodiment Mode 4 will describe an example of a light-emitting device formed using a light-emitting element including an organometallic complex described in Embodiment Mode 1, in other words, the light-emitting element described in Embodiment Mode 2 or 3. Note that the light-emitting device of the present invention is not limited to the light-emitting device having a structure to given below, and it includes all modes. e.g., a mode in which a display portion (e.g., a display portion 602 in this embodiment mode) includes any of the organometallic complexes described in Embodiment Mode 1.

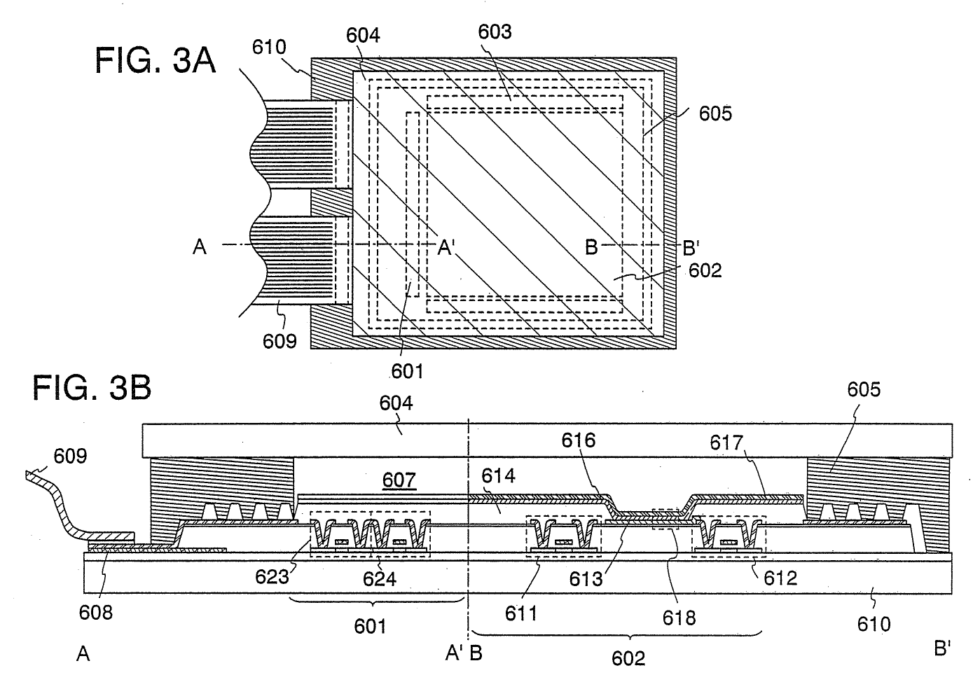

An example of a light-emitting device formed using a light-emitting element including an organometallic complex described in Embodiment Mode 1, in other words, the light-emitting element described in Embodiment Mode 2 or 3 is described with reference to FIG. 3. FIG. 3A is a top view of the light-emitting device, and FIG. 3B is a cross sectional view taken along A-A′ and B-B′ of FIG. 3A. This light-emitting device includes a driver circuit portion (source side driver circuit) 601, a pixel portion 602, and a driver circuit portion (gate side driver circuit) 603 in order to control the light emission of the light-emitting element. Also, a reference numeral 604 represents a sealing substrate, a reference numeral 605 represents a sealant, and the inside that is surrounded by the sealant 605 is a space 607.

A leading wiring 608 is a wiring for transmitting a signal to be inputted to the source driver circuit 601 and the gate driver circuit 603, and this wiring 608 receives a video signal, a clock signal, a start signal, a reset signal, and the like from an FPC (flexible printed circuit) 609 that is an external input terminal. Although only the FPC is illustrated here, the FPC may be provided with a printed wiring board (PWB). The light-emitting device in this specification includes not only the light-emitting device itself but also a state in which an FPC or a PWB is attached thereto.

Next, a cross-sectional structure will be explained with reference to FIG. 3B. The driver circuit areas and the pixel portion are formed over an element substrate 610. Here, the source driver circuit 601 which is the driver circuit area and one pixel in the pixel portion 602 are shown.

A CMOS circuit combining an n-channel TFT 623 and a p-channel TFT 624 is formed for the source side driving circuit 601. The driver circuit may be formed by various CMOS circuits, PMOS circuits, or NMOS circuits. A driver integration type in which a driver circuit is formed over the same substrate is described in this embodiment mode, but it is not necessarily formed over the same substrate and a driver circuit can be formed not over a substrate but outside a substrate.

The pixel portion 602 has a plurality of pixels, each of which includes a switching TFT 611, a current control TFT 612, a first electrode 613 which is electrically connected to a drain of the current control TFT 612, and a light-emitting element including the first electrode 613, an EL layer 616 and a second electrode 617. Note that an insulator 614 is formed so as to cover an end portion of the first electrode 613. In this embodiment mode, the insulator 614 is formed using a positive photosensitive acrylic resin film

In order to obtain favorable coverage, the insulator 614 is formed to have a curved surface with curvature at an upper end portion or a lower end portion thereof. For example, in the case of using a positive photosensitive acrylic resin as a material for the insulator 614, the insulator 614 is preferably formed so as to have a curved surface with a curvature radius (0.2 μm to 3 μm) only at the upper end portion thereof. Either a negative type which becomes insoluble in an etchant by light irradiation or a positive type which becomes soluble in an etchant by light irradiation can be used as the insulator 614.

An EL layer 616 and a second electrode 617 are formed over the first electrode 613, so that a light-emitting element is formed. As a material used for the first electrode 613 serving as an anode, metal, an alloy, a conductive compound, and a mixture thereof each having a high work function (specifically, 4.0 eV or higher) is preferably used. Typically, a single layer of indium tin oxide (ITO), indium tin oxide containing silicon of silicon oxide, indium oxide containing zinc oxide (ZnO), indium oxide including tungsten oxide and zinc oxide (IWZO), titanium (Ti), gold (Au), platinum (Pt), nickel (Ni), tungsten (W), chromium (Cr), molybdenum (Mo), iron (Fe), cobalt (Co), copper (Cu), palladium (Pd), or nitride of a metal material (e.g., titanium nitride), can be used. Moreover, a multilayer including a film containing titanium nitride and a film containing aluminum as its main component; a three-layer structure including a titanium nitride film, a film containing aluminum as its main component, and a titanium nitride film; or the like can be used. The multilayer structure achieves to have low wiring resistance, favorable ohmic contact, and a function as an anode.

The EL layer 616 includes any of the organometallic complexes described in Embodiment Mode 1. Either low molecular compounds or high molecular compounds (including oligomers and dendrimers) may be employed as the material used for the EL layer 616. Further, not only organic compounds but also inorganic compounds can be partially used for the material for forming the EL layer 616. In addition, the EL layer 616 is formed by various methods such as an evaporation method using an evaporation mask, an inkjet method, and a spin coating method.

As a material used for the second electrode 617, which is formed over the EL layer 616 and serves as a cathode, a material having a low work function (Al, Mg, Li, Ca, or an alloy or a compound thereof such as MgAg, MgIn, AlLi, LiF, or CaF₂) is preferably used. In a case where light generated in the EL layer 616 is transmitted through the second electrode 617, stacked layers of a metal thin film with reduced thickness and a transparent conductive film (ITO, indium oxide containing 2 to 20 wt % zinc oxide, indium tin oxide containing silicon or silicon oxide, zinc oxide (ZnO), or the like) are preferably used as the second electrode 617.

Here, the light-emitting element 618 includes the first electrode 613, the EL layer 616 and the second electrode 617. The specific structures and materials of the light-emitting element have been described in Embodiment Mode 2, and the repeated description is omitted. The description in Embodiment Mode 2 is to be referred to. Note that the first electrode 613, the EL layer 616 and the second electrode 617 correspond to the first electrode 101, the EL layer 102 and the second electrode 103, respectively.

The element substrate 610 in which TFTs for a driver circuit and the pixel portion as described above and the light-emitting element are formed is attached to the sealing substrate 604 with a sealant 605, and thereby, a light-emitting device can be provided, in which the light-emitting element 618 described in Embodiment Mode 2 is provided in the space 607 surrounded by the element substrate 610, the sealing substrate 604, and the sealant 605. Note that the space 607 is filled with a filler. There are cases where the space 607 may be filled with an inert gas (such as nitrogen or argon), or where the space 607 may be filled with the sealant 605.

Note that an epoxy-based resin is preferably used as the sealant 605. It is preferable that the material allow as little moisture and oxygen as possible to penetrate therethrough. As the sealing substrate 604, a plastic substrate formed of FRP (Fiberglass-Reinforced Plastics), PVF (polyvinyl fluoride), a polyester film, polyester, acrylic, or the like can be used besides a glass substrate or a quartz substrate.

As described above, a light-emitting device of the present invention formed using the light-emitting element including an organometallic complex of Embodiment Mode 1, i.e., the light-emitting element described in Embodiment Mode 2 or 3 can be obtained.

A light-emitting device of the present invention can have favorable characteristics since the organometallic complex described in Embodiment Mode 1 is used for the light-emitting device. In addition, the light-emitting device can have high emission efficiency.

By using an organometallic complex described in Embodiment Mode 1, a saving-power light-emitting device can be provided.

Since the organometallic complexes of Embodiment Mode 1 emit green phosphorescence, they are suitable for use in full-color display. Therefore, a full-color display utilizing a feature of a phosphorescent compound, high emission efficiency can be realized.

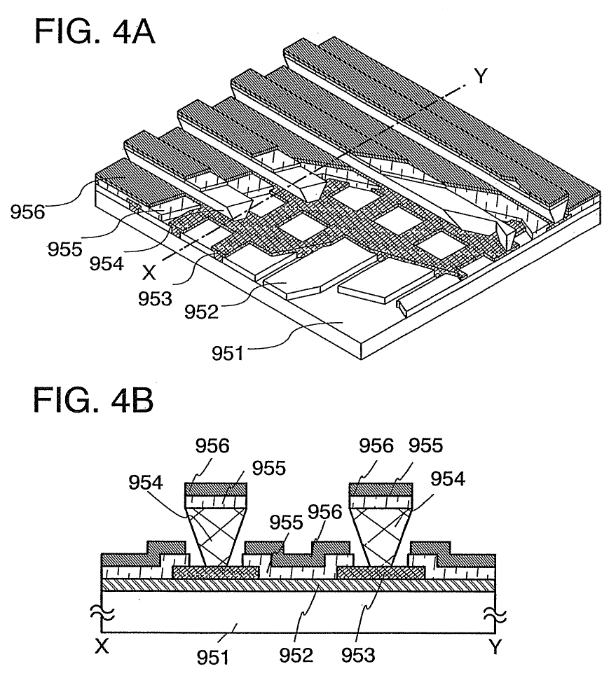

This embodiment mode has described the active light-emitting device in which the driving of the light-emitting element is controlled by a transistor. However, a passive light-emitting device may be adopted. FIG. 4A is a perspective view of a passive matrix type light-emitting device formed according to the present invention. FIG. 4A is a perspective view of the light-emitting device, and FIG. 4B is a cross-sectional view taken along a line X-Y of FIG. 4A. In FIGS. 4A and 4B, over a substrate 951, an EL layer 955 is provided between an electrode 952 and an electrode 956. An end of the electrode 952 is covered with an insulating layer 953. Sidewalls of the partition layer 954 are slanted so that a distance between one of the sidewalls and the other becomes narrower toward a substrate surface. In other words, a cross section of the partition layer 954 in the direction of a narrow side is trapezoidal, and a base (a side facing in the same direction as a plane direction of the insulating layer 953 and in contact with the insulating layer 953) is shorter than an upper side (a side facing in the same direction as the plane direction of the insulating layer 953 and not in contact with the insulating layer 953). The partition layer 954 provided in this manner can prevent the light-emitting element from being defective due to static electricity or the like. Also, the passive matrix type light-emitting device can be formed using a light-emitting element including an organometallic complex described in Embodiment Mode 1, i.e., the light-emitting element described in Embodiment Mode 2 or 3. The light-emitting device formed using the light-emitting element with high emission efficiency can also have high emission efficiency, and can be a power-saving light-emitting device.

### Embodiment Mode 5

Embodiment Mode 5 will describe electronic devices which include the light-emitting device described in Embodiment Mode 4 as a part. These electronic devices each include a display portion including a light-emitting element including an organometallic complex described in Embodiment Mode 1, i.e., the light-emitting element described in Embodiment Mode 2 or 3.

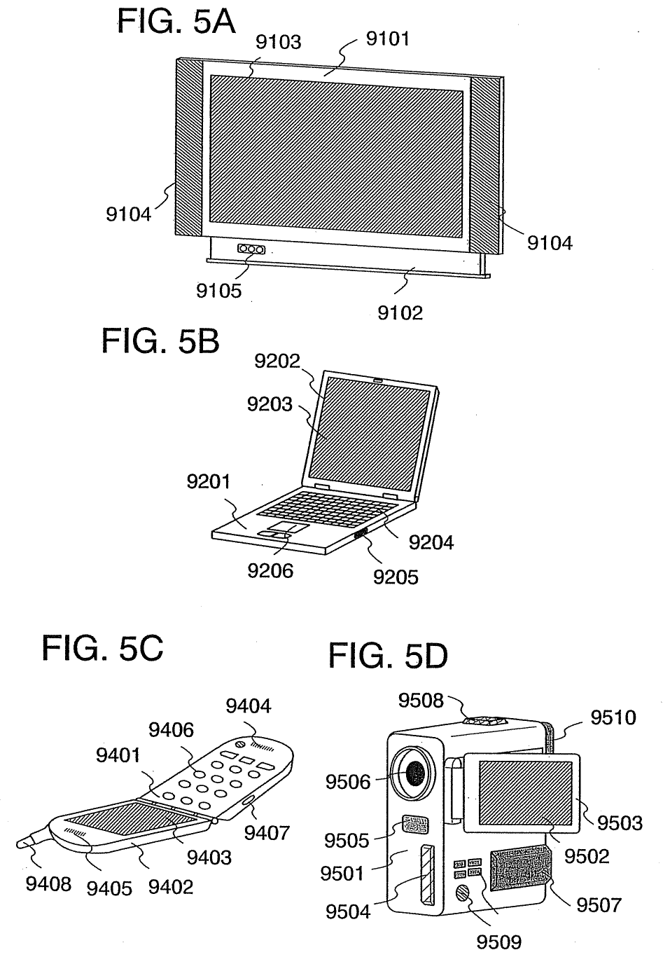

Examples of such electronic devices a light-emitting element including an organometallic complex described in Embodiment Mode 1, i.e., the light-emitting element described in Embodiment Mode 2 or 3 include cameras such as video cameras and digital cameras, goggle-type displays, navigation systems, audio reproducing devices (such as car audio components and audio components), computers, game machines, portable information terminals (such as mobile computers, mobile phones, mobile game machines, and electronic books), and image reproducing devices provided with a recording medium (specifically, a device which reproduces a recording medium such as a digital versatile disc (DVD) and has a display device for displaying the reproduced image). Specific examples of these electronic devices are shown in FIGS. 5A to 5D.

FIG. 5A shows a television set of the present invention which includes a housing 9101, a supporting base 9102, a display portion 9103, speaker portions 9104, a video input terminal 9105, and the like. The display portion 9103 of the television set is formed by using a light-emitting element including an organometallic complex described in Embodiment Mode 1, i.e., the light-emitting element described in Embodiment Mode 2 or 3 as a display element. The power consumption of the display portion 9103 in the television set formed using the light-emitting element with high emission efficiency is reduced, and the television set having the display portion 9103 is a power-saving television set. The light-emitting element has high emission efficiency, exhibits a desired luminance with a smaller amount of current, and hardly deteriorates. Therefore, a functional circuitry for deterioration compensation to be incorporated in the television set can be greatly reduced or downsized. In addition, the power consumption is small, similarly, a power supply circuit to be incorporated can be reduced or downsized, which leads to downsize and lightweight of the television set.

FIG. 5B illustrates a computer according to the present invention which includes a main body 9201, a housing 9202, a display portion 9203, a keyboard 9204, an external connection port 9205, a pointing device 9206, and the like. The display portion 9203 of the computer is formed by using a light-emitting element including an organometallic complex described in Embodiment Mode 1, i.e., the light-emitting element described in Embodiment Mode 2 or 3 as a display element. The power consumption of the display portion 9203 in the computer formed using the light-emitting element with high emission efficiency is reduced, and the computer having the display portion 9203 is a power-saving computer. The light-emitting element has high emission efficiency, exhibits a desired luminance with a smaller amount of current, and hardly deteriorates. Therefore, a functional circuitry for deterioration compensation can be greatly reduced or downsized. In addition, the power consumption to be incorporated in the computer is small, similarly, a power supply circuit to be incorporated can be reduced or downsized, which leads to downsize and lightweight of the computer.

FIG. 5C illustrates a mobile phone according to the present invention. The mobile phone includes a main body 9401, a housing 9402, a display portion 9403, an audio input portion 9404, an audio output portion 9405, operation keys 9406, an external connection port 9407, an antenna 9408, and the like. The display portion 9403 of the mobile phone is formed by using a light-emitting element including an organometallic complex described in Embodiment Mode 1, i.e., the light-emitting element described in Embodiment Mode 2 or 3 as a display element. The power consumption of the display portion 9403 in the mobile phone formed using the light-emitting element with high emission efficiency is reduced, and the mobile phone having the display portion 9403 is a power-saving mobile phone. It is important for the mobile phone to be a device with low power consumption. The light-emitting element has high emission efficiency, exhibits a desired luminance with a smaller amount of current, and hardly deteriorates. Therefore, a functional circuitry for deterioration compensation to be incorporated in the mobile phone can be greatly reduced or downsized. In addition, the power consumption is small, similarly, a power supply circuit to be incorporated can be reduced or downsized, which leads to downsize and lightweight of the mobile phone. The downsize and lightweight mobile phone of the present invention can have appropriate size and weight even when a variety of additional values are added to the mobile phone, and thus the mobile phone of the present invention is suitable for use as a highly functional mobile phone.

FIG. 5D illustrates a camera according to the present invention. The camera includes a main body 9501, a display portion 9502, a housing 9503, an external connection port 9504, a remote control receiving portion 9505, an image receiving portion 9506, a battery 9507, an audio input portion 9508, an operation key 9509, an eye piece portion 9510, and the like. The display portion 9502 of the camera is formed by using a light-emitting element including an organometallic complex described in Embodiment Mode 1, i.e., the light-emitting element described in Embodiment Mode 2 or 3 as a display element. The power consumption of the display portion 9502 in the camera formed using the light-emitting element with high emission efficiency is reduced, and the camera having the display portion 9403 is a power-saving camera. It is important for the camera as a mobile device to be a device with low power consumption. The light-emitting element has high emission efficiency, exhibits a desired luminance with a smaller amount of current, and hardly deteriorates. Therefore, a functional circuitry for deterioration compensation to be incorporated in the camera can be greatly reduced or downsized. In addition, the power consumption is small, similarly, a power supply circuit to be incorporated can be reduced or downsized, which leads to downsize and lightweight of the camera.

As described above, the applicable range of the light emitting device formed using a light-emitting element including an organometallic complex described in Embodiment Mode 1, i.e., the light-emitting element described in Embodiment Mode 2 or 3 is so wide that the light-emitting device can be applied to electronic devices in various fields. In addition, a display portion formed using the light-emitting element with high emission efficiency exhibits high emission efficiency, and thus an electronic device having such a display portion can be a power-saving electronic device.

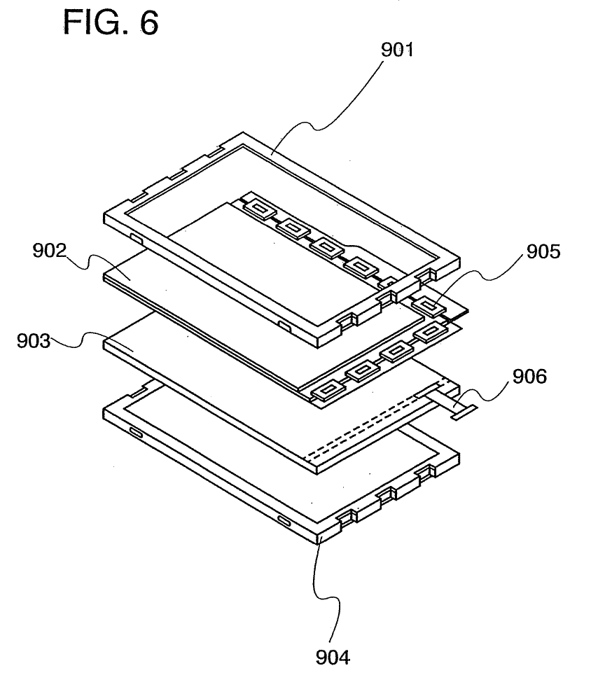

In addition, the light-emitting device of the present invention can also be used as an illumination apparatus. One mode of using a light-emitting element including an organometallic complex described in Embodiment Mode 1, i.e., the light-emitting element described in Embodiment Mode 2 or 3 for an illumination apparatus will be described with reference to FIG. 6.

FIG. 6 illustrates an example of a liquid crystal display device in which a light-emitting element including an organometallic complex described in Embodiment Mode 1, i.e., the light-emitting element described in Embodiment Mode 2, is used as a backlight. The liquid crystal display device shown in FIG. 6 includes a housing 901, a liquid crystal layer 902, a backlight 903, and a housing 904. The liquid crystal layer 902 is connected to a driver IC 905. A light-emitting element including an organometallic complex described in Embodiment Mode 1, i.e., the light-emitting element described in Embodiment Mode 2 or 3 is used as the backlight 903, to which current is supplied through a terminal 906.

The backlight 903 for the liquid crystal display device should emit white light or three colors emission of red, green and blue. In a light-emitting element including an organometallic complex described in Embodiment Mode 1, i.e., the light-emitting element described in Embodiment Mode 2 or 3, as a method for emitting white light, a method in which two light-emitting layers (light-emitting units) are provided in the EL layer, one light-emitting layer (light-emitting unit) includes an organometallic complex described in Embodiment Mode 1, and the other light-emitting layer (light-emitting unit) includes, as an emission center, a light-emitting substance which emit complementary light of light emitted from the organometallic complex, and the both light-emitting layers (light-emitting units) are made to emit light at the same time; a method in which three light-emitting layers (light-emitting units) are provided and red, green and blue light emission are obtained from the respective light-emitting layers (light-emitting units) at the same time, as described in Embodiment Mode 2 or 3. In the former structure, any of the organometallic complexes described in Embodiment Mode 1 is used for the one light-emitting layer (light-emitting unit), and in the latter structure, any of the organometallic complexes described in Embodiment Mode 1 is used for the light-emitting layer (light-emitting unit) for green emission.

In addition, light-emitting elements for red, green and blue are arranged in matrix, and the light-emitting elements are made to emit light at the same time, so that white emission color can be obtained by the whole backlight 903. At this time, the light-emitting element for green phosphorescence is a light-emitting element including an organometallic complex described in Embodiment Mode 1, i.e., the light-emitting element described in Embodiment Mode 2. In this case, the light-emitting element for each color of red, green and blue may be provided to correspond to each pixel for red, green or blue.

Note that the backlight 903 may be formed from one light-emitting element or a plurality of light-emitting elements, which is/are a light-emitting element including the organometallic complex described in Embodiment Mode 1, i.e., the light-emitting element described in Embodiment Mode 2 or 3. Alternatively, the backlight 903 may be formed from plural types of light-emitting elements, which emit different colors from the light-emitting element of the present invention.

As described above, a light-emitting element including an organometallic complex described in Embodiment Mode 1, i.e., the light-emitting element described in Embodiment Mode 2 or 3 can be applied to a backlight of a liquid crystal display device. The area of the backlight can be enlarged, and thus the liquid crystal display device also can be enlarged. Further, a high-quality image can be provided by using a light-emitting element of the present invention with high color purity. Moreover, a backlight with high emission efficiency and reduced power consumption can be provided by using the light-emitting element having high emission efficiency. Moreover, since the backlight using the light-emitting element of the present invention is thin and consumes less electric power, reduction in thickness and power consumption of the liquid crystal display device is possible.

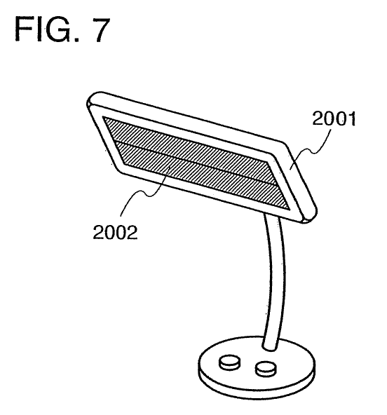

FIG. 7 illustrates an example in which a light-emitting element including an organometallic complex described in Embodiment Mode 1, i.e., the light-emitting element described in Embodiment Mode 2 or 3 is used for a desk lamp which is an example of illumination apparatuses. The desk lamp shown in FIG. 7 includes a housing 2001 and a light source 2002, and the light-emitting element including the organometallic complex described in Embodiment Mode 1, i.e., the light-emitting element described in Embodiment Mode 2 or 3 is used for the light source 2002. The light source 2002 may be formed from one light-emitting element or a plurality of light-emitting elements describe above. Alternatively, the light source 2002 may be formed from plural types of light-emitting elements, which emit different colors from the light-emitting element including the organometallic complex described in Embodiment Mode 1, i.e., the light-emitting element described in Embodiment Mode 2 or 3. As described above, the light source 2002 can be manufactured by using a light-emitting element including an organometallic complex described in Embodiment Mode 1, i.e., the light-emitting element described in Embodiment Mode 2 or 3. In addition, the light source 2002 formed using the light-emitting element having high emission efficiency have high emission efficiency and low power consumption, and thus the desk lamp using the light source also has high emission efficiency and low power consumption.

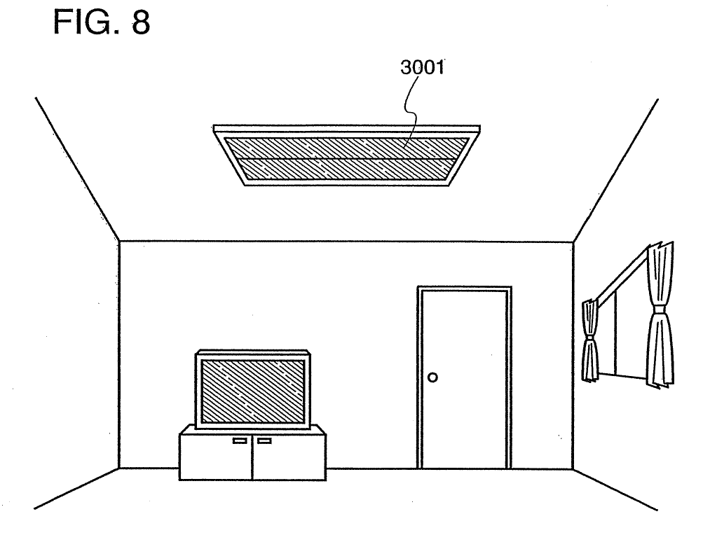

FIG. 8 illustrates an example in which a light-emitting element including an organometallic complex described in Embodiment Mode 1, i.e., the light-emitting element described in Embodiment Mode 2 or 3 is used for an indoor illumination apparatus 3001. The illumination apparatus 3001 may be formed from one light-emitting element or a plurality of light-emitting elements described above. Alternatively, the illumination apparatus 3001 may be formed from plural types of light-emitting elements, which emit different colors from the light-emitting element including the organometallic complex described in Embodiment Mode 1, i.e., the light-emitting element described in Embodiment Mode 2 or 3. As described above, the illumination apparatus 3001 can be manufactured by using a light-emitting element including the organometallic complex described in Embodiment Mode 1, i.e., the light-emitting element described in Embodiment Mode 2 or 3. The area of the illumination apparatus 3001 formed using the light-emitting element can be enlarged, and thus it can be used as a large area illumination apparatus. The illumination apparatus 3001 formed using the light-emitting element having high emission efficiency can be an illumination apparatus which is thin and consumes less power.

### Example 1

### Synthesis Example 1

In Synthesis Example 1, a synthesis example of an organometallic complex of the present invention represented by the following structural formula (I), bis[2-(4-fluorophenyl)-3,5-diisopropylpyrazinato](picolinato)iridium(III)(abbreviation [Ir(diPrFppr)₂(pic)]) is specifically described.

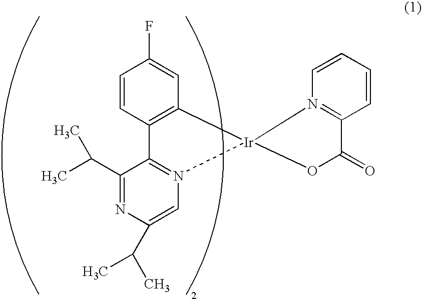

### Step 1: Synthesis of 2-(4-fluoropheyl)-3,5-diisopropylpyrazine (abbreviation: HdiPrFppr)

First, 25 mL of dehydrated ethanol, 2.19 g of 1-(4-fluorophenyl)-3-methyl-1,2-butanedione (produced by Midori Kagaku Co., Ltd.), and 0.68 g of anhydrous ethylenediamine were put in an eggplant flask equipped with a reflux pipe, and the inside thereof was substituted by argon. Then, this reaction container was subjected to irradiation with microwave (2.45 GHz, 100 W) for 35 minutes to be heated. Then, in this reaction container, 1.66 mL of acetone and 0.63 g of potassium hydroxide were added, the inside thereof was substituted by argon, and the reaction container was subjected to irradiation of microwave (2.45 GHz, 100 W) for 15 minutes to be heated. Water was added into this mixture, and an organic layer was extracted with ethyl acetate. The organic layer obtained was washed with water and dried with magnesium sulfate. After the drying, the solution was filtrated. A solvent of this solution was distilled off, and the residue obtained by the distillation was purified by silica gel column chromatography which uses dichloromethane as a developing solvent; thereby obtaining an objective pyrazine derivative HdiPrFppr (milky white powder, yield of 85%). For the irradiation of microwave, a microwave synthesis system (Discover, produced by CEM Corporation) was used. The synthetic scheme of Step 1 is shown by the following (a-1).

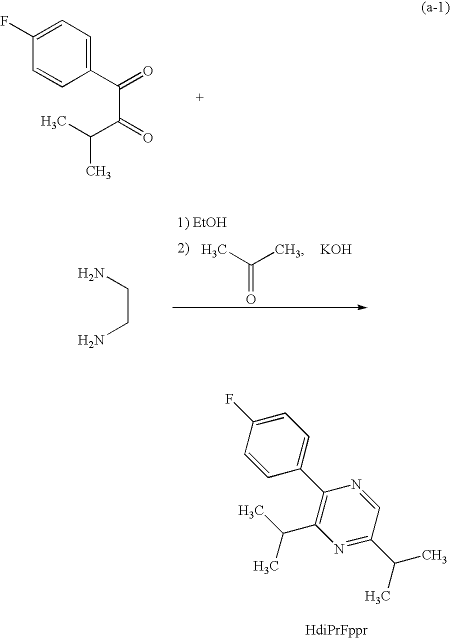

### Step 2: Synthesis of di-μ-chloro-bis{bis[2-(4-fluorophenyl)-3,5-diisopropylpyrazinato]}iridium(III)}(abbreviation: [Ir(diPrFppr)₂Cl]₂

Next, 15 mL of 2-ethoxyethanol, 5 mL of water, 0.79 g of the pyrazine derivative, HdiPrFppr obtained in the above Step 1, and 0.46 g of iridium chloride hydrate (IrCl₃.H₂O) (produced by Sigma-Aldrich Corp.) were put in an eggplant flask with a reflux pipe, and the inside of the flask was substituted by argon. Then, a reaction was carried out by heating using irradiation of the reaction container with microwave (2.45 GHz, 150 W) for 30 minutes. A powder precipitated from the reacted solution was filtered and washed with ethanol; thereby obtaining a binuclear complex [Ir(diPrFppr)₂Cl]₂ (bright yellow, yield of 54%). A synthetic scheme of Step 2 is shown in the following (b-1).

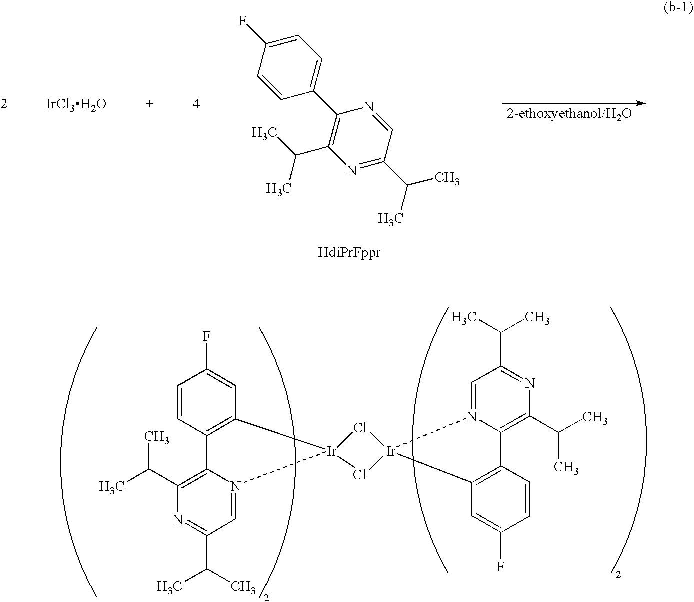

### Step 3: Synthesis of bis[2-(4-fluorophenyl)-3,5-diisopropylpyrazinato](picolinato)iridium(III) (abbreviation: [Ir(diPrFppr)₂(pic)]

25 mL of dichloromethane, 0.63 g of the binuclear complex obtained in the above Step 2, [Ir(diPrFppr)₂Cl]₂, and 0.41 g of picolinic acid were put in an eggplant flask equipped with a reflux pipe, and the inside of the flask was substituted by argon. Then, a reaction was carried out by heating with irradiation of the reaction container with microwave (2.45 GHz, 50 to 100 W) for 45 minutes. The reaction solution was cooled down to room temperature and the solvent was distilled off. The obtained residue was refined by a neutral silica gel column chromatography using ethyl acetate as a development solvent, and recrystallized with methanol, so that an organometallic complex of the present invention, [Ir(diPrFppr)₂(pic)] was obtained (yellow powder, yield of 24%). A synthetic scheme of Step 3 is shown by the following (c-1).

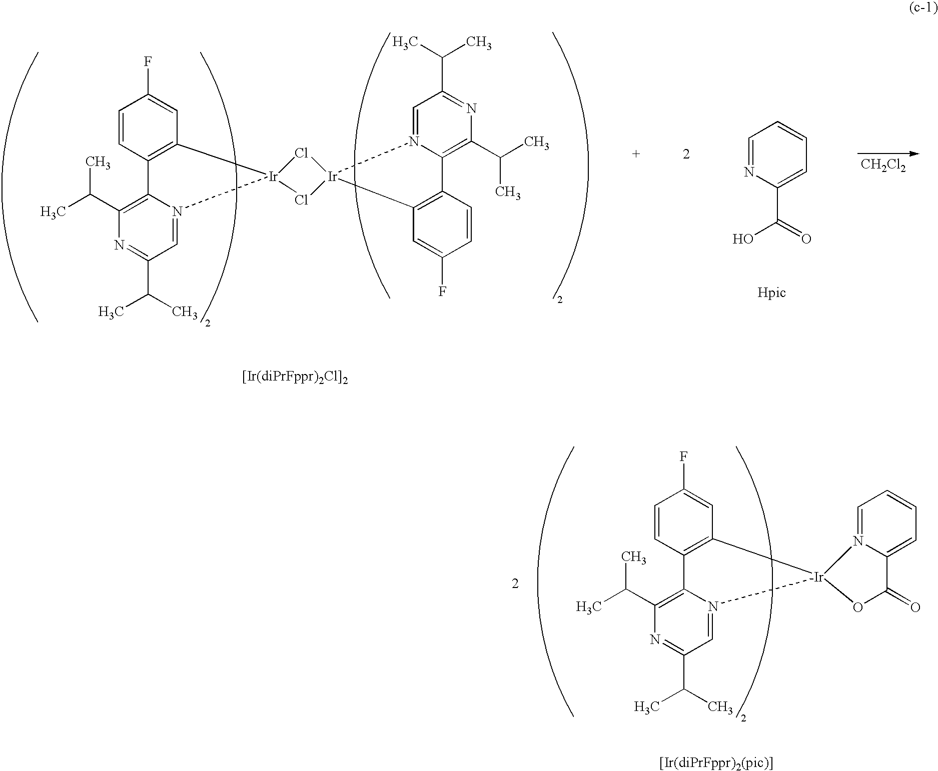

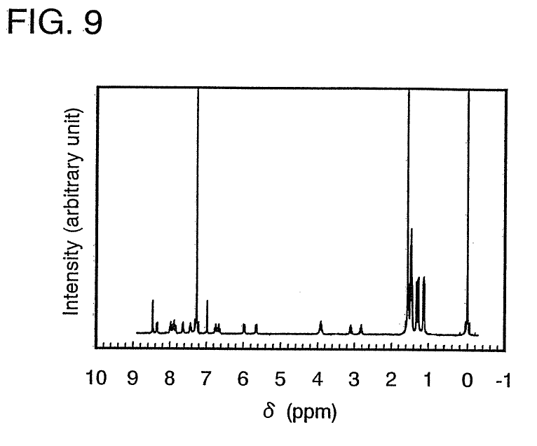

An analysis result by nuclear magnetic resonance spectrometry (¹H-NMR) of the yellow powder obtained in Step 3 is shown below. Further, the ¹H-NMR chart is shown in FIG. 9. It is found that the organometallic complex of the present invention [Ir(diPrFppr)₂(pic)] represented by the above structural formula (I) was obtained in this synthesis example.

¹H-NMR. δ(CDCl₃): 1.12 (m, 6H), 1.30 (m, 6H), 1.54 (m, 12H), 2.82 (sep, 1H), 3.10 (sep, 1H), 3.91 (sep, 2H), 5.64 (dd, 1H), 5.97 (dd, 1H), 6.65 (dt, 1H), 6.74 (dt, 1H), 6.97 (s, 1H), 7.43 (t, 1H), 7.64 (d, 1H), 7.88 (m, 2H), 7.97 (dt, 1H), 8.35 (d, 1H), 8.47 (s, 1H).

The gravity decrease of the obtained organometallic complex of the present invention [Ir(diPrFppr)₂(pic)] was measured by a high vacuum differential type differential thermal balance (manufactured by Bruker AXS K. K., TG-DTA2410SA,). The temperature was increased at a rate of 10° C./min in normal pressure under a nitrogen atmosphere; as a result, the gravity decreased by 5% at 336° C. and thus a favorable heat resistance was exhibited.

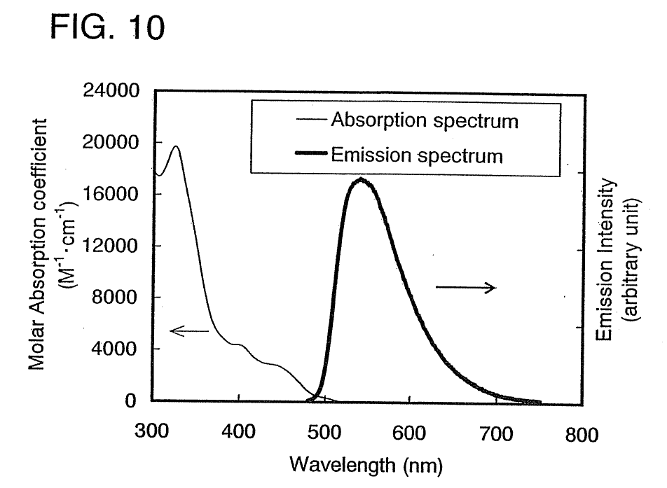

Next, the absorption spectrum of [Ir(diPrFppr)₂(pic)] was measured. The measurement of the absorption spectrum was conducted at room temperature, using a degassed dichloromethane solution (0.11 mmol/L) by an ultraviolet-visible spectrophotometer (V-550, manufactured by JASCO Corporation). Further, an emission spectrum of [Ir(diPrFppr)₂(pic)] was measured with use of a fluorescence spectrophotometer (FS920, manufactured by Hamamatsu Photonics Corporation). The measurement was conducted using a degassed dichloromethane solution (0.37 mmol/L) at room temperature. The measurement results of the absorption spectrum and the emission spectrum in excitation at 468 nm are shown in FIG. 10. The horizontal axis indicates a wavelength and the vertical axis indicates a molar absorption coefficient and an emission intensity.

As illustrated in FIG. 10, the organometallic complex of the present invention, [Ir(diPrFppr)₂(pic)] has a peak of emission spectrum at 540 nm, and green light was observed from the dichloromethane solution.

In addition, when the dichloromethane solution of the organometallic complex [Ir(diPrFppr)₂(pic)] of the present invention was irradiated with light, luminescence derived from the compound can be observed by nitrogen substitution of air in the solution while luminescence derived from the compound is hardly observed by oxygen substitution of air in the solution. In the case of fluorescence with nanosecond order of short decay time of emission, quenching effect by a high concentration of oxygen is small, on the other hand, in the case of phosphorescence, the quenching effect due to oxygen easily influence, since phosphorescence goes through microsecond order of long decay time of emission. Therefore, since the organometallic complex synthesized in this example was influenced by the quenching effect by a high concentration of oxygen, this luminescence obtained from the compound is considered to be phosphorescence.

### Example 2

### Synthesis Example 2

In Synthesis Example 2, a synthesis example of the organometallic complex of the present invention, represented by the structural formula (40) in Embodiment Mode 1, (acetylacetonato)bis{2-(2,4-difluorophenyl)-3,5-dimethylpyrazinato}iridium(III) (abbreviation: [Ir(dmF₂ ppr)₂(acac)]) is described specifically. The structural formula of [Ir(dmF₂ ppr)₂(acac)] is shown below.

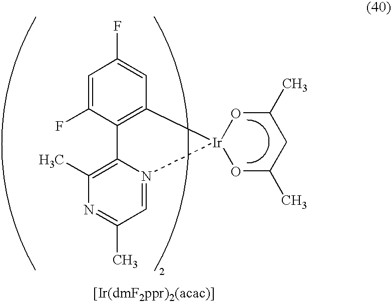

### Step 1: Synthesis of 2-(2,4-difluorophenyl)-3,5-dimethylpyrazine (abbreviation: HdmF₂ ppr)

First, a synthesis method of an intermediate, 2-chloro-3,5-dimethylpyrazine is described. 7.12 g of 2,6-dimethylpyrazine and 6.5 mL of dimethylformamide (abbreviation: DMF) were put in a three-neck flask equipped with a drop funnel and a thermometer, and the inside was refluxed under a nitrogen atmosphere. 6.7 mL of sulfuric chloride was put in a drop funnel and the reaction container was soaked in an ice bath. While the reaction solution was being stirred, the sulfuric chloride was dropped in such a way that the temperature of the solution be kept 45° C.±5° C. After that, water was added after it was confirmed that the temperature of the solution was 40° C. or lower. After it was confirmed again that the temperature of the solution was 40° C. or lower, an aqueous sodium hydroxide was added and the pH of the solution was adjusted to 7 to 8. This solution was subjected to steam distillation. The obtained solution was subjected to extraction using dichloromethane to separate an organic layer. The organic layer obtained was dried with magnesium sulfate. After the drying, the solution was filtrated. After the solvent of this solution was distilled off, the obtained residue was distilled under reduced pressure, so that an objective intermediate was obtained (clear and colorless liquid, yield of 36%).

Next, a synthesis method of a ligand of the present invention, 2-(2,4-difluorophenyl)-3,5-dimethylpyrazine is described. 2.14 g of 2-chloro-3,5-dimethylpyrazine which was obtained as the intermediate described above, 2.37 g of 2,4-difluorophenyl boronic acid, 1.59 g of sodium carbonate, 0.069 g of bis(triphenylphosphine)palladium(II) dichloride (abbreviation: Pd(PPh₃)₂Cl₂), 15 mL of water, and 15 mL of acetonitrile were put in an eggplant flask equipped with a reflux pipe, and the inside thereof was substituted by argon. This reaction container was subjected to irradiation with microwave (2.45 GHz, 100 W) for 10 minutes to be heated. Then, water was added to this solution, and extraction using dichloromethane was conducted to separate an organic layer. The organic layer obtained was washed with water and dried with magnesium sulfate. After the drying, the solution was filtrated. A solvent of this solution was distilled off, and then the residue obtained by the distillation was purified by silica gel column chromatography which uses dichloromethane as a developing solvent; thereby obtaining an objective pyrazine derivative, HdmF₂ ppr (white powder, yield of 39%). A synthetic scheme of Step 1 is shown by the following (a-2).

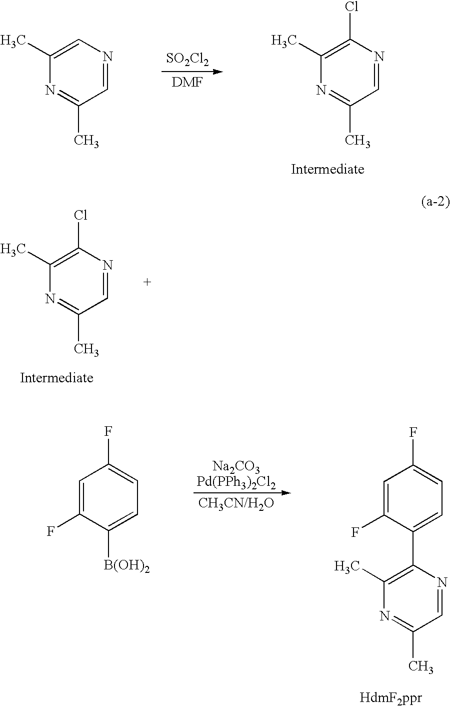

### Step 2: Synthesis of di-μ-chloro-bis{bis[2-(2,4-difluorophenyl)-3,5-methylpyrazinato]}iridium(III) (abbreviation: [Ir(dmF₂ ppr)₂Cl]₂)

Next, 18 mL of 2-ethoxyethanol, 6 mL of water, 1.28 g of the pyrazine derivative obtained in the above Step 1, HdmF₂ ppr, and 0.87 g of iridium chloride hydrate (IrCl₃.H₂O) (produced by Sigma-Aldrich Corp.) were put in an eggplant flask equipped with a reflux pipe, and the inside thereof was substituted by argon. Then, this reaction container was subjected to irradiation with microwave (2.45 GHz, 100 W) for 1 hour to be heated and reacted. Water was added to the reaction solution and extraction using dichloromethane was conducted to separate an organic layer. The organic layer obtained was dried with magnesium sulfate. After the drying, the solution was filtrated. The solvent of the solution was concentrated and a precipitated yellow powder was filtrated and washed with ethanol, so that a binuclear complex [Ir(dmF₂ ppr)₂Cl]₂ was obtained (yield of 63%). A synthetic scheme of Step 2 is shown by the following (b-2).

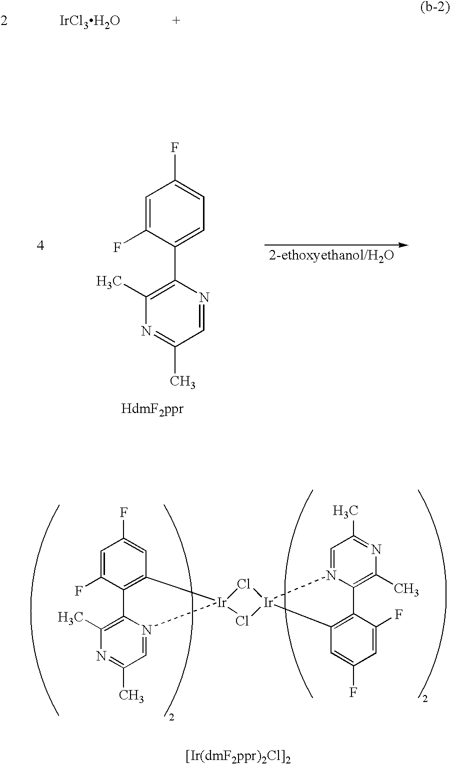

### Step 3: Synthesis of (acetylacetonato)bis{2-(2,4-difluorophenyl)-3,5-dimethylpyrazinato}iridium(III) (abbreviation: [Ir(dmF₂ ppr)₂(acac)])

20 mL of 2-ethoxyethanol, 0.75 g of the binuclear complex obtained in Step 2 [Ir(dmF₂ ppr)₂Cl]₂, 0.17 mL of acetylacetone, 0.59 g of sodium carbonate were put in an eggplant flask equipped with a reflux pipe, and the inside of the flask was substituted by argon. Then, it was irradiated with microwave (2.45 GHz, 100 W) for 30 minutes and reacted. Dichloromethane was added to the reaction solution and filtrated. The obtained filtrate was concentrated, so that an ocher powder was precipitated. This powder was obtained by filtration and washed with ethanol, so that an organometallic complex of the present invention [Ir(dmF₂ ppr)₂(acac)] was obtained (yield of 53%). A synthetic scheme of this step is shown in the following (c-3).

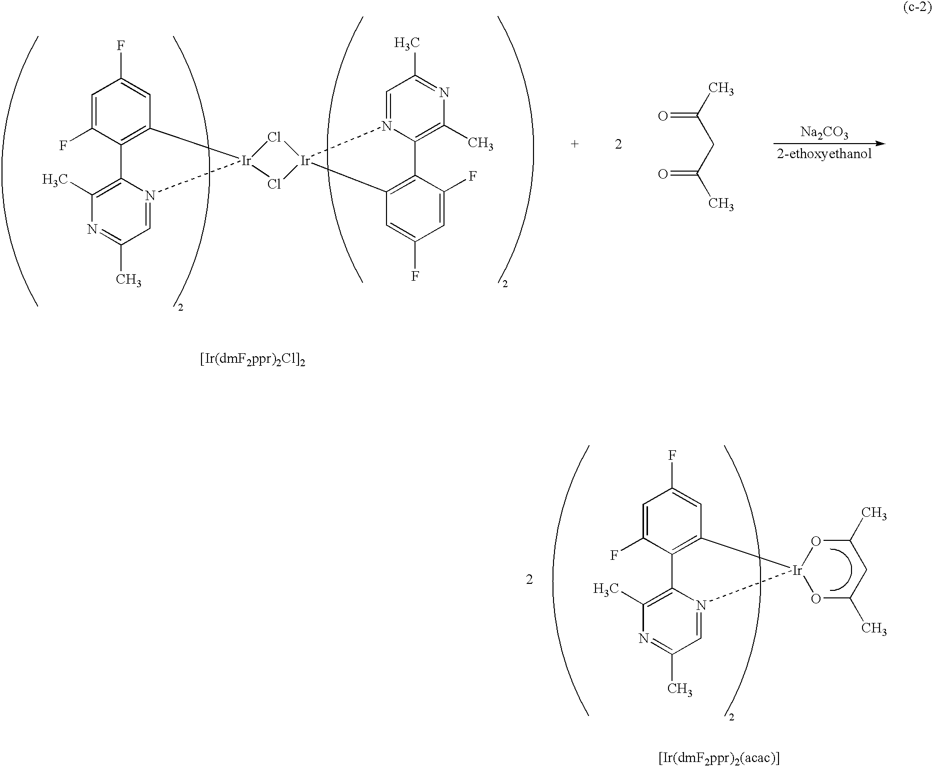

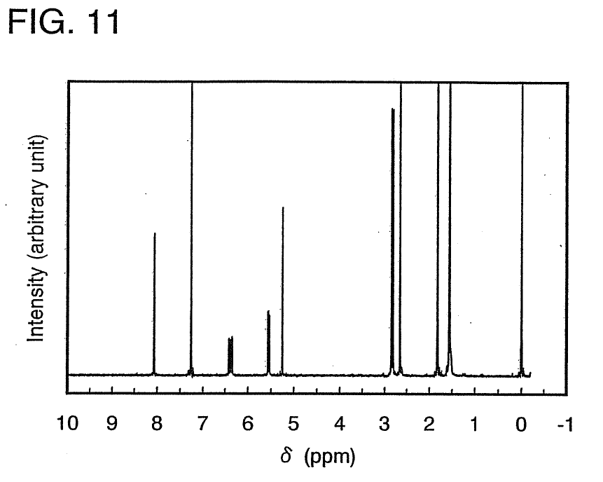

An analysis result of the ocher powder obtained in the above step by nuclear magnetic resonance spectrometry (¹H-NMR) is shown below. The ¹H-NMR chart is shown in FIG. 11. According to this, it is found that in this synthesis example 2, the organometallic complex of the present invention [Ir(dmF₂ ppr)₂(acac)] represented by the above structural formula (40) was obtained.

¹H-NMR. δ(CDCl₃): 1.82 (s, 6H), 2.65 (s, 6H), 2.81 (s, 3H), 2.85 (s, 3H), 5.25 (s, 1H), 5.55 (dd, 2H), 6.38 (m, 2H), 8.06 (s, 2H).

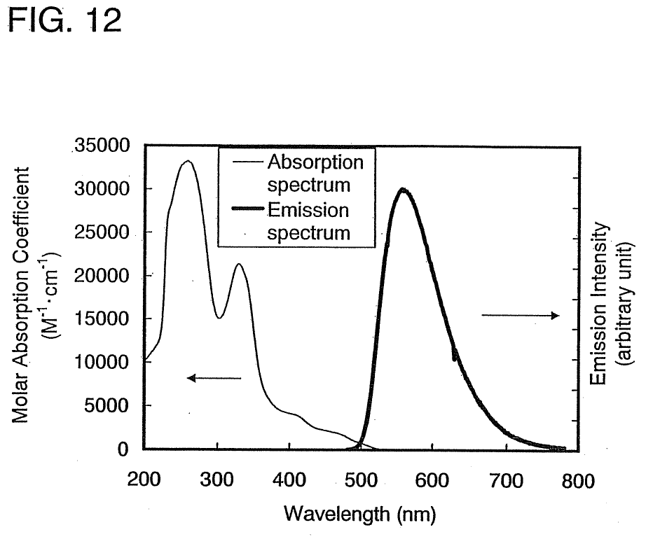

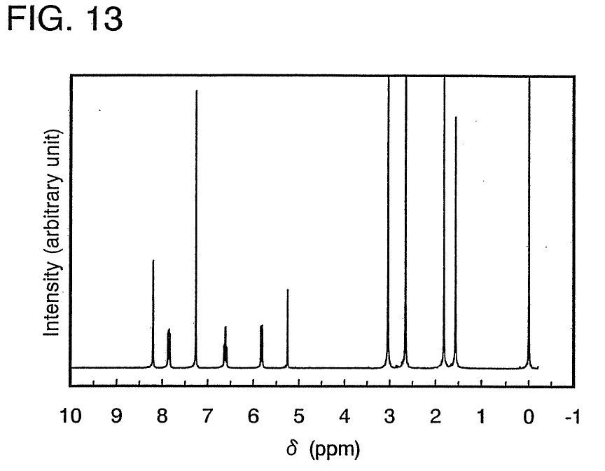

Next, an absorption spectrum of [Ir(dmF₂ ppr)₂(acac)] was measured with use of an ultraviolet-visible light spectrophotometer (V550, manufactured by JASCO Corporation). The measurement was conducted by using a dichloromethane solution (0.12 mmol/L) at room temperature. Further, an emission spectrum of [Ir(dmF₂ ppr)₂(acac)] was measured with use of a fluorescence spectrophotometer (FS920, manufactured by Hamamatsu Photonics Corporation). The measurement was conducted by using a degassed dichloromethane solution (0.41 mmol/L) at room temperature. The measurement results are shown in FIG. 12. The horizontal axis indicates a wavelength and the vertical axis indicates a molar absorption coefficient and an emission intensity.

As illustrated in FIG. 12, the organometallic complex of the present invention, [Ir(dmF₂ ppr)₂(acac)] has a peak of emission spectrum at 557 nm, and yellow-green light was observed from the dichloromethane solution.

In addition, when the dichloromethane solution containing the organometallic complex [Ir(dmF₂ ppr)₂(acac)] of the present invention was irradiated with light, luminescence can be observed by nitrogen substitution of air in the solution while luminescence derived from the compound is hardly observed by oxygen substitution of air in the solution, and thus the luminescence is considered to be phosphorescence.

### Example 3

### Synthesis Example 3

In Synthesis Example 3, a synthesis example of the organometallic complex of the present invention, represented by the structural formula (13) in Embodiment Mode 1, (acetylacetonato)bis{2-(4-fluorophenyl)-3,5-dimethylpyrazinato}iridium(III) (abbreviation: [Ir(dmFppr)₂(acac)]) is described specifically. The structural formula of [Ir(dmFppr)₂(acac)] is shown below.

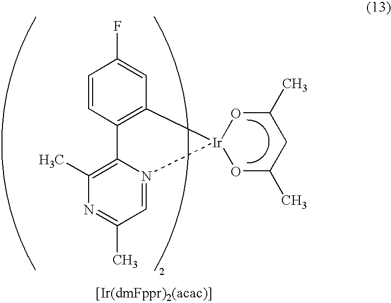

### Step 1: Synthesis of 2-(4-fluorophenyl)-3,5-dimethylpyrazine (abbreviation HdmFppr)

1.42 g of 2-chloro-3,5-dimethylpyrazine which was obtained as the intermediate obtained in the Step 1 of the above synthesis example 2, 1.40 g of 4-fluorophenyl boronic acid, 1.06 g of sodium carbonate, 0.046 g of bis(triphenylphosphine)palladium(II) dichloride (abbreviation: Pd(PPh₃)₂Cl₂), 15 mL of water, and 15 mL of acetonitrile were put in an eggplant flask equipped with a reflux pipe, and the inside thereof was substituted by argon. This reaction container was subjected to irradiation with microwave (2.45 GHz, 100 W) for 10 minutes to be heated. Then, water was added to this solution, and extraction using dichloromethane was conducted and an organic layer was extracted. The organic layer obtained was washed with water and dried with magnesium sulfate. After the drying, the solution was filtrated. A solvent of this solution was distilled off. Then the residue obtained by the distillation was purified by silica gel column chromatography which uses dichloromethane as a developing solvent; thereby obtaining an objective pyrazine derivative HdmFppr (white powder, yield of 77%). A synthetic scheme of Step 1 is shown by the following (a-3).

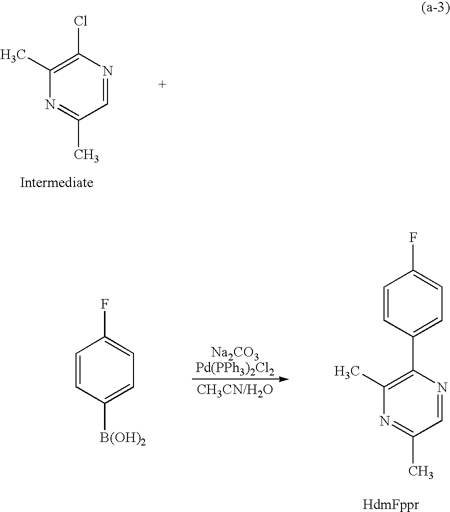

### Step 2: Synthesis of di-μchloro-bis{bis[2-(4-fluorophenyl)-3,5-dimethylpyrazinato]}iridium(III)}(abbreviation: [Ir(dmFppr)₂Cl]₂)

Next, 12 mL of 2-ethoxyethanol, 3 mL of water, 1.55 g of the pyrazine derivative obtained in the above Step 1, HdmFppr, and 0.92 g of iridium chloride hydrate (IrCl₃.H₂O) (produced by Sigma-Aldrich Corp.) were put in an eggplant flask equipped with a reflux pipe, and the inside thereof was substituted by argon. Then, this reaction container was subjected to irradiation with microwave (2.45 GHz, 100 W) for 30 minutes to be heated and reacted. The reaction solution was filtrated and washed with ethanol, so that a binuclear complex [Ir(dmFppr)₂Cl]₂ was obtained (dark green powder, yield of 63%). A synthetic scheme of Step 2 is shown by the following (b-3).

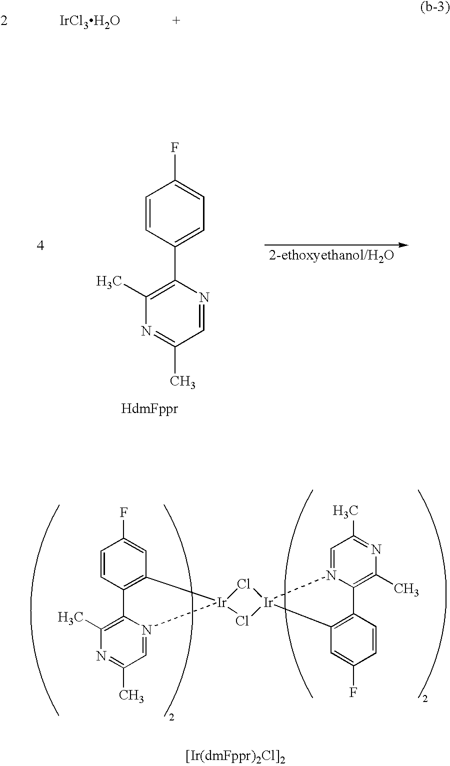

### Step 3: Synthesis of (acetylacetonato)bis{2-(4-fluorophenyl)-3,5-dimethylpyrazinato}iridium(III) (abbreviation: [Ir(dmFppr)₂(acac)])

15 mL of 2-ethoxyethanol, 1.19 g of the binuclear complex obtained in the above Step 2, [Ir(dmFppr)₂Cl]₂, 0.29 mL of acethylacetone, 1.00 g of sodium carbonate were put in an eggplant flask equipped with a reflux pipe, and the inside thereof was substituted by argon. Then, it was irradiated with microwave (2.45 GHz, 100 W) for 30 minutes and reacted. Dichloromethane was added to the reaction solution and the reaction solution was filtrated. The obtained filtrate was concentrated, so that an orange powder was precipitated. This powder was obtained by filtration and washed with ethanol and then ether, so that an organometallic complex of the present invention [Ir(dmFppr)₂(acac)] was obtained (yield of 82%). A synthetic scheme of this step was shown by the following (c-3).

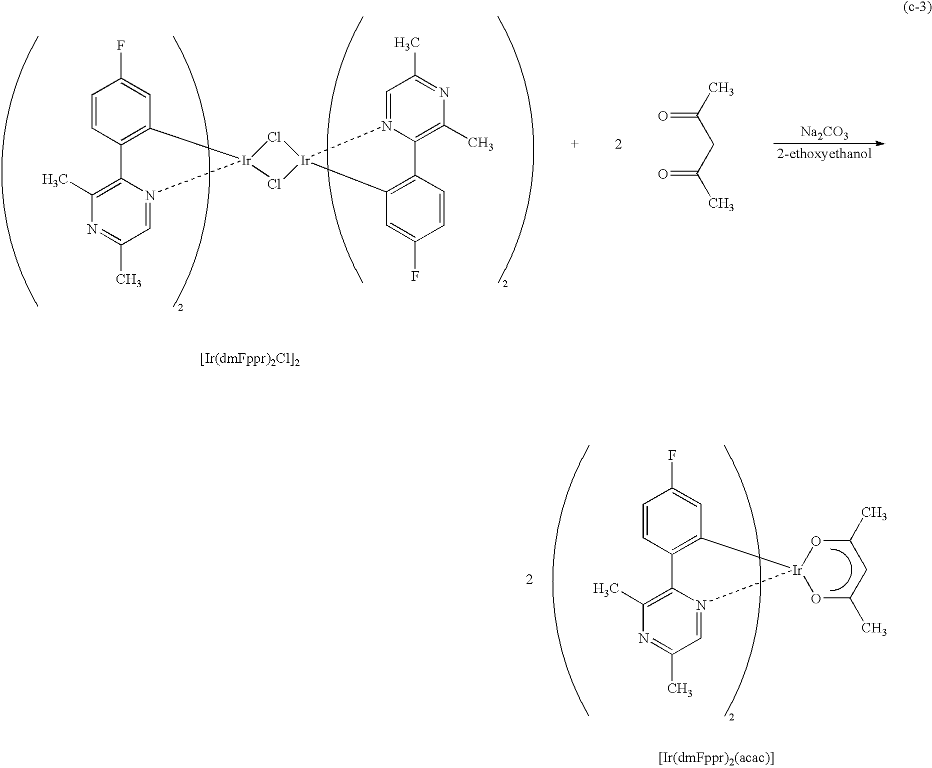

An analysis result of the orange powder obtained in the above step by nuclear magnetic resonance spectrometry (¹H-NMR) is shown below. FIG. 13 shows the ¹H-NMR chart. According to the result, it is found that the organometallic complex of the present invention [Ir(dmFppr)₂(acac)], represented by the above structural formula (13), was obtained in Synthesis Example 3.

¹H-NMR. δ(CDCl₃): 1.82 (s, 6H), 2.65 (s, 6H), 3.04 (s, 6H), 5.26 (s, 1H), 5.82 (dd, 2H), 6.61 (dt, 2H), 7.86 (dd, 2H), 8.20 (s, 2H).

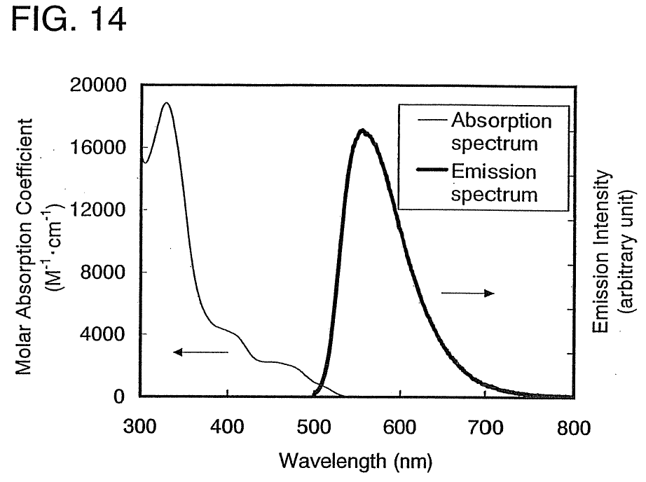

Next, an absorption spectrum of [Ir(dmFppr)₂(acac)] was measured with use of an ultraviolet-visible light spectrophotometer (V550, manufactured by JASCO Corporation). The measurement was conducted by using a dichloromethane solution (0.12 mmol/L) at room temperature. Further, an emission spectrum of [Ir(dmFppr)₂(acac)] was measured with use of a fluorescence spectrophotometer (FS920, manufactured by Hamamatsu Photonics Corporation). The measurement was conducted by using a degassed dichloromethane solution (0.44 mmol/L) at room temperature. FIG. 14 shows the measurement result. The horizontal axis indicates a wavelength and the vertical axis indicates a molar absorption coefficient and an emission intensity.

As illustrated in FIG. 14, the organometallic complex of the present invention [Ir(dmFppr)₂(acac)] has a peak of emission spectrum at 557 nm, and yellow-green light was observed from the solution.

In addition, when the dichloromethane solution of the organometallic complex [Ir(dmFppr)₂(acac)] of the present invention was irradiated with light, luminescence can be observed by nitrogen substitution of air in the container while luminescence derived from the compound is hardly observed by oxygen substitution of air in the container, and thus the luminescence is considered to be phosphorescence.

### Example 4

Example 4 will describe a light-emitting element using, as a emission center substance, [Ir(dmFppr)₂(acac)], which was the organometallic complex represented by the structural formula (13) in Embodiment Mode 1.

The molecular structures of the organic compounds used in forming a light-emitting element in this example are shown by the following structural formulae (I) to (v).

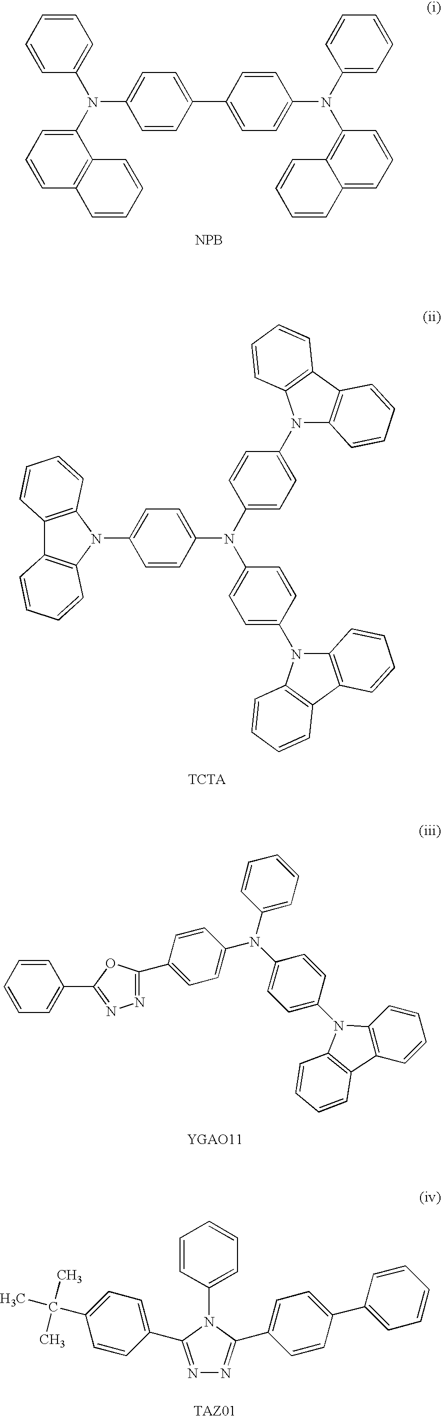

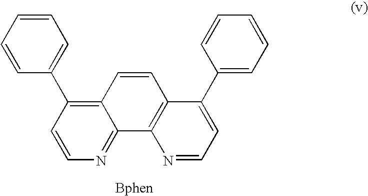

### <<Fabrication of Light-Emitting Element>>

First, a glass substrate over which indium tin oxide including silicon (ITSO) which a thickness of 110 nm had been formed as an anode was prepared. The periphery of surface of the ITSO was covered with a polyimide film so that an area of 2 mm×2 mm of the surface was exposed. The electrode area was 2 mm×2 mm. As a pretreatment for forming the light-emitting element over the substrate, the surface of the substrate was washed with water, and baked at 200° C. for one hour, then, a UV ozone treatment was conducted for 370 seconds. Then, the substrate was transferred into a vacuum evaporation apparatus whose pressure was reduced to about 10⁻⁴ Pa, and vacuum baking at 170° C. for 30 minutes was conducted in a heating chamber of the vacuum evaporation apparatus, and then the substrate was cooled down for about 30 minutes.

Subsequently, the substrate was fixed to a holder provided in a vacuum evaporation apparatus so that the surface provided with ITSO faced downward.

After pressure in the vacuum evaporation apparatus was reduced to 10⁻⁴ Pa, 4,4′-bis[N-(1-naphthyl)-N-phenylamino]biphenyl (abbreviation: NPB), represented by the above structural formula (I) and molybdenum(VI) oxide were co-deposited so as to meet NPB:molybdenum(VI) oxide=4:1 (mass ratio), whereby a hole-injecting layer was formed. The film thickness was 40 nm. Note that a co-evaporation method is an evaporation method in which a plurality of different substances are concurrently evaporated from respective different evaporation sources. 4,4′,4″-tris(N-carbazolyl)triphenylamine (abbreviation: TCTA), represented by the above structural formula (II), was deposited to a thickness of 20 nm, so that a hole-transporting layer was formed.

Over the hole-transporting layer, 4-(9H-carbazol-9-yl)-4′-(5-phenyl-1,3,4-oxadiazol-2-yl)triphenylamine (abbreviation: YGAO11) represented by the above structural formula (III) and the organometallic complex, [Ir(dmFppr)₂(acac)] represented by the structural formula (13) in Embodiment Mode 1 were co-deposited such that the mass ratio of YGAO11 to [Ir(dmFppr)₂(acac)] was 1:0.0025, thereby forming a light-emitting layer. The thickness thereof was 30 nm.

Next, 10 nm of 3-(4-biphenylyl)-4-phenyl-5-(4-tert-buthylphenyl)-1,2,4-triazole (abbreviation: TAZOL) represented by the above structural formula (Iv) was deposited and then 20 nm of bathophenanthroline (abbreviation: BPhen) represented by the above structural formula (v) was deposited to form an electron-transporting layer. Further, over the electron-transporting layer, Alq and lithium fluoride were co-desposited so as to meet Alq:Li=1:0.01 (mass ratio), whereby an electron-injecting layer was formed. The thickness thereof was 1 nm. Finally, aluminum was formed to be 200 nm thick as a second electrode serving as a cathode, whereby a light-emitting element was obtained. It is to be noted that, in the above evaporation process, evaporation was all performed by a resistance heating method.

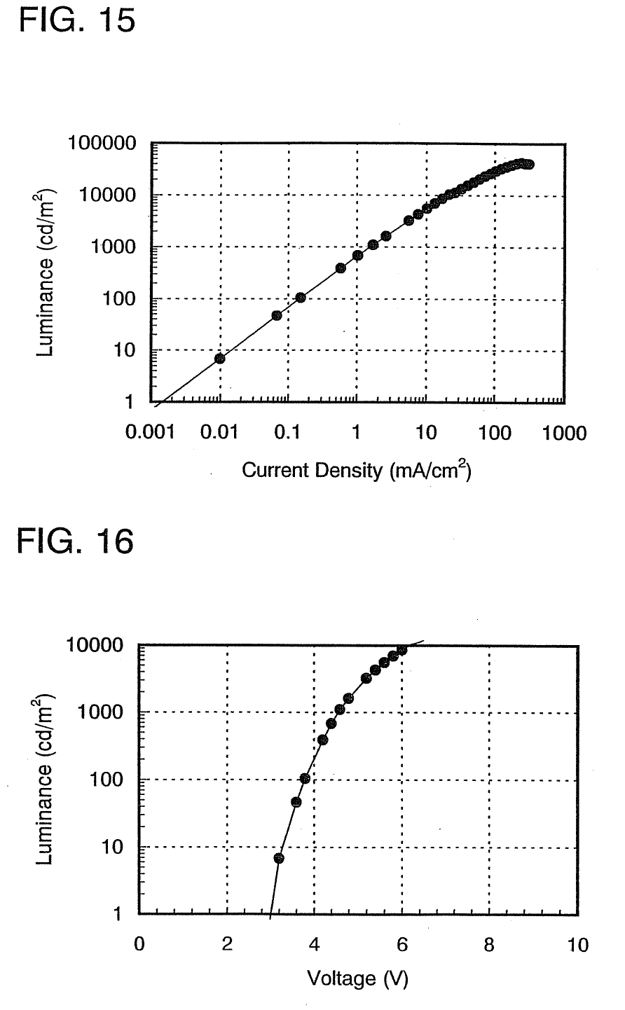

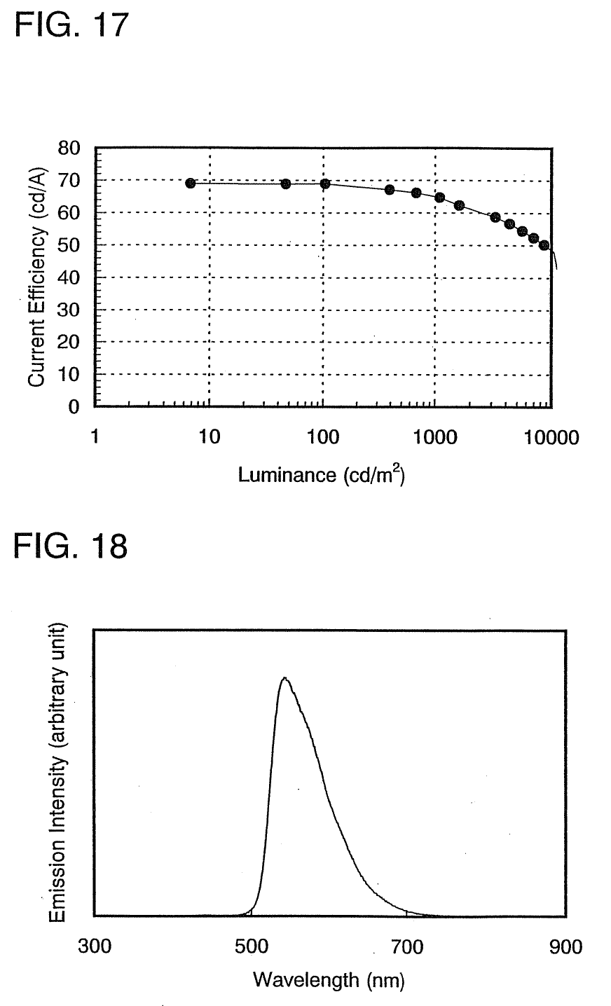

Current density-luminance characteristics, voltage-luminance characteristics, and luminance-current efficiency characteristics of the light-emitting element are shown in FIGS. 15, 16, and 17, respectively.

As described above, it is found that the organometallic complex represented by the structural formula (13) in Embodiment Mode 1, [Ir(dmFppr)₂(acac)] can be operated as a light-emitting material of a light-emitting element rightly.

FIG. 18 shows an emission spectrum when a current of 1 mA flows to the obtained light-emitting element. As shown in FIG. 18, it is found that the organometallic complex represented by the structural formula (13) in Embodiment Mode 1, [Ir(dmFppr)₂(acac)] has an emission peak at 542 nm and emits yellow-green light. The current efficiency and the external quantum efficiency at luminance of 1100 cd/m² were 64.7 cd/A and 17.8%, respectively. The voltage, current density and power efficiency at luminance of 1100 cd/m² were 4.6 V, 0.0681 mA/cm², and 44 lm/W, respectively. As described above, it is found that a light-emitting element using, as an emission center substance, [Ir(dmFppr)₂(acac)] which is the organometallic complex represented by the structural formula (13) in Embodiment Mode 1 is a superior light-emitting element with extremely high efficiency.

### Example 5

### Synthesis Example 4

In Synthesis Example 4, a synthesis example of the organometallic complex of the present invention, represented by the structural formula (12) in Embodiment Mode 1, bis{2-(4-fluorophenyl)-3,5-dimethylpyrazinato}(picolinato)iridium(III) (abbreviation [Ir(dmFppr)₂(pic)]) is described specifically. The structural formula of [Ir(dmFppr)₂(pic)] is shown below.

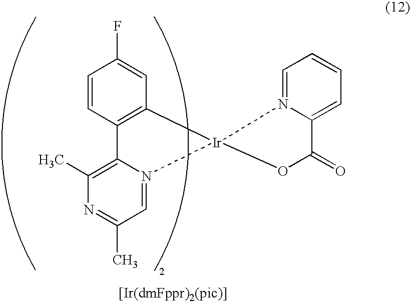

### Step 1: Synthesis of 2-(4-fluororophenyl)-3,5-dimethylpyrazine (abbreviation HdmFppr)>

The synthesis was conducted in a similar manner to the Step 1 of the synthesis example 3 in Example 3.

### Step 2: Synthesis of di-t-chloro-bis{bis[2-(4-fluorophenyl)-3,5-dimethylpyrazinato]}iridium(III)}(abbreviation: [Ir(dmFppr)₂Cl]₂)

The synthesis was conducted in a similar manner to the Step 2 of the synthesis example 3 in Example 3.

### Step 3: Synthesis of bis{2-(4-fluorophenyl)-3,5-dimethylpyrazinato}(picolinato)iridium(III) (abbreviation [Ir(dmFppr)₂(pic)])

0.51 g of the binuclear complex obtained in Step 2, [Ir(dmFppr)₂Cl]₂, 0.40 g of picoline acid, 0.34 g of sodium carbonate, and 25 mL of dichloromethane were put in an eggplant flask equipped with a reflux pipe, and the inside thereof was substituted by argon. Then, it was irradiated with microwave (2.45 GHz, 100 W) for 30 minutes and reacted. The reaction solution was filtrated. The filtrate was concentrated to obtain a residue. The obtained residue was recrystallized with methanol, so that an organometallic complex of the present invention [Ir(dmFppr)₂(pic)] was obtained (bright yellow, yield of 84%). A synthetic scheme of this step was shown by the following (c-4).

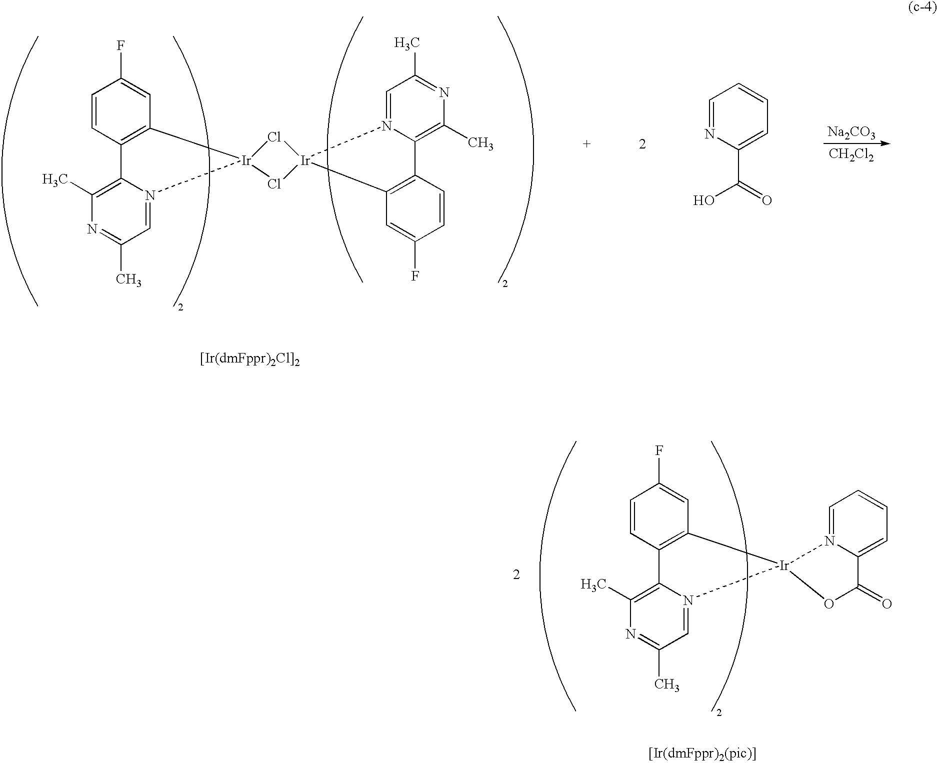

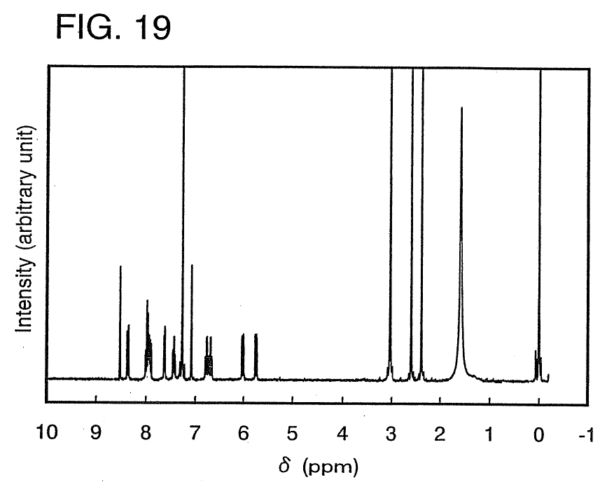

An analysis result of the bright yellow powder obtained in the above step by nuclear magnetic resonance spectrometry (¹H-NMR) is shown below. FIG. 19 shows the ¹H-NMR chart. It is found that the organometallic complex of the present invention, [Ir(dmFppr)₂(pic)] represented by the above structural formula (12), was obtained in Synthesis Example 4.

¹H-NMR. δ(CDCl₃): 2.38 (s, 3H), 2.59 (s, 3H), 3.03 (s, 6H), 5.74 (dd, 1H), 6.01 (dd, 1H), 6.68 (dt, 1H), 6.76 (dt, 1H), 7.08 (s, 1H), 7.42 (dt, 1H), 7.62 (d, 1H), 7.95 (m, 3H), 8.36 (d, 1H), 8.52 (s, 1H).

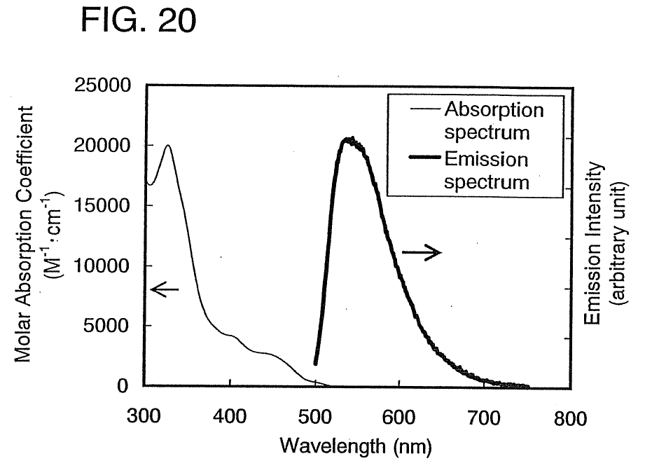

Next, the absorption spectrum of [Ir(dmFppr)₂(pic)] was measured using an ultraviolet-visible spectrophotometer (V550, manufactured by JASCO Corporation). The measurement was conducted using a dichloromethane solution (0.13 mmol/L) at room temperature. Further, an emission spectrum of [Ir(dmFppr)₂(pic)] was measured with use of a fluorescence spectrophotometer (FS920, manufactured by Hamamatsu Photonics Corporation). The measurement was conducted by using a degassed dichloromethane solution (0.44 mmol/L) at room temperature. FIG. 20 shows the measurement result. The horizontal axis indicates a wavelength and the vertical axis indicates a molar absorption coefficient and an emission intensity.

As illustrated in FIG. 20, the organometallic complex of the present invention [Ir(dmFppr)₂(pic)] has a peak of emission spectrum at 538 nm, and yellow-green light was observed from the solution.

In addition, when a dichloromethane solution of the organometallic complex [Ir(dmFppr)₂(pic)] of the present invention was irradiated with light, luminescence can be observed by nitrogen substitution of air in the solution while luminescence derived from the compound is hardly observed by oxygen substitution of air in the solution, and thus the luminescence is considered to be phosphorescence.

### Example 6

### Synthesis Example 5

In Synthesis Example 5, a synthesis example of the organometallic complex of the present invention, represented by the structural formula (17) in Embodiment Mode 1, bis{2-(4-fluorophenyl)-3,5-dimethylpyrazinato}(L-prolinato)iridium(III) (abbreviation: [Ir(dmFppr)₂(pro)]) is described specifically. The structural formula of [Ir(dmFppr)₂(pro)] is shown below.

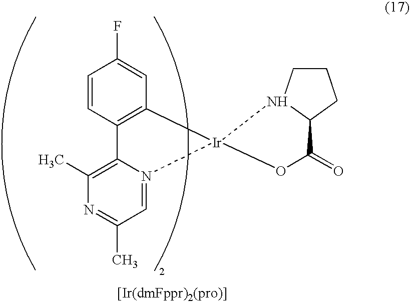

### Step 1: Synthesis of 2-(4-fluororophenyl)-3,5-dimethylpyrazine (abbreviation HdmFppr)

The synthesis was conducted in a similar manner to the Step 1 of the synthesis example 3 in Example 3.

### Step 2: Synthesis of di-μ-chloro-bis{bis[2-(4-fluorophenyl)-3,5-dimethylpyrazinato]}iridium(III)}(abbreviation: [Ir(dmFppr)₂Cl]₂)

The synthesis was conducted in a similar manner to the Step 2 of the synthesis example 3 in Example 3.

### Step 3: Synthesis of bis{2-(4-fluorophenyl)-3,5-dimethylpyrazinato}(L-prolinato)iridium(III) (abbreviation: [Ir(dmFppr)₂(pro)])

0.35 g of the binuclear complex obtained in Step 2, [Ir(dmFppr)₂Cl]₂ was suspended in 10 mL of acetone, and 10 mL of water, 0.47 g of sodium hydrogen carbonate, and 0.064 g of L-proline were added thereto in order. The mixture solution was stirred at room temperature for 20 hours to be reacted. The reaction solution was filtrated and the obtained filtrate was concentrated so that powder precipitated. The precipitated matter was obtained by filtration, and was subjected to recrystallization with a mixed solvent of chloroform and hexane, so that an organometallic complex of the present invention [Ir(dmFppr)₂(pro)] was obtained (orange powdered solid, yield of 25%). A synthetic scheme of this step was shown by the following (c-5).

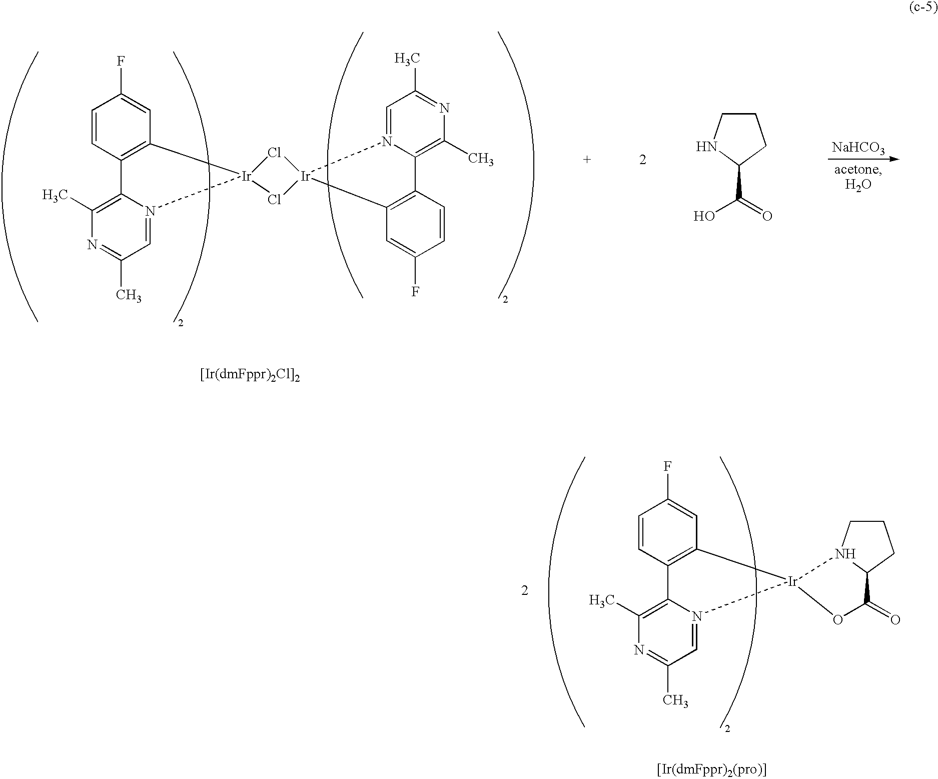

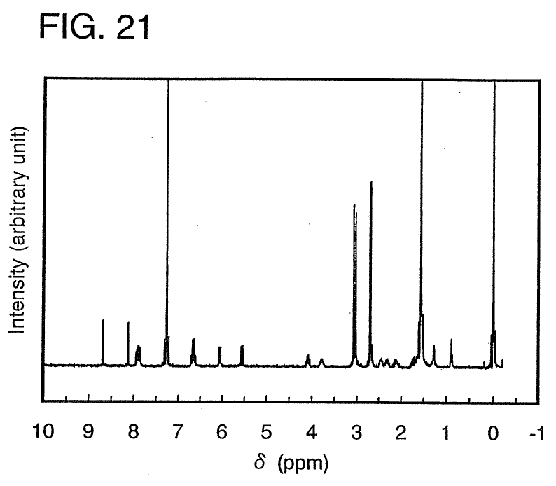

An analysis result of the orange powder obtained in the above step by nuclear magnetic resonance spectrometry (¹H-NMR) is shown below. FIG. 21 shows the ¹H-NMR chart.

¹H-NMR. δ(CDCl₃): 1.63-1.75 (m, 2H), 2.12 (m, 1H), 2.31 (m, 1H), 2.43 (m, 1H), 2.69 (s, 3H), 2.71 (s, 3H), 3.03 (s, 3H), 3.07 (s, 3H), 3.78 (m, 1H), 4.07 (m, 1H), 5.55 (dd, 1H), 6.05 (dd, 1H), 6.65 (m, 1H), 7.90 (m, 2H), 8.12 (s, 1H), 8.69 (s, 1H).

As illustrated in FIG. 21, in the ¹H-NMR analysis, NH protons of [Ir(dmFppr)₂(pro)] were not observed. This is thought to be because the speed of the deuterium exchange reaction is high.

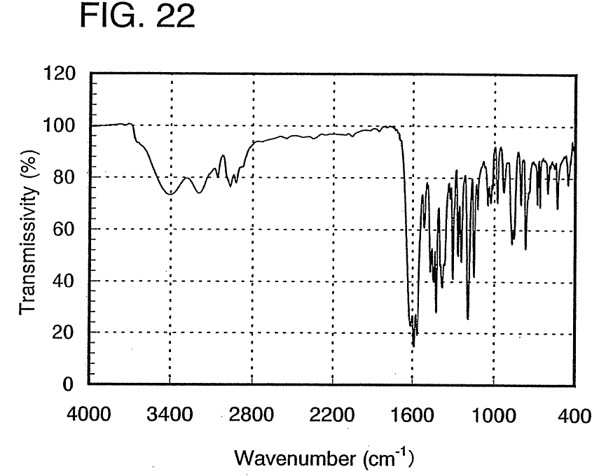

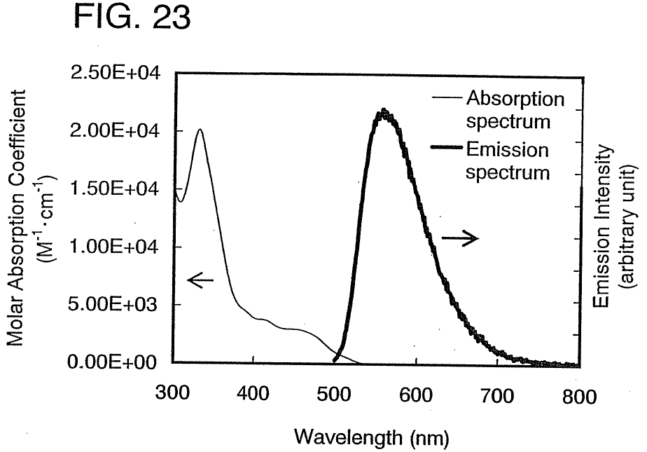

Analysis using infrared spectroscopy (IR) of [Ir(dmFppr)₂(pro)] was conducted. The obtained IR spectrum is shown in FIG. 22. For the measurement of IR spectrum, Fourier transform infrared (FTIR) spectroscopy (Nicolet Nexus670) and potassium bromide (KBr) tablet were used.

As shown in FIG. 22, stretching vibration which was derived from an NH bond was observed at 3402 cm⁻¹. From these results, it is known that in the synthesis example 5, the organometallic complex of the present invention represented by the above structural formula (17), [Ir(dmFppr)₂(pro)] was obtained.

Next, the UV spectrum of [Ir(dmFppr)₂(pro)] was measured using an ultraviolet-visible spectrophotometer (V550, manufactured by JASCO Corporation). The measurement was conducted by using a dichloromethane solution (0.075 mmol/L) at room temperature. Further, an emission spectrum of [Ir(dmFppr)₂(pro)] was measured with use of a fluorescence spectrophotometer (manufactured by Hamamatsu Photonics Corporation, FS920). The measurement was conducted by using a degassed dichloromethane solution (0.45 mmol/L) at room temperature. FIG. 23 shows the measurement result. The horizontal axis indicates a wavelength and the vertical axis indicates a molar absorption coefficient and an emission intensity.

As shown in FIG. 23, the organometallic complex of the present invention, [Ir(dmFppr)₂(pro)] has an emission peak at 556 nm, and yellow-green light emitted from the solution was observed.

In addition, when the dichloromethane solution of the organometallic complex [Ir(dmFppr)₂(pro)] of the present invention was irradiated with light, luminescence can be observed by nitrogen substitution of air in the solution while luminescence derived from the compound is hardly observed by oxygen substitution of air in the solution, and thus the luminescence is considered to be phosphorescence.

### Example 7

### Synthesis Example 6

In Synthesis Example 6, a synthesis example of the organometallic complex of the present invention, represented by the structural formula (21) in Embodiment Mode 1, tris{2-(4-fluorophenyl)-3,5-dimethylpyrazinato}iridium(III) (abbreviation: [Ir(dmFppr)₃]) is described specifically. The structural formula of [Ir(dmFppr)₃] is shown below.

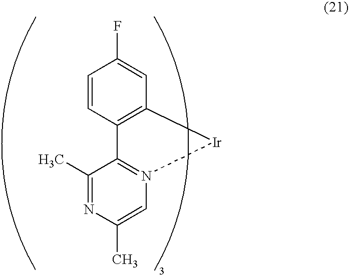

0.13 g of the organometallic complex represented by the structural formula (13) which was obtained in Step 3 of the above synthesis example 3 was suspended in 20 mL of glycerol, and 0.09 g of the ligand HdmFppr obtained in Step 1 of the above synthesis example 3, was added thereto. This mixture solution was subjected to irradiation with microwaves (2.45 GHz, 140 W) for 40 minutes to be heated. Then, water was added to this solution, the mixture solution was filtrated, and a solid obtained by filtration was washed with ethanol. Further, this solid was dissolved in dichloromethane, and an insoluble matter was removed by filtration. The obtained filtrate was recrystallized with ethanol, so that the organometallic complex of the present invention, [Ir(dmFppr)₃] was obtained (yield of 5%). A synthesis scheme of this step is shown in the following scheme (d-6).

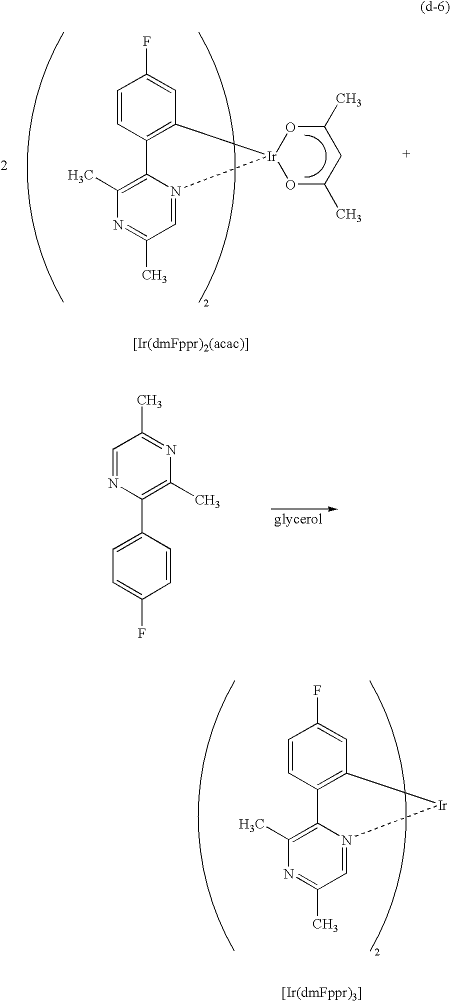

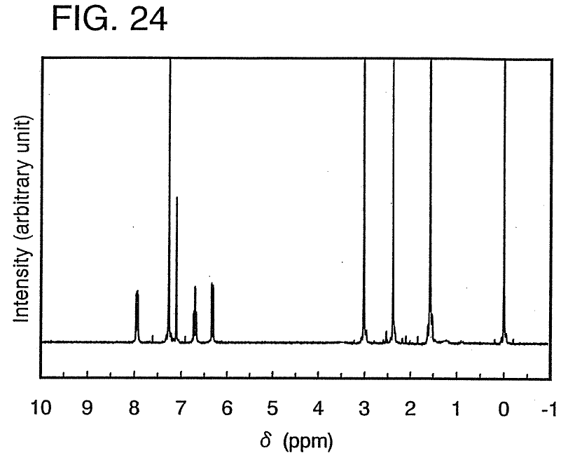

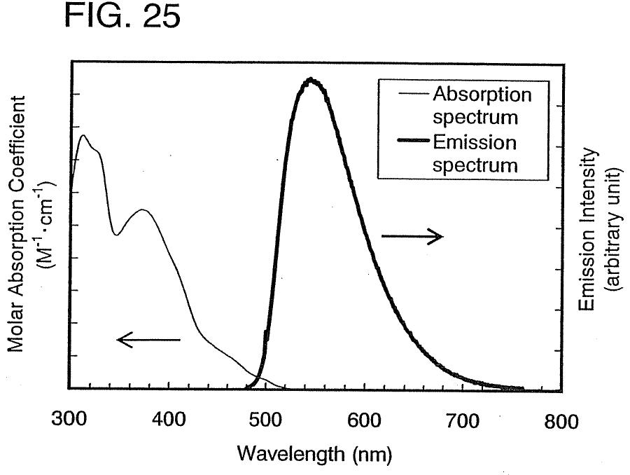

An analysis result of the bright yellow powder obtained in the above Step 3 by nuclear magnetic resonance spectrometry (¹H-NMR) is shown below. FIG. 24 shows the ¹H-NMR chart. It is found that the organometallic complex of the present invention [Ir(dmFppr)₃] of the present invention, represented by the above structural formula (21), was obtained in Synthesis Example 6.

¹H-NMR. δ(CDCl₃): 2.38 (s, 9H), 3.02 (s, 9H), 6.32 (dd, 3H), 6.70 (s, 3H), 7.10 (s, 3H), 7.94 (dd, 3H).

Next, the UV spectrum of [Ir(dmFppr)₃] was measured using an ultraviolet-visible spectrophotometer (V550, manufactured by JASCO Corporation). The measurement was conducted by using a dichloromethane solution at room temperature. Further, an emission spectrum of [Ir(dmFppr)₃] was measured with use of a fluorescence spectrophotometer (FS920, manufactured by Hamamatsu Photonics Corporation). The measurement was conducted by using a degassed dichloromethane solution at room temperature. FIG. 25 shows the measurement result. The horizontal axis indicates a wavelength and the vertical axis indicates a molar absorption coefficient and an emission intensity.

As shown in FIG. 25, the organometallic complex of the present invention, [Ir(dmFppr)₃] has an emission peak at 544 nm, and yellow-green light emitted from the solution was observed.

In addition, when the dichloromethane solution of the organometallic complex [Ir(dmFppr)₃] of the present invention was irradiated with light, luminescence can be observed by nitrogen substitution of air in the solution while luminescence derived from the compound is hardly observed by oxygen substitution of air in the solution, and thus the luminescence is considered to be phosphorescence.

This application is based on Japanese Patent Application Serial No. 2007-149497 filed with Japan Patent Office on Jun. 5, 2007, the entire contents of which are hereby incorporated by reference.

### REFERENCE NUMERALS

101: electrode, 102: EL layer, 103: electrode, 501: electrode, 502: electrode, 511: light-emitting unit, 512: light-emitting unit, 513: charge generation layer, 601: driver circuit portion (source side driver circuit), 602: pixel portion, 603: driver circuit portion (gate side driver circuit), 604: sealing substrate, 605: sealant, 607: space, 608: wiring, 609: FPC (flexible print circuit), 610: element substrate, 611: switching TFT, 612: current control TFT, 613: electrode, 614: insulator, 616: EL layer, 617: electrode, 618: light-emitting element, 623: n-channel TFT, 624: p-channel TFT, 901: housing, 902: liquid crystal layer, 903: backlight, 904: housing, 905: driver IC, 906: terminal, 951: substrate 952: electrode, 953: insulating layer, 954: partition layer, 955: EL layer, 956: electrode, 2001: housing, 2002: light source 3001: illumination apparatus, 9101: housing, 9102: support, 9103: display portion, 9104: speaker portion, 9105: video input terminal, 9201: main body, 9202: housing, 9203: display portion, 9204: keyboard, 9205: external connection port, 9206: pointing device, 9401: main body, 9402: housing, 9403: display portion, 9404: audio input portion, 9405: audio output portion, 9406: operation key, 9407: external connection port, 9408: antenna, 9501: main body, 9502: display portion, 9503: housing, 9504: external connection port, 9505: remote control receiving portion, 9506: image receiving portion, 9507: battery, 9508: audio input portion, 9509: operation key, 9510: eye piece portion,

1. An organometallic complex having a structure represented by a general formula (G1), 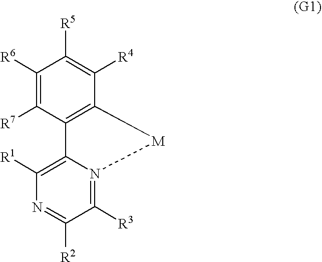
wherein R¹ and R² individually represent an alkyl group having 1 to 4 carbon atoms; and R³ represents hydrogen or an alkyl group having 1 to 4 carbon atoms; R⁴ to R⁷ individually represent an electron-withdrawing group, hydrogen or an alkyl group having 1 to 4 carbon atoms; at least one of R⁴ to R⁷ represents an electron-withdrawing group; M is a central metal and represents an element belonging to Group 9 or Group 10 in the periodic table.

2. An organometallic complex having a structure represented by a general formula (G4), 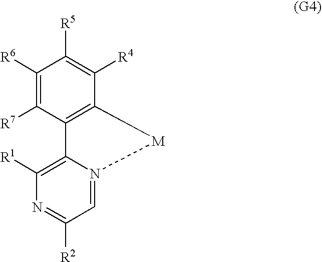
wherein R¹ represents an alkyl group having 1 to 4 carbon atoms; R² represents an alkyl group having 1 to 4 carbon atoms; R⁴ to R⁷ individually represent a fluoro group, a trifluoromethyl group, hydrogen or an alkyl group having 1 to 4 carbon atoms; at least one of R⁴ to R⁷ represents a fluoro group or a trifluoromethyl group; M is a central metal and represents an element belonging to Group 9 or Group 10 in the periodic table.

3. An organometallic complex having a structure represented by a general formula (G13), 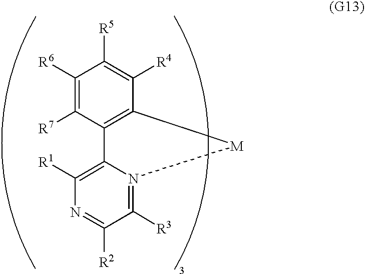
wherein R¹ and R² individually represent an alkyl group having 1 to 4 carbon atoms; and R³ represents hydrogen or an alkyl group having 1 to 4 carbon atoms; R⁴ to R⁷ individually represent an electron-withdrawing group, hydrogen or an alkyl group having 1 to 4 carbon atoms; at least one of R⁴ to R⁷ represents an electron-withdrawing group; and M is a central metal and represents an element belonging to Group 9 or Group 10 in the periodic table.

4. An organometallic complex having a structure represented by a general formula (G14), 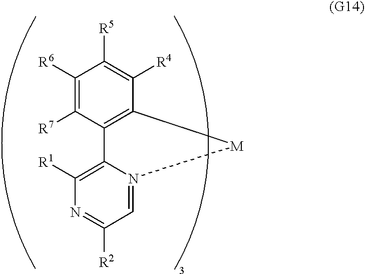
wherein R¹ represents an alkyl group having 1 to 4 carbon atoms represents an alkyl group having 1 to 4 carbon atoms; R⁴ to R⁷ individually represent a fluoro group, a trifluoromethyl group, hydrogen or an alkyl group having 1 to 4 carbon atoms; at least one of R⁴ to R⁷ represents a fluoro group or a trifluoromethyl group; and M is a central metal and represents an element belonging to Group 9 or Group 10 in the periodic table.

5. The organometallic complex according to claim 1, wherein the central metal is iridium or platinum.

6. The organometallic complex according to claim 2, wherein the central metal is iridium or platinum.

7. The organometallic complex according to claim 3, wherein the central metal is iridium or platinum.

8. The organometallic complex according to claim 4, wherein the central metal is iridium or platinum.

9. A light-emitting element having the organometallic complex according to claim 1.

10. A light-emitting element having the organometallic complex according to claim 2.

11. A light-emitting element having the organometallic complex according to claim 3.

12. A light-emitting element having the organometallic complex according to claim 4.
